(19) United States
(12) Patent Application Publication
(10) Pub. No.: US 2016/0110747 A1
(43) Pub. Date: Apr. 21, 2016

(54) MANAGEMENT DEVICE, MANAGEMENT METHOD, TERMINAL DEVICE, CONTROL METHOD, AND PROGRAM

(71) Applicant: KONAMI DIGITAL ENTERTAINMENT CO., LTD., Tokyo (JP)

(72) Inventors: Yoko NAKAI, Tokyo (JP); Shinsaku INUKAI, Tokyo (JP); Shota SUZUKI, Tokyo (JP); Daisuke SATO, Tokyo (JP); Masato MIYAZAKI, Tokyo (JP)

(73) Assignee: KONAMI DIGITAL ENTERTAINMENT CO., LTD., Tokyo (JP)

(21) Appl. No.: 14/980,749

(22) Filed: Dec. 28, 2015

Related U.S. Application Data
(63) Continuation-in-part of application No. PCT/JP2014/057470, filed on Mar. 19, 2014.

(30) Foreign Application Priority Data
Jun. 28, 2013 (JP) 2013-136814
Jun. 28, 2013 (JP) 2013-136815
Jun. 28, 2013 (JP) 2013-136816
Jun. 28, 2013 (JP) 2013-136817
Jun. 28, 2013 (JP) 2013-136818
Jun. 28, 2013 (JP) 2013-136819

(51) Int. Cl. G06Q 30/02; G06F 9/445

(52) U.S. Cl. CPC G06Q 30/0209; G06F 8/61

(57) ABSTRACT

A management device includes an application manager, an install notification acquisitor, a user information acquisitor, a reward granting manager, a reward granting manager, and a reward granting processor. The reward granting processor determines, based on a reward granting management information managed by the reward manager, whether or not the install notification acquisitor acquired the install notification information indicating that the reward granting application has been installed in a terminal. The reward granting processor notifies, to one of a server responsible to the reward granting application and the reward granting application which has been installed into the terminal, a reward granting information associated with a user information with respect to the reward granting application, in a case that the reward granting processor determined that the install notification acquisitor acquired the install notification information, and that the user information acquisitor acquired the user information with respect to the reward granting application.

### TECHNICAL FIELD

The present invention relates to a management device, a management method, a terminal device, a control method, and a program.

### RELATED ART

In contrast to applications (such as games) provided to SNS (social networking service) members, with independently operated applications usable by downloading from a store site that sells the applications, it is first necessary to attract customers to use the application. For this reason, each time a new application is marketed (released), it is necessary to conduct promotional activities such as advertising in order to attract customers.

For example, for the purpose of attracting customers to a new application, there has been a method of displaying advertising for not-yet-installed applications on a display screen displayed while an installed application is being used on a user terminal. Those are disclosed in Japanese Patent No. 5107455.

There are applications that can be downloaded for use on user terminals such as smartphones from a store site selling applications. With such applications, as a campaign to promote continued use of an application by a user, there has been a campaign, for example, in which points are granted in accordance with the number of times a user executes an application. Those are disclosed in Japanese Patent Application Publication No. 2013-54732.

According to the method described above, for example, users can be widely informed about applications by displaying on user terminals advertising for applications to be promoted for use by the user. However, in informing users of applications by displaying advertising, there have been cases in which it has been difficult to heighten the motivation for the user to use the application.

When conducting a campaign such as described above, the user is motivated to use an application by the granting of points. However, even if such campaigns are conducted, because it is difficult to inform a user, who has already stopped using that application, of the existence of the program, there have been cases in which it was difficult to heighten the motivation of the user to use the application once again.

Also, a campaign such as described above could be conducted, for example, for a prescribed period of time. In such cases, information regarding the campaign needs to be provided to the user in accordance with the period of time. In the case of providing a user with information regarding a campaign on the display screen displayed by an application, it can be envisioned that the application program would need to be changed each time a campaign is conducted, or that, if the time period of the campaign is changed before or during the campaign, the application program change cannot be made in time. Given this, it has been desirable to provide users with information regarding a campaign in accordance with the time period, without changing the application program.

An aspect of the present invention has as an object to provide a management device, a management method, a terminal device, a control method, and a program capable of increasing the motivation for a user to use an application.

An aspect of the present invention has as an object to provide a management device, a management method, a terminal device, a control method, and a program capable of increasing the motivation for a user who has stopped using an application to once again use the application.

The present invention has as an object to provide a management device, a management method, a terminal device, a control method, and a program capable of providing a user with information regarding a campaign in accordance with the time period, without changing the application program.

### SUMMARY

In one aspect of the present invention, a management device may include, but is not limited to, an application manager, an install notification acquisitor, a user information acquisitor, a reward granting manager, a reward granting manager, and a reward granting processor. The application manager may be configured to manage a set of application-related information which is related to a plurality of target applications which are subject to management. The install notification acquisitor may be configured to acquire an install notification information from an application which has been installed in a terminal, included in the plurality of target applications. The install notification information indicates that the application has been installed. The install notification information includes an identifier which identifies the application and a unique identifier which identifies the terminal in which the application has been installed. The user information acquisitor may be configured to acquire a user information with respect to a user who uses the terminal with respect to the application for which the install notification acquisitor acquired the install notification information. The reward granting manager may be configured to manage a reward granting management information which includes an identifier and a unique identifier which are associated with each other. The identifier identifies a reward granting application selected to be reward-granted from not-yet-installed applications which has not yet been installed in the terminal. The unique identifier identifies the terminal. The applications are included in the plurality of applications. The reward granting processor may be configured to determine, based on the reward granting management information managed by the reward manager, whether or not the install notification acquisitor acquired the install notification information indicating that the reward granting application has been installed in the terminal. The reward granting processor is configured to notify, to one of a server responsible to the reward granting application and the reward granting application which has been installed into the terminal, a reward granting information associated with the user information with respect to the reward granting application, in a case that the reward granting processor determined that the install notification acquisitor acquired the install notification information, and that the user information acquisitor acquired the user information with respect to the reward granting application.

### BRIEF DESCRIPTION OF THE DRAWINGS

FIG. 1 is a schematic representation generally describing campaign processing according to a first embodiment.

FIG. 2 is a drawing describing an example of a display screen in the campaign processing.

FIG. 3 is a drawing showing the general constitution of an example of a network system according to the first embodiment.

FIG. 4 is a drawing showing the general constitution of an example of user terminal according to the first embodiment.

FIG. 5 is a schematic representation of an example of the general constitution of a reciprocal campaign system of the first embodiment.

FIG. 6 is a drawing showing an example of the functional constitution executed based on an SKD of a user terminal in accordance with the first embodiment.

FIG. 7 is a drawing showing an example of the constitution of a management server 200 according to the first embodiment.

FIG. 8 is a drawing showing an example of information stored in a target application information storage.

FIG. 9 is a drawing showing an example of information stored in a campaign information storage.

FIG. 10 is a drawing showing an example of information stored in a campaign participation application information storage.

FIG. 11 is a drawing showing an example of information stored in a link information storage.

FIG. 12 is a drawing showing an example of information stored in an install information storage.

FIG. 13 is a drawing showing an example of information stored in a point information storage.

FIG. 14 is a drawing showing an example of information stored in a reward granting management information storage.

FIG. 15 is a drawing showing an example of information stored in a reward achievement information storage.

FIG. 16 is a drawing showing an example of information stored in a content storage.

FIG. 17 is an operational flowchart showing the overall flow of operation in a first processing in campaign processing.

FIG. 18 is an operational flowchart showing an example of the operation of the SDK initialization processing.

FIG. 19 is an operational flowchart showing an example of the operation of the log-in notification processing.

FIG. 20 is an operational flowchart showing an example of the operation of the campaign verification processing.

FIG. 21 is an operational flowchart showing an example of the operation of campaign page display processing.

FIG. 22 is an operational flowchart showing an example of the operation of action result processing.

FIG. 23 is an operational flowchart showing an example of operation of a second processing in campaign processing.

FIG. 24 is a schematic representation describing campaign processing according to a second embodiment.

FIG. 25 is a schematic representation describing campaign processing according to a third embodiment.

FIG. 26 is a schematic representation describing processing according to a fourth embodiment.

FIG. 27 is a schematic representation describing processing according to a fifth embodiment.

FIG. 28 is a schematic representation describing campaign processing according to a sixth embodiment.

FIG. 29 is an operational flowchart showing an example of the operation of communication session establishment processing.

### DETAILED DESCRIPTIONS

In one aspect of the present invention, a management device may include, but is not limited to, an application manager, an install notification acquisitor, a user information acquisitor, a reward granting manager, a reward granting manager, and a reward granting processor. The application manager may be configured to manage a set of application-related information which is related to a plurality of target applications which are subject to management. The install notification acquisitor may be configured to acquire an install notification information from an application which has been installed in a terminal, included in the plurality of target applications. The install notification information indicates that the application has been installed. The install notification information includes an identifier which identifies the application and a unique identifier which identifies the terminal in which the application has been installed. The user information acquisitor may be configured to acquire a user information with respect to a user who uses the terminal with respect to the application for which the install notification acquisitor acquired the install notification information. The reward granting manager may be configured to manage a reward granting management information which includes an identifier and a unique identifier which are associated with each other. The identifier identifies a reward granting application selected to be reward-granted from not-yet-installed applications which has not yet been installed in the terminal. The unique identifier identifies the terminal. The applications are included in the plurality of applications. The reward granting processor may be configured to determine, based on the reward granting management information managed by the reward manager, whether or not the install notification acquisitor acquired the install notification information indicating that the reward granting application has been installed in the terminal. The reward granting processor is configured to notify, to one of a server responsible to the reward granting application and the reward granting application which has been installed into the terminal, a reward granting information associated with the user information with respect to the reward granting application, in a case that the reward granting processor determined that the install notification acquisitor acquired the install notification information, and that the user information acquisitor acquired the user information with respect to the reward granting application.

In some cases, the application manager is configured to manage a reward granting time limit defining at least an ending date or time. The reward granting processor is configured to determine that the install notification acquisitor acquired no later than the reward granting time limit the install notification information indicating that the reward granting application has been installed in the terminal.

In some cases, the management device may further include, but is not limited to, a content provider configured to provide the terminal with executable contents which are executable by the terminal. The reward granting manager is configured to manage the reward granting management information with respect to the reward granting application selected to be reward-granted from not-yet-installed applications which have not yet been installed in the terminal, the not-yet-installed applications being included in the plurality of applications in a case that a reward granting condition is satisfied by execution of the contents which were provided to the terminal by the content provider.

In some cases, the contents provided by the content provider includes receiving a user operation in the terminal and presenting a result in response to a user operation. The reward granting manager is configured to manage the reward granting management information with respect to the reward granting application selected from the not-yet-installed applications included in the plurality of target applications, in a case that a reward granting condition is satisfied in response to the user operation in the contents provided to the terminal by the content provider.

In some cases, the reward granting manager is configured to manage the reward granting management information with respect to the reward granting application selected from a group including the installed applications which have been installed in the terminal and the not-yet-installed applications which are included in the plurality of target applications, in a case that a reward granting condition is satisfied in the contents provided by the content provider.

In some cases, the content provider is configured to provide the contents in response to a request from an application which has been installed in the terminal, included in the plurality of target applications. The reward granting manager is configured to manage the reward granting management information with respect to the reward granting application selected from the plurality of target applications except for an application which requests the contents.

In some cases, the content provider is configured to provide the contents in response to a request from an application which is operable in the terminal, and which is different from the plurality of target applications. The reward granting manager is configured to manage the reward granting management information with respect to the reward granting application selected from the plurality of target applications, the selection having been performed on the basis of a result of the execution of the contents.

In some cases, the content provider is configured to provide the contents in a case that a providing condition is satisfied on the basis of a request from an application which has been installed in the terminal, included in the plurality of target applications.

In some cases, the unique identifier which identifies the terminal has been acquired in a case that a first-installed application, which was first installed in the terminal in the plurality of target applications, is executed. The unique identifier is stored in the terminal where the unique identifier is referable by any of the target applications installed in the terminal.

In some cases, the management device may further include, but is not limited to, a communicator configured to communicate the install notification information or the user information directly with the terminal or communicate indirectly to the terminal through a server which is responsible to an application installed in the terminal, included in the plurality of target applications.

In some cases, the communicator is configured to communicate directly with the terminal after the communicator has established a session with an application which has been installed in the terminal, included in the plurality of target applications, the establishment was performed via a server which is responsible to the application which had been installed in the terminal.

In another aspect of the present invention, a management method may include, but is not limited to, managing a set of application-related information which is related to a plurality of target applications which are subject to management; acquiring an install notification information from an application which has been installed in a terminal included in the plurality of target applications, the install notification information indicating that the application has been installed, the install notification information including an identifier which identifies the application and a unique identifier which identifies the terminal in which the application has been installed; acquiring a user information with respect to a user who uses the terminal with respect to the application for which the install notification information is acquired; managing a reward granting management information which includes an identifier and a unique identifier which are associated with each other, the identifier identifying a reward granting application selected to be reward-granted from not-yet-installed applications which has not yet been installed in the terminal, the applications being included in the plurality of applications; and determining, based on the reward granting management information managed by the reward manager, whether or not the install notification acquisitor acquired the install notification information indicating that the reward granting application has been installed in the terminal; and notifying, to one of a server responsible to the reward granting application and the reward granting application which has been installed into the terminal, a reward granting information associated with the user information with respect to the reward granting application, in a case that the install notification information is acquired, and that the user information is acquired with respect to the reward granting application.

In still another aspect of the present invention, a non-transitory computer readable storage medium that stores a computer program to be executed by a computer to perform a management method which may include, but is not limited to, managing a set of application-related information which is related to a plurality of target applications which are subject to management; acquiring an install notification information from an application which has been installed in a terminal included in the plurality of target applications, the install notification information indicating that the application has been installed, the install notification information including an identifier which identifies the application and a unique identifier which identifies the terminal in which the application has been installed; acquiring a user information with respect to a user who uses the terminal with respect to the application for which the install notification information is acquired; managing a reward granting management information which includes an identifier and a unique identifier which are associated with each other, the identifier identifying a reward granting application selected to be reward-granted from not-yet-installed applications which has not yet been installed in the terminal, the applications being included in the plurality of applications; and determining, based on the reward granting management information managed by the reward manager, whether or not the install notification acquisitor acquired the install notification information indicating that the reward granting application has been installed in the terminal; and notifying, to one of a server responsible to the reward granting application and the reward granting application which has been installed into the terminal, a reward granting information associated with the user information with respect to the reward granting application, in a case that the install notification information is acquired, and that the user information is acquired with respect to the reward granting application.

In yet another aspect of the present invention, a terminal device is configured to communicate with a management device which is configured to manage information related to a plurality of target applications which are subject to management. The terminal device may include, but is not limited to, a content acquisitor, a content presenter, and an execution result notifier. The content acquisitor may be configured to acquire executable contents from the management device, the contents being executable in the terminal device. The content presenter may be configured to present the executable contents acquired by the content acquisitor. The execution result notifier may be configured to notify the management device of a result of execution of the executable contents presented by the content presenter. The content acquisitor acquires contents which include a pre-grant notification information from the management device, in response to notification of the execution result to the management device by the execution result notifier, the pre-grant notification information being to notify, prior to installation of a reward granting application, that a reward is granted to the reward granting application, the reward granting application having been selected to be reward-granted from not-yet-installed applications which have not yet been installed in the terminal device. The not-yet-installed applications are included in the plurality of target applications. The content presentor is configured to present contacts including the pre-grant notification information acquired by the content acquisitor.

In some cases, the terminal device may further include, but is not limited to, a content requester configured to request the management device for the executable contents with respect to an application which has been installed in the terminal device, included in the plurality of target applications. The content acquisitor is configured to acquire the executable contents provided by the management device in accordance with the request by the content requester.

In some cases, identifiers which identify the plurality of target applications are managed in the management device. A reward granting management information is managed in the management device, the reward granting management information includes an identifier identifying the reward granting application and a unique identifier identifying the terminal device which is associated with the identifier. The content acquisitor is configured to acquire contents including the pre-grant notification information from the management device, in response to notification of the execution result to the management device by the execution result notifier, the pre-grant notification information being based on the reward granting management information which is managed in the management device.

In some cases, the terminal device may further include, but is not limited to, an install notifier configured to notify, to the management device, an install notification information. The install notification information indicates that an application was installed in the terminal device. The application is included in the plurality of target applications subject to management. The install notification information indicates an identifier which identifies the application and a unique identifier identifying the terminal device.

In some cases, the terminal device may further include, but is not limited to, a unique identifier acquisitor configured to acquire the unique identifier in a case that the application installed in the terminal device is a first-installed target application which has been installed first in the terminal device among the plurality of target applications. The unique identifier acquisitor is configured to store in a storage the unique identifier as acquired. The unique identifier is reviewable by any of the target applications installed in the terminal device.

In some cases, the unique identifier acquisitor is configured to determine whether or not the unique identifier is stored in the storage when the target application is installed in the terminal device. The unique identifier acquisitor is configured to acquire the unique identifier acquisitor configured to acquire the unique identifier in a case that the unique identifier acquisitor determined that the unique identifier is not stored.

In some cases, the terminal device may further include, but is not limited to, a user information notifier configured to notify, to the management device, a user information related to a user which uses the terminal device with respect to an application installed in the terminal device, included in the plurality of target applications.

In some cases, the terminal device may further include, but is not limited to, a communicator configured to communicate at least one of: the executable contents; the execution result of the executable contents; and contacts including the pre-grant notification information, directly with the management device or indirectly to the management device through a server which is responsible to an application installed in the terminal device.

In some cases, the communicator is configured to communicate directly with the management device after the communicator has established a session with the server responsible to the application installed in the terminal device.

In a further aspect of the present invention, a control method is provided for controlling a terminal device configured to communicate with a management device configured to manage information related to a plurality of target applications subject to management. The method may include, but is not limited to, acquiring executable contents from the management device, the contents being executable in the terminal device; presenting the executable contents acquired; notifying a result of execution of the executable contents presented; acquiring contents which include a pre-grant notification information from the management device, the pre-grant notification information being to notify, prior to installation of a reward granting application, that a reward is granted to the reward granting application, in response to notification of the execution result to the management device, the reward granting application having been selected to be reward-granted from not-yet-installed applications which have not yet been installed in the terminal device, the not-yet-installed applications being included in the plurality of target applications, and presenting contacts including the pre-grant notification information acquired.

In a further aspect of the present invention, a non-transitory computer readable storage medium stores a computer program to be executed by a computer to perform a control method for controlling a terminal device configured to communicate with a management device configured to manage information related to a plurality of target applications subject to management. The method may include, but is not limited to, acquiring executable contents from the management device, the contents being executable in the terminal device; presenting the executable contents acquired; notifying a result of execution of the executable contents presented, acquiring contents which include a pre-grant notification information from the management device, the pre-grant notification information being to notify, prior to installation of a reward granting application, that a reward is granted to the reward granting application, in response to notification of the execution result to the management device, the reward granting application having been selected to be reward-granted from not-yet-installed applications which have not yet been installed in the terminal device, the not-yet-installed applications being included in the plurality of target applications, and presenting contacts including the pre-grant notification information acquired.

In a further aspect of the present invention, a non-transitory computer readable storage medium stores a computer program to be incorporated into an application which is to be installed and executed by a computer to perform a control method for controlling a terminal device configured to communicate with a management device configured to manage information related to a plurality of target applications subject to management. The method may include, but is not limited to, acquiring executable contents from the management device, the contents being executable in the terminal device; presenting the executable contents acquired; notifying a result of execution of the executable contents presented, acquiring contents which include a pre-grant notification information from the management device, the pre-grant notification information being to notify, prior to installation of a reward granting application, that a reward is granted to the reward granting application, in response to notification of the execution result to the management device, the reward granting application having been selected to be reward-granted from not-yet-installed applications which have not yet been installed in the terminal device, the not-yet-installed applications being included in the plurality of target applications, and presenting contacts including the pre-grant notification information acquired.

In a furthermore aspect of the present invention, a management device may include, but is not limited to, an application manager, a user information acquisitor, a content provider, and a reward granting processor. The application manager may be configured to manage a set of application-related information which is related to a plurality of target applications which are subject to management. The user information acquisitor may be configured to acquire a user information with respect to respective users which use the terminal with respect to respective applications which are installed in the terminal, the respective applications being included in the plurality of target applications. The content provider may be configured to provide the terminal with executable contents which are executable by the terminal. The reward granting processor may be configured to notify, to one of a server responsible to a reward granting application and the reward granting application which has been installed into the terminal, a reward granting information associated with the user information with respect to the reward granting application selected to be reward-granted among target applications installed in the terminal, based on execution results from the execution of contents in the terminal, the contents having been provided by the content provider.

In moreover aspect of the present invention, a management device may include, but is not limited to, an application manager, a user information acquisitor, a content provider, and a reward granting processor. The application manager may be configured to manage a set of application-related information which is related to a plurality of specific applications which are subject to management. The user information acquisitor may be configured to acquire a user information with respect to respective users which use the terminal with respect to respective applications which are installed in the terminal, the respective applications being included in the plurality of specific applications. The content provider may be configured to provide the terminal with executable contents which are executable by the terminal. The reward granting processor may be configured to notify, to one of a server responsible to a reward granting application and the reward granting application which has been installed into the terminal, a reward granting information associated with the user information with respect to the reward granting application selected to be reward-granted among the specific applications installed in the terminal, based on execution results from the execution of contents in the terminal, the contents having been provided by the content provider.

In some cases, the application manager is configured to manage a first time period which has been set to the plurality of specific applications. The content provider is configured to provide contents to the terminal in the first time period.

In some cases, the management device may further include, but is not limited to, a point manager configured to accumulate values in accordance with requests from the plurality of specific applications installed in the terminal and to manage an accumulation value. The content provider is configured to provide contents, while decreasing the accumulation value that the point manager manages, in accordance with requests from the plurality of specific applications.

In some cases, the content provider is configured to provide contents, within an upper limit of times to provide contents, in accordance with a same application in a limited time period.

In some cases, the management device may further include, but is not limited to, an install notification acquisitor configured to acquire an install notification information from an application which has been installed in a terminal, included in the plurality of target applications, the install notification information indicating that the application has been installed. The install notification information includes an identifier which identifies the application and a unique identifier which identifies the terminal in which the application has been installed. The reward granting manager may be configured to manage a reward granting management information which includes an identifier and a unique identifier which are associated with each other, the identifier identifying the reward granting application selected to be reward-granted on the basis of the execution result of the executable contents, and the unique identifier identifies the terminal. The reward granting processor is configured to notify, to one of a server responsible to the reward granting application and the reward granting application which has been installed into the terminal, a reward granting information associated with the user information with respect to the reward granting application, in a case that the reward granting processor determined that the reward granting application managed as the reward granting management information in the reward granting manager has been installed in the terminal. The reward granting processor is configured to notify, to one of a server responsible to the reward granting application and the reward granting application which has been installed into the terminal, a reward granting information associated with the user information with respect to the reward granting application, if the reward granting processor determined, on the basis of the reward granting management information managed by the reward granting manager, that the install notification acquisitor acquired the install notification information indicating the reward granting application has been installed in the terminal, and that the user information acquisitor acquired the user information with respect to the reward granting application, in a case that the reward granting processor determined that the reward granting application managed as the reward granting management information in the reward granting manager has not yet installed in the terminal.

In an additional aspect of the present invention, a management method may include, but is not limited to, managing a set of application-related information which is related to a plurality of target applications which are subject to management: acquiring a user information with respect to respective users which use the terminal with respect to respective applications which are installed in the terminal, the respective applications being included in the plurality of target applications, providing the terminal with executable contents which are executable by the terminal; and notifying, to one of a server responsible to a reward granting application and the reward granting application which has been installed into the terminal, a reward granting information associated with the user information with respect to the reward granting application selected to be reward-granted among target applications installed in the terminal, based on execution results from the execution of contents in the terminal, the contents having been provided.

In a further additional aspect of the present invention, a management method may include, but is not limited to, managing a set of application-related information which is related to a plurality of specific applications which are subject to management; acquiring a user information with respect to respective users which use the terminal with respect to respective applications which are installed in the terminal, the respective applications being included in the plurality of specific applications, providing the terminal with executable contents which are executable by the terminal; and notifying, to one of a server responsible to a reward granting application and the reward granting application which has been installed into the terminal, a reward granting information associated with the user information with respect to the reward granting application selected to be reward-granted among the specific applications installed in the terminal, based on execution results from the execution of contents in the terminal, the contents having been provided.

In a further additional aspect of the present invention, a non-transitory computer readable storage medium stores a computer program to be executed by a computer to perform a management method which may include, but is not limited to, managing a set of application-related information which is related to a plurality of target applications which are subject to management; acquiring a user information with respect to respective users which use the terminal with respect to respective applications which are installed in the terminal, the respective applications being included in the plurality of target applications, providing the terminal with executable contents which are executable by the terminal; and notifying, to one of a server responsible to a reward granting application and the reward granting application which has been installed into the terminal, a reward granting information associated with the user information with respect to the reward granting application selected to be reward-granted among target applications installed in the terminal, based on execution results from the execution of contents in the terminal, the contents having been provided.

In a further additional aspect of the present invention, a non-transitory computer readable storage medium stores a computer program to be executed by a computer to perform a management method which may include, but is not limited to, managing a set of application-related information which is related to a plurality of specific applications which are subject to management; acquiring a user information with respect to respective users which use the terminal with respect to respective applications which are installed in the terminal, the respective applications being included in the plurality of specific applications, providing the terminal with executable contents which are executable by the terminal; and notifying, to one of a server responsible to a reward granting application and the reward granting application which has been installed into the terminal, a reward granting information associated with the user information with respect to the reward granting application selected to be reward-granted among the specific applications installed in the terminal, based on execution results from the execution of contents in the terminal, the contents having been provided.

In a further additional aspect of the present invention, a terminal device may be configured to communicate with a management device which is configured to manage information related to a plurality of target applications which are subject to management. The terminal device may include, but is not limited to, a content acquisitor, a content presenter, and an execution result notifier. The content acquisitor may be configured to acquire executable contents from the management device, the contents being executable in the terminal device. The content presenter may be configured to present the executable contents acquired by the content acquisitor. The execution result notifier may be configured to notify the management device of a result of execution of the executable contents presented by the content presenter. The content acquisitor acquires contents which include a grant notification information from the management device, in response to notification of the execution result to the management device by the execution result notifier. The grant notification information is to notify that a reward is granted to the reward granting application. The reward granting application has been selected to be reward-granted from installed applications which have been installed in the terminal device. The installed applications is included in the plurality of target applications. The content presentor is configured to present contacts including the grant notification information acquired by the content acquisitor.

In a further additional aspect of the present invention, a terminal device may be configured to communicate with a management device which is configured to manage information related to a plurality of target applications which are subject to management. The terminal device may include, but is not limited to, a content acquisitor, a content presenter, and an execution result notifier. The content acquisitor may be configured to acquire executable contents from the management device. The contents are executable in the terminal device. The content presenter may be configured to present the executable contents acquired by the content acquisitor. The execution result notifier may be configured to notify the management device of a result of execution of the executable contents presented by the content presenter. The content acquisitor acquires contents which include a grant notification information from the management device, in response to notification of the execution result to the management device by the execution result notifier, the grant notification information being to notify that a reward is granted to the reward granting application. The reward granting application has been selected to be reward-granted from installed applications which have been installed in the terminal device. The installed applications are included in the plurality of specific applications. The content presentor is configured to present contacts including the grant notification information acquired by the content acquisitor.

In some cases, the application manager is configured to manage a first time period which has been set to the plurality of specific applications. The content provider is configured to provide contents to the terminal in the first time period.

In some cases, the terminal device may further include, but is not limited to, a content requester configured to request the management device for the executable contents with respect to an application which has been installed in the terminal device, included in the plurality of target applications. The content acquisitor is configured to acquire the executable contents provided by the management device in accordance with the request by the content requester.

In some cases, the content acquisitor is configured to acquire contents including the grant notification information from the management device. The grant notification information indicates that the reward was granted in the reward granting application which had been selected from different applications from an application which had requested the executable contents.

In some cases, the reward granting application has not yet been installed in the terminal device.

In a further additional aspect of the present invention, a method is provided for controlling a terminal device configured to communicate with a management device which is configured to manage information related to a plurality of target applications which are subject to management. The method may include, but is not limited to, acquiring executable contents from the management device, the contents being executable in the terminal device; presenting the executable contents acquired; notifying the management device of a result of execution of the executable contents presented; acquiring contents which include a grant notification information from the management device, in response to notification of the execution result to the management device, the grant notification information being to notify that a reward is granted to the reward granting application, the reward granting application having been selected to be reward-granted from installed applications which have been installed in the terminal device, the installed applications being included in the plurality of specific applications; and presenting contacts including the grant notification information acquired.

In a further additional aspect of the present invention, a method is provided for controlling a terminal device configured to communicate with a management device which is configured to manage information related to a plurality of specific applications included in a plurality of target applications which are subject to management. The method may include, but is not limited to, acquiring executable contents from the management device, the contents being executable in the terminal device; presenting the executable contents acquired; notifying the management device of a result of execution of the executable contents presented; acquiring contents which include a grant notification information from the management device, in response to notification of the execution result to the management device, the grant notification information being to notify that a reward is granted to the reward granting application, the reward granting application having been selected to be reward-granted from installed applications which have been installed in the terminal device, the installed applications being included in the plurality of specific applications; and presenting contacts including the grant notification information acquired.

In a further additional aspect of the present invention, a non-transitory computer readable storage medium stores a computer program to be executed by a computer to perform a method of controlling a terminal device configured to communicate with a management device which is configured to manage information related to a plurality of target applications which are subject to management. The method may include, but is not limited to, acquiring executable contents from the management device, the contents being executable in the terminal device; presenting the executable contents acquired; notifying the management device of a result of execution of the executable contents presented; acquiring contents which include a grant notification information from the management device, in response to notification of the execution result to the management device, the grant notification information being to notify that a reward is granted to the reward granting application, the reward granting application having been selected to be reward-granted from installed applications which have been installed in the terminal device, the installed applications being included in the plurality of specific applications; and presenting contacts including the grant notification information acquired.

In a further additional aspect of the present invention, a non-transitory computer readable storage medium stores a computer program to be executed by a computer to perform a method of controlling a terminal device configured to communicate with a management device which is configured to manage information related to a plurality of specific applications included in a plurality of target applications which are subject to management. The method may include, but is not limited to, acquiring executable contents from the management device, the contents being executable in the terminal device; presenting the executable contents acquired; notifying the management device of a result of execution of the executable contents presented; acquiring contents which include a grant notification information from the management device, in response to notification of the execution result to the management device, the grant notification information being to notify that a reward is granted to the reward granting application, the reward granting application having been selected to be reward-granted from installed applications which have been installed in the terminal device, the installed applications being included in the plurality of specific applications; and presenting contacts including the grant notification information acquired.

In a further additional aspect of the present invention, a non-transitory computer readable storage medium stores a computer program to be incorporated into an application which is to be installed and executed by a computer to perform a control method for controlling a terminal device configured to communicate with a management device configured to manage information related to a plurality of target applications subject to management. The method may include, but is not limited to, acquiring executable contents from the management device, the contents being executable in the terminal device; presenting the executable contents acquired; notifying the management device of a result of execution of the executable contents presented; acquiring contents which include a grant notification information from the management device, in response to notification of the execution result to the management device, the grant notification information being to notify that a reward is granted to the reward granting application, the reward granting application having been selected to be reward-granted from installed applications which have been installed in the terminal device, the installed applications being included in the plurality of specific applications; and presenting contacts including the grant notification information acquired.

In a further additional aspect of the present invention, a non-transitory computer readable storage medium stores a computer program to be incorporated into an application which is to be installed and executed by a computer to perform a control method for controlling a terminal device configured to communicate with a management device configured to manage information related to a plurality of specific application included in a plurality of target applications subject to management. The method may include, but is not limited to, acquiring executable contents from the management device, the contents being executable in the terminal device; presenting the executable contents acquired; notifying the management device of a result of execution of the executable contents presented; acquiring contents which include a grant notification information from the management device, in response to notification of the execution result to the management device, the grant notification information being to notify that a reward is granted to the reward granting application, the reward granting application having been selected to be reward-granted from installed applications which have been installed in the terminal device, the installed applications being included in the plurality of specific applications; and presenting contacts including the grant notification information acquired.

In a further additional aspect of the present invention, a management device may include, but is not limited to, an application manager, an event information notifier, and a content provider. The application manager may be configured to manage a set of information related to a plurality of target applications which are subject to management and a set of information related to an event having a first time period which has been set on a plurality of specific applications included in the plurality of target applications. The event information notifier may be configured to notify a terminal of a first provision destination information, in response to a request from an application installed in the terminal. The application is included in the plurality of specific applications. The first provision destination information indicates a first provision destination to which a first content is to be provided if the request is received in the first time period. The content provider may be configured to provide the terminal with the first content on the basis of an access request to have an access to the first provision destination from the application installed in the terminal.

In some cases, the application manager is configured to manage a second time period immediately before the first time period set on the plurality of specific applications. The event information notifier is configured to notify the terminal of a second provision destination information, in response to a request from an application installed in the terminal. The application is included in the plurality of specific applications. The second provision destination information indicates a second provision destination to which a second content is to be provided if the request is received in the second time period.

In some cases, the second content indicates a notice of the start of the first time period in which the first content is provided.

In some cases, the application manager is configured to manage a third time period immediately after the first time period set on the plurality of specific applications. The event information notifier is configured to notify the terminal of a third provision destination information, in response to a request from an application installed in the terminal, the application being included in the plurality of specific applications. The third provision destination information indicates a third provision destination to which a third content is to be provided if the request is received in the third time period.

In some cases, the event information notifier is configured to notify the terminal of the third provision destination information, in response to a request from an application installed in the terminal to which the content provider had provided the first content in accordance with an access request to access to the first provision destination information from the application installed in the terminal.

In some cases, the third content indicates a notice of the end of the first time period in which the first content is provided.

In some cases, the management device may further include, but is not limited to, a user information acquisitor, and a reward granting processor. The user information acquisitor may be configured to acquire a user information with respect to a user who uses the terminal with respect to the application for which the install notification acquisitor acquired the install notification information. The reward granting processor may be configured to notify, to one of a server responsible to a reward granting application and the reward granting application which has been installed into the terminal, a reward granting information associated with the user information with respect to the reward granting application selected to be reward-granted among the specific applications installed in the terminal, based on execution results from the execution of contents in the terminal, the contents having been provided by the content provider.

In a further additional aspect of the present invention, a management device may include, but is not limited to, managing a set of information related to a plurality of target applications which are subject to management and a set of information related to an event having a first time period which has been set on a plurality of specific applications included in the plurality of target applications; notifying a terminal of a first provision destination information, in response to a request from an application installed in the terminal, the application being included in the plurality of specific applications, the first provision destination information indicating a first provision destination to which a first content is to be provided if the request is received in the first time period; and providing the terminal with the first content on the basis of an access request to have an access to the first provision destination from the application installed in the terminal.

In a further additional aspect of the present invention, a non-transitory computer readable storage medium stores a computer program to be executed by a computer to perform a management method which may include, but is not limited to, managing a set of information related to a plurality of target applications which are subject to management and a set of information related to an event having a first time period which has been set on a plurality of specific applications included in the plurality of target applications; notifying a terminal of a first provision destination information, in response to a request from an application installed in the terminal, the application being included in the plurality of specific applications, the first provision destination information indicating a first provision destination to which a first content is to be provided if the request is received in the first time period; and providing the terminal with the first content on the basis of an access request to have an access to the first provision destination from the application installed in the terminal.

In a further additional aspect of the present invention, a terminal device may be configured to communicate with a management device which is configured to manage a set of information related to a plurality of target applications which are subject to management and a set of event-related information related to an event having a first time period which has been set on a plurality of specific applications included in the plurality of target applications. The terminal device may include, but is not limited to, an event information requester, an event information acquisitor, a content acquisitor, and a content presentor. The event information requester may be configured to transmit, to the management device, a request for the set of event-related information with respect to an application installed in the terminal device, the application being included in the plurality of target applications. The event information acquisitor may be configured to acquire a first provision destination information which has been notified by the management device in a case that the management device received the request for the set of event-related information in the first time period and in a case that the event information requester transmitted the request to the application which is the specific application. The content acquisitor may be configured to make an access request for the first provision destination information that the event information acquisitor acquired, the content acquisitor being configured to acquire a first content from the management device. The content presentor may be configured to present the first content that the content acquisitor acquired.

In some cases, the management device manages a second time period immediately before the first time period set on the plurality of specific applications. The event information acquisitor is configured to acquire a second provision destination information from the management device, in a case that the management device received the request in the second time period and in a case that the event information requester transmitted the request to the specific application. The content acquisitor is configured to make an access request for the second provision destination information that the event information acquisitor acquired, the content acquisitor being configured to acquire a second content from the management device. The content presentor is configured to present the second content that the content acquisitor acquired.

In some cases, the second content indicates a notice of the start of the first time period in which the first content is provided.

In some cases, the management device manages a third time period immediately after the first time period set on the plurality of specific applications. The event information acquisitor is configured to acquire a third provision destination information from the management device, in a case that the management device received the request in the third time period and in a case that the event information requester transmitted the request to the specific application. The content acquisitor is configured to make an access request for the third provision destination information that the event information acquisitor acquired, the content acquisitor being configured to acquire a third content from the management device. The content presentor is configured to present the third content that the content acquisitor acquired.

In some cases, the third content indicates a notice of the end of the first time period in which the first content is provided.

In some cases, the management device may further include, but is not limited to, an execution result notifier configured to notify the management device of a result of execution of the executable contents presented by the content presenter. The content acquisitor acquires contents which include a grant notification information from the management device, in response to notification of the execution result to the management device by the execution result notifier, the grant notification information being to notify that a reward is granted to the reward granting application. The reward granting application has been selected to be reward-granted from installed applications which have been installed in the terminal device. The installed applications are included in the plurality of target applications. The content presentor is configured to present contacts including the grant notification information acquired by the content acquisitor.

In some cases, the management device may further include, but is not limited to, an execution result notifier configured to notify the management device of a result of execution of the first content presented by the content presenter. The content acquisitor acquires contents which include a pre-grant notification information from the management device, in response to notification of the execution result to the management device by the execution result notifier, the pre-grant notification information being to notify, prior to installation of a reward granting application, that a reward is granted to the reward granting application, the reward granting application having been selected to be reward-granted from not-yet-installed applications which have not yet been installed in the terminal device, the not-yet-installed applications being included in the plurality of target applications. The content presentor is configured to present contacts including the pre-grant notification information acquired by the content acquisitor.

In a further additional aspect of the present invention, a method is provided for controlling a terminal device configured to communicate with a management device which is configured to manage a set of information related to a plurality of target applications which are subject to management and a set of event-related information related to an event having a first time period which has been set on a plurality of specific applications included in the plurality of target applications. The method may include, but is not limited to, transmitting, to the management device, a request for the set of event-related information with respect to an application installed in the terminal device, the application being included in the plurality of target applications; acquiring a first provision destination information which has been notified by the management device in a case that the management device received the request for the set of event-related information in the first time period and in a case that the event information requester transmitted the request to the application which is the specific application; making an access request for the first provision destination information acquired; acquiring a first content from the management device; and presenting the first content that the content acquisitor acquired.

In a further additional aspect of the present invention, a non-transitory computer readable storage medium stores a computer program to be executed by a computer to perform a method of controlling a terminal device configured to communicate with a management device which is configured to manage information related to a plurality of target applications which are subject to management. The method may include, but is not limited to, transmitting, to the management device, a request for the set of event-related information with respect to an application installed in the terminal device, the application being included in the plurality of target applications; acquiring a first provision destination information which has been notified by the management device in a case that the management device received the request for the set of event-related information in the first time period and in a case that the event information requester transmitted the request to the application which is the specific application; making an access request for the first provision destination information acquired; acquiring a first content from the management device; and presenting the first content that the content acquisitor acquired.

In a further additional aspect of the present invention, a non-transitory computer readable storage medium stores a computer program to be incorporated into an application which is to be installed and executed by a computer to perform a control method for controlling a terminal device configured to communicate with a management device configured to manage information related to a plurality of target applications subject to management. The method may include, but is not limited to, transmitting, to the management device, a request for the set of event-related information with respect to an application installed in the terminal device, the application being included in the plurality of target applications; acquiring a first provision destination information which has been notified by the management device in a case that the management device received the request for the set of event-related information in the first time period and in a case that the event information requester transmitted the request to the application which is the specific application; making an access request for the first provision destination information acquired; acquiring a first content from the management device; and presenting the first content that the content acquisitor acquired.

### First Embodiment

In contrast to applications (such as games) provided to SNS (social networking service) members, with independently operated applications usable by downloading from a store site that sells the applications, it is first necessary to attract customers to use the application. For this reason, each time a new application is marketed (released), it is necessary to conduct promotional activities such as advertising in order to attract customers.

In this case, an independently operated application, in contrast to an application that, such as applications provided on an SNS, which permits common use of user information in the SNS, is an application in which user information is independently set for each application or for each provider of applications.

For example, if the operator providing a popular application that has a large number of users introduces (releases) a new application, for the purpose of transferring users of the popular application (that is, the customer transfer source application) to the new application (that is, the customer transfer destination application), there is a method of pasting an advertising image for the customer transfer destination application is onto the screen of the customer transfer source application and of informing users of the new applications. However, in widely informing users by such advertising images, there have been cases in which it has been difficult to heighten the motivation for user to install the customer transfer destination application.

The present embodiment grants a reward to a user in the customer transfer destination application beforehand (this being referred to as a temporary granting, because the reward is not actually granted yet). By granting a reward to an application even though the application is not yet used, the user is caused to be interested in the application, thereby enabling an increase in the motivation for the user to use the application.

(Overview of Campaign Processing in the Reciprocal Campaign System)

An overview of campaign processing by a reciprocal campaign system according to the present embodiment, in which temporary rewards such as described above are granted, will be presented below. A reciprocal campaign system according to the present embodiment can perform promotion (for example, a campaign) of an application reciprocally between applications and, based on a use of an application by a user, executes processing to temporarily grant a reward to the user for an application that the user has not yet used. The reciprocal campaign system according to the present embodiment executes processing that grants to the user a reward for one application that the user already uses, based on the use of an application by the user.

In this case, if some sort of reward is granted with respect to an application used by a user, it is necessary to notify an application server that manages the user information in that application in association with data. However, when a temporary grant is made as described above, the user who has been given a temporary grant of a reward is still at the stage of not having yet used the customer transfer destination application (that is, it is not installed in the user terminal). Therefore, the user information is not managed by the above-described application server. For this reason, the reciprocal campaign system according to the present embodiment manages information indicating temporary granting of a reward during the time until the user installs into the user terminal the customer transfer destination application. If the reciprocal campaign system judges that the customer transfer destination application was installed in the user terminal, it notifies the application server of the temporarily granted reward, in association with the user information of the customer transfer destination application. This temporarily grants a reward to the user in the application server.

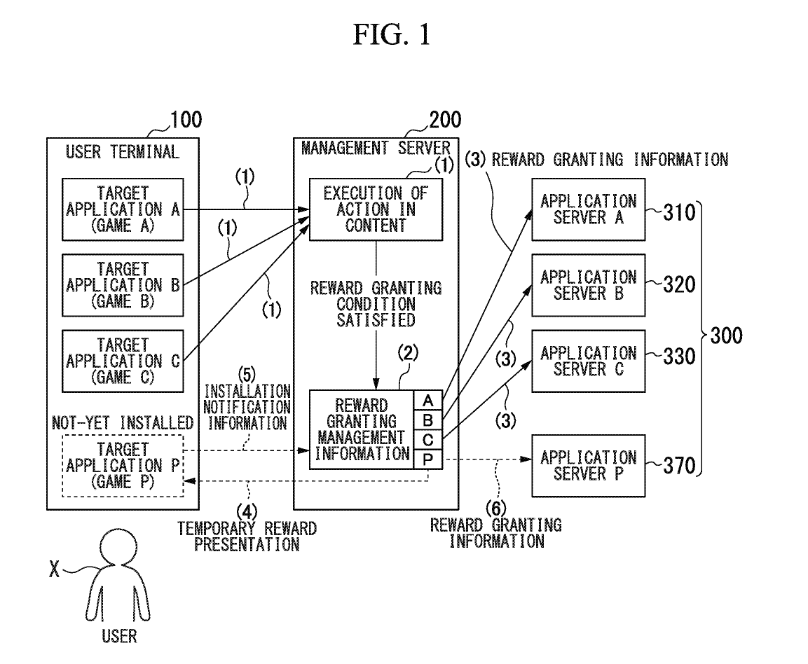

FIG. 1 is a schematic representation generally describing campaign processing according to the present embodiment. Referring to FIG. 1, campaign processing according to the present embodiment will now be generally described. A management server 200 manages information regarding an application that is a target of a reciprocal campaign system (hereinafter referred to as a target application). The management server 200 manages a campaign period during a campaign (advertising or the like) set from among the target applications. The campaign is a program (event) that promotes the use of a target application by granting a reward to a user who fulfills a prescribed condition only during the campaign period. In this case, the description will be for the case of the target application being a game application.

In FIG. 1, three target applications, the target application A (game A), the target application B (game B), and the target application C (game C) are installed in the user terminal 100 used by the user X. The target application P (game P) indicates a target application that is not installed in the user terminal 100 used by the user X. The target application A (game A), the target application B (game B), the target application C (game C), and the target application P (game P) will be referred to, respectively, as the target application A, the target application B, the target application C, and the target application P.

At this point, let us assume that the target application A, the target application B, the target application C, and the target application P are in the campaign time period of the same campaign. Also, assume that install notification information indicating that each of the target application A, the target application B, and the target application C, has been installed has been obtained and is being managed. Each of the install notification information includes unique identification information, which uniquely identifies the user terminal 100, and identification information uniquely identifying a target application of the target application A, the target application B, and the target application C. In the following, identification information uniquely identifying an application will be referred to as an application ID.

The campaign processing will be generally described below in the sequence (1) to (6).

(1) The user X, in the user terminal 100, executes the content of a campaign provided from the management server 200 in response to a request from any one of the target application A, the target application B, and the target application C (content execution by the user X). In this case, the content is such that it can be executed in the user terminal 100, such as a simple game (for example a scratch or bingo game) that accepts operations from the user X in the user terminal 100 and that presents the results of those simple operations. In the description to follow, this executable content will be referred to as the first content.

When the user X executes the first content in the user terminal 100, the user terminal 100 transmits the result of the execution of an action of the first content to the management server 200.

(2) If the reward granting condition is satisfied in accordance with the result of the user X executing the action by the first content, the management server 200 manages as reward granting management information the identification information of the reward granting application selected from among the managed target applications as the application (hereinafter, referred to as the reward granting application) for which a reward is to be granted to the user X (hereinafter, the application identification information being referred to as the application ID) and the unique identification information identifying the user terminal 100 of the user X, in association with each other.

(3) If the selected reward granting application is a target application installed in the user terminal 100 of the user X, the management server 200 can obtain the user information of the user X in that reward granting application. In this case, the user information of the user X in the reward granting application is, for example, identification information (a user ID) that uniquely identifies the user X in the reward granting application. In the following, the user ID in the application will be referred to as the application user ID.

The management server 200 transmits to the application server handling the reward granting application (hereinafter referred to as the application server 300) reward granting information that was associated with the user information of the user X (for example, the application user ID) in the reward granting application.

For example, if the reward granting application is the target application A, the management server 200 transmits the reward granting information to the application server A310, which is the application server 300 handling the target application A. If the reward granting application is the target application B, the management server 200 transmits the reward granting information to the application server B320, which is the application server 300 handling the target application B. If the reward granting application is the target application C, the management server 200 transmits the reward granting information to the application server C330, which is the application server 300 handling the target application C. By doing this, the reward in the target application A, the target application B, and the target application C are each granted to the user X in the corresponding application server 300.

(4) If the selected reward granting application is a target application (referred to as the target application P in this case) not installed in the user terminal 100 of the user X, the management server 200 cannot obtain the user information of the user X in that reward granting application. Given this, the management server 200, in addition to managing reward granting management information in which the application ID of the not-yet installed target application P and the unique identification information identifying the user terminal of the user X are associated as information indicating that a reward has been temporarily granted to the user X in the target application P, makes a notification and presentation to the user terminal 100 of the user X to that effect (presentation of temporary granting). By doing this, the management server 200 can make notification to the user X that a temporary grant of a reward has been made in the not-yet-installed target application P.

(5) Assume that the user X has installed into the user terminal 100 the target application P in which the reward had been temporarily granted. In this case, the user terminal 100 transmits to the management server 200 install notification information indicating that the target application P has been installed. The management server 200 obtains from the user terminal 100 user information of the user X (for example, the user X application ID) that was registered in the installed target application P.

(6) Assume that the management server 200 obtains the install notification information indicating that the target application P has been installed into the user terminal 100 of the user X and obtains user information of the user X in the target application P (for example, the application user ID). In this case, the management server 200, based on reward granting management information indicating that a reward has been temporarily granted to the user X in the target application P, transmits to the application server P370, which is the application server 300 handling the target application P reward granting information associated with the user information (for example, the application user ID) of the user X in the target application P. Doing this, in the application server 370 the user X is granted the reward that had been temporarily granted.

In this manner, according to the reciprocal campaign system of the present embodiment, by a user executing the first content of a campaign page from a target application installed in the user terminal 100, a reward is temporarily granted in a target application that is not installed in the user terminal 100, enabling an increase in the motivation for the user to use the not-yet-installed application. Then, if the user, triggered by the temporary granting of the reward, installs the not-yet-installed application into the user terminal 100 and uses the application, the customer transfer to the not-yet-installed application from the target application installed in the user terminal 100 is achieved. That is, it is possible in the reciprocal campaign system of the present embodiment to perform reciprocal customer transfer between target applications.

In the reciprocal campaign system of the present embodiment, by the user executing the first content of a campaign page from a target application installed in the user terminal 100, a reward is granted in any one of the target applications installed in the user terminal 100. For example, by the user executing the first content of a campaign page from a target application that is often used, the user is granted a reward in a target application that is not used that much. In this case, the reciprocal campaign system, by granting a reward in a target application not used that much by the user, can increase the motivation for the user to use that target application.

(Campaign Processing Display Screen Example)

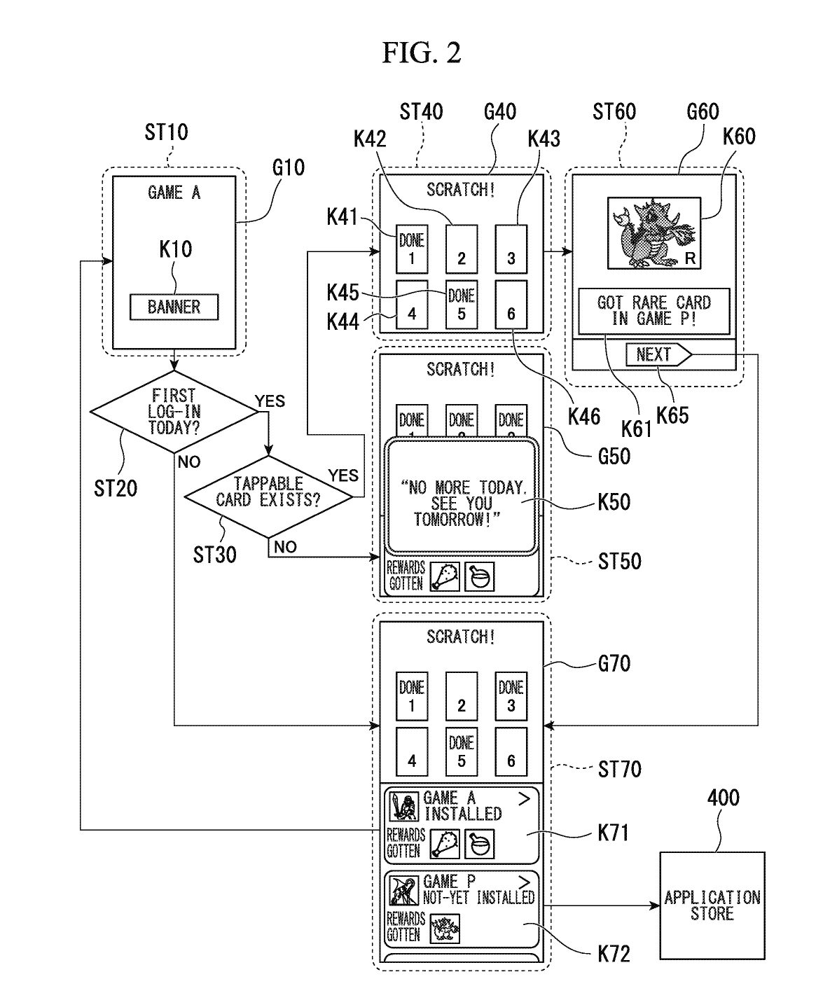

Next, referring to FIG. 2, an example of a display screen (game screen) displayed on the display of the user terminal 100 of the user X in the process of the above-described campaign processing will be described. FIG. 2 describes one example of the display screen displayed on the user terminal 100 in campaign processing.

In this case, an example of the display screen displayed on the user terminal 100 during the processing will be described as an example in which, from the target application A, the user X executes the first content of a campaign provided to the user terminal 100 from the management server 200 and in which a reward is temporarily granted to the user X in the not-yet-installed target application P. The description will take the above-described first content executable in the user terminal 100 and provided from the management server 200 to be a scratch game.

In this scratch game, by making a tap operation on one of the cards of a plurality of scratch cards disposed on the display screen, the card operated on can be flipped over. Once a card is flipped over, it cannot be flipped over again. The example shown in the drawing is one of a scratch game displaying six scratch cards, enabling a maximum of one to be flipped over each day of six types of target applications. If the user X flips over a scratch card, a reward for one target application (for example, an item usable in one of the target applications) is granted to the user X. In this case, the granted reward may be pre-established in accordance with the target application for which a reward is granted and with a campaign, and may be the granting of an established fix reward, or may be the selecting and the granting of a reward in accordance with the flipped over scratch card, from among a plurality of established rewards.

In the example shown in the drawing, although the description is for the granting to the user X of a reward in one target application each time a scratch card is flipped over, the reward granting condition for the granting of a reward is not limited to this. For example, there may be a card that is a “Hit” or a “Miss” card that can be distinguished only after a scratch card is flipped over, with a reward being granted only in the case of flipping over a Hit card. Also, a reward may be granted when all of the displayed scratch cards are flipped over.

The display screen G10 displayed in the display processing at step ST10 is a game screen of game A displayed when the target application A is launched, this being, for example, a main screen that is a selection menu for causing the selection of the start of play or the display of a description of how to play, and a message of notification to the user. A banner K10, which is an advertising image for the purpose of displaying a campaign page is displayed on the display screen G10. For example, the banner K10 includes information indicating a link destination of the campaign page, this being displayed as an operator item for displaying the link destination. The banner K10 display content may change or not be displayed, in accordance with the participation status with respect to the campaign of the target application A (status such as whether or not the campaign is in progress). In this case, because target application A is currently conducting a campaign, the advertising image for displaying the campaign page is displayed as the banner K10.

In the judgment processing at step ST20, if the user X makes an operation (for example, a tap operation) with respect to the banner K10, a judgment is made of whether or not the user X is logging into the target application A for the first time that day in the display screen G10 displayed at step ST10. If the judgment is that this is not the first log-in that day (NO at step ST20), the display processing proceeds to step ST70. If, however, at step ST20 the judgment is that this is the first log-in on that day (YES at step ST20), processing proceeds to the judgment processing of step ST30.

In the judgment processing at step ST30, a judgment is made as to whether or not there is a scratch card (that is, there is a card remaining) that can be flipped over by a tap operation. If the judgment is that there is a remaining scratch card that can be flipped over by a tap operation (YES at step ST30) display processing proceeds to step ST40.

The display screen G40 displayed in the display processing at step ST40 is a campaign display screen that is displayed on the user terminal 100 if, at step ST30, the judgment is made that there is a scratch card that can be tapped (YES at step ST30). The display screen G40 is obtained by accessing the campaign page link destination included in the banner K10. The campaign page display screen G40 includes a scratch game screen as the first content executable in the user terminal 100.

In the example of the scratch game screen shown in the drawing, six scratch cards (reference symbols K41 to K46) are displayed. For example, six target applications are participating in the campaign, and six scratch cards are displayed, so that a maximum of one of the six target applications can be flipped in one day. If there are three target applications installed in the user terminal 100 of the six target applications, three scratch cards may be displayed, or six cards may be displayed, with three cards of the six being made cards that can be flipped over by a tap operation.

Cards that have already been flipped over by a tap operation made by the user X are marked “Done” (refer to the cards indicated by the reference symbols K41 and K44) and cannot be flipped over again by a tap operation.

In the display screen G40, the user X can, by making a tap operation, flip over a scratch card (in this drawing, one card of the cards indicated by the reference symbols K42, K43, K44, and K46, for example, the card indicated by the reference symbol K43), this being execution of the first content by the user X, noted as (1) in FIG. 1.

The display screen G50 displayed in the display processing at step ST50 is a campaign page display screen that is displayed if, at step ST30, there is no remaining scratch card that can be flipped over by a tap operation (NO at step ST30). The display screen G50 displays a message label K50 such as “No more today. See you tomorrow!” overlaid with the game screen of the scratch game. The scratch cards displayed on the game screen of the scratch game at this time are all cards that have been flipped over. The message label K50 displays information indicating that there are no remaining scratch cards that can be flipped over by a tap operation (in this case “No more today. See you tomorrow!”). In this scratch game, the execution results (results of flipping over cards) are reset each day, so that the next day all six scratch cards can be flipped over again.

If the number of scratch cards and the number of target applications participating in a campaign coincide, the processing at step ST30 can be eliminated. In the processing at step ST20, if the judgment is made that this is the first log-in of the day, this is equivalent to there being a scratch card that can be flipped over by a tap operation, and if the judgment is made at the step ST20 processing that this is not the first log-in of the day, this is equivalent to there being no remaining scratch card that can be flipped over by a tap operation. In this case, because there is no transition to the display processing of step ST50, the display screen G50 is not displayed.

The display screen G60 displayed in the display processing of step ST60 is the displayed if the user X flipped a scratch card over at step ST40, this being a screen indicating that the user X has gotten a reward. The display screen G60 shown here indicates that a reward (in this case, a rare card) in the target application P (game P) is gotten by the user X, and it displays an icon K60 indicating the obtaining of the reward and a message label K61 that says, for example, “Got a rare card in game P.”

Because the target application P (game P) is not yet installed in the user terminal 100 of the user X, user X getting a reward in the target application P (game P) means that the user X is temporarily granted the reward. If however, the user X gets a reward of an target application that has been installed in the user terminal 100 of the user X, this would mean that the user X was granted that reward.

The display screen G60 displays a button K65 as an operator item that accepts an operation input to proceed to the next screen. If the button K65 is tapped, processing proceeds to the display processing of step ST70.

The display screen G70 displayed in the display processing of step ST70 is a campaign page display screen that displays the game screen of the executed scratch game, a game information label K71 and game information label K72 indicating information regarding various games. The information regarding each game includes, for example, the game name, information as to whether or not the game has been installed, and information regarding already gotten rewards. The game information label K71 displays the game name as “Target Application A (Game A)”, information indicating that it has already been installed in the user terminal 100 of the user X, and information indicating rewards already gotten by the user X. The game information label K72 displays the game name as “Target Application P (Game P)”, information indicating that it has not yet been installed in the user terminal 100 of the user X, and information indicating rewards already gotten by the user X (rewards temporarily granted), this being the presentation of rewards noted as (4) in FIG. 1.

The game information label K71 and the game information label K72 are displayed as operator items that, when tapped, execute processing in accordance with the game displayed by that game information label. The game information label K71 includes execution instruction information (for example, a URL scheme) that executes game A, and when tapped, displays a prescribed game screen of game A. In contrast, the game information label K72 includes link information to an application store 400, which is a server device providing a store site (downloading service site) from which the target application P (game P) can be downloaded. If the game information label K72 is tapped, the application store 400 is accessed, and a downloading page enabling downloading of the target application P (game P) is displayed.

The above-described display screen displayed on the display of the user terminal 100 displays a part or all of the screen information as information displayed on the display screen. If a part of the screen information is displayed, the user terminal 100 can present a scrolled display to a displayed portion of the screen information in response to a scrolling operation performed at an arbitrary location on the screen, which is, for example, a touch panel.

The constitution and processing of the present embodiment are described below in detailed.

(Network System Constitution)

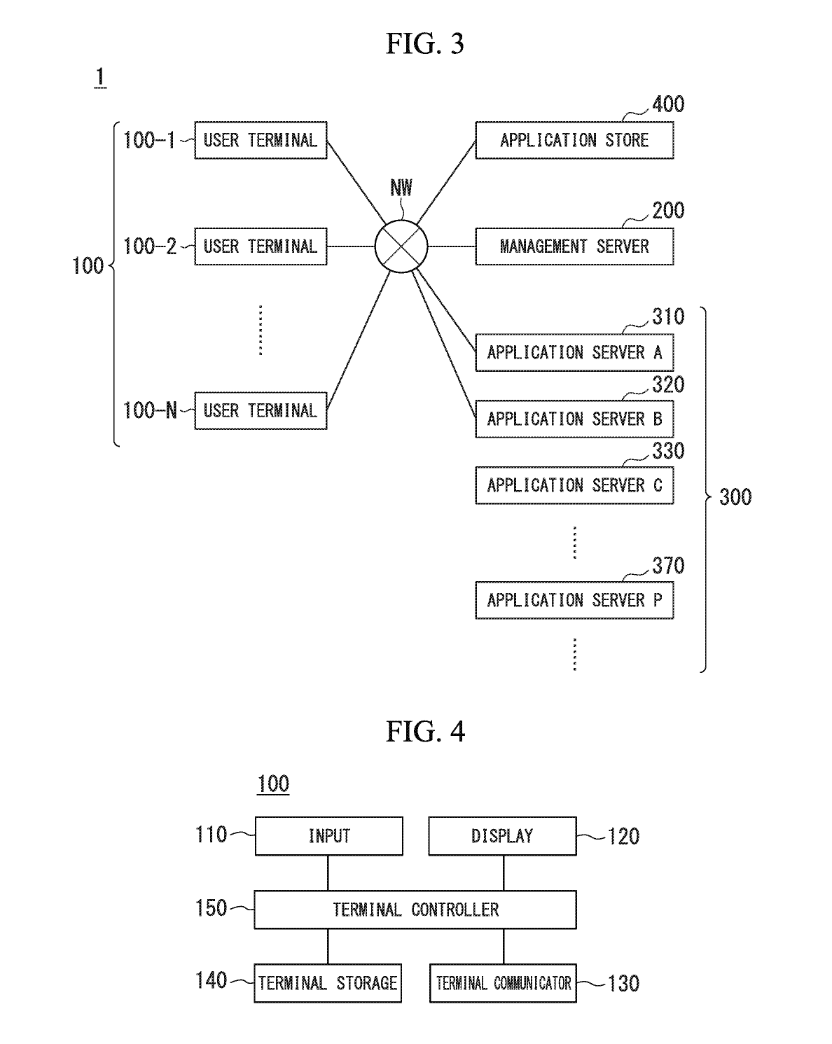

FIG. 3 shows the general constitution of an example of a network system 1 according to the present embodiment, which implements a reciprocal campaign system. A network system 1 has a plurality of user terminals 100-N (where N is a positive integer, the user terminals being the user terminal 100-1, the user terminal 100-2, . . . ), a management server 200, a plurality of application servers 300, and an application store 400, with these computers connected to and capable of communicating via a network NW. In this case, because the plurality of user terminals 100-N have the same constitution, unless a particular distinction is made, the suffixes such as -1, -2, and the like will be omitted and these will be referred to as the user terminal 100.

The user terminal 100 is an example of a terminal device used by a user, this being, for example, a mobile telephone, a smartphone, a tablet terminal, a personal computer, or a game machine with a communication function. In this case, the description will be for a user terminal 100 that is a smartphone.

The management server 200 is an example of a management device that, in addition to managing information regarding a target application in the reciprocal campaign system of the present embodiment and information regarding a campaign set in a target application, manages reward granting management information in a reward application selected as an application in which a reward is granted, from among the target applications.

Specifically, the management server 200, in response to a request from a target application installed in the user terminal 100, provides to the user terminal 100 a campaign page that includes the first content, which can be executed in the user terminal 100. The management server 200, based on the result of executing the first content in the user terminal 100 (the result of the execution of an action of the first content), manages reward granting management information indicating that a reward was granted to a user using the user terminal in at least one application of the managed target applications. The management server 200 then, based on the reward granting management information, if it is managing the reward granting management information in the target application installed in the user terminal 100, transmits the reward granting information to the application server 300 handling that target application. If, based on the reward granting management information, the management server 200 is managing reward granting management information of a target application that is not installed in the user terminal 100, after that target application is installed into the user terminal 100, the management server 200 transmits reward granting information to the application server 300 handling that target application.

The application server 300 is a server device that handles a target application that can be installed into the user terminal 100. In this case, for the example in which the target application to be installed into the user terminal 100 is a game application, the application server 300 is a game server handling various game applications. In FIG. 3, the application server A310, the application server B320, the application server C330, and the application server P370, which handle, as application servers 300, respectively, the target application A, the target application B, the target application C, and the target application P shown in FIG. 1, are shown as being connected to the user terminal 100 and the management server 200 via the network NW.

In the network system 1 is not restricted to the above-described application servers 300, and has a plurality of application servers 300 that handle games that can be installed into and played on the user terminal 100. In this case, a target application to be installed into the user terminal 100 is a so-called native application that, by the application program being installed into the user terminal 100, performs processing (for example, game processing) regarding the application by the user terminal 100, based on the installed program. The user terminal 100 transmits user information regarding the user playing the game to the application server 300 and obtains information required during playing the game from the application server 300.

The application store 400 is a server device providing a store site (downloading service site) from which a target application that can be installed into the user terminal 100 can be downloaded. By the user connecting to the application store 400 from the user's own user terminal 100 via the network NW and purchasing a desired application, either for free or for a fee, the user can download and install the purchased application into the user's own user terminal 100.

The network NW is, for example a mobile telephone network, a PHS (Personal Handy-phone System) network, a VPN (virtual private network), a dedicated communication circuit network, a WAN (wide area network), a LAN (local area network), a PSTN (public switched telephone network), or a combination thereof, serving as an information communication network.

(User Terminal Constitution)

Next, referring to FIG. 4, the constitution of the user terminal 100 according to the present embodiment will be described. FIG. 4 is a drawing showing the general constitution of an example of user terminal 100 according to the first embodiment. As shown in this drawing, the user terminal 100 has an input 110, a display 120, a terminal communicator 130, a terminal storage 140, and a terminal controller 150.

The input 110 is an input device accepts an instruction of a user in response to an operation from the user and generates input instruction information according to the content of the instruction. The input 110 can be, for example, a keyboard or button, a touch panel, a mouse, or a microphone.

The display 120 is a display device that displays information such as images and characters, this being, for example, a LCD (liquid crystal display) or an organic EL (electroluminescence) display. The input 110 and the display 120 can be integrated as a touch panel that accepts operation inputs from a user.

The terminal communicator 130 communicates with the management server 200 or the application server 300 via the network NW.

The terminal storage 140 is constituted by a storage medium such as a RAM (random-access memory), a ROM (read-only memory), a flash ROM, a hard disk (hard disk drive), or a combination thereof, and stores programs for controlling various parts of the user terminal 100 (for example, an OS (operating system) for causing the terminal controller 150 to perform basic operation), installed application programs, and various type of information.

The terminal controller 150 has an information processing device such as a CPU (central processor) that functions as the control center of the user terminal 100 and controls the various parts of the user terminal 100. For example, the terminal controller 150, in addition to executing processing of basic operations based on the operating system stored in the terminal storage 140, executes processing based on the application program (game program). The terminal controller 150 also performs processing to execute, via the operating system, functions of various applications that can run in the operating system (web browsers, applications to display a store page of a store site provided by the application store 400, or the like).

(General Reciprocal Campaign System Constitution)

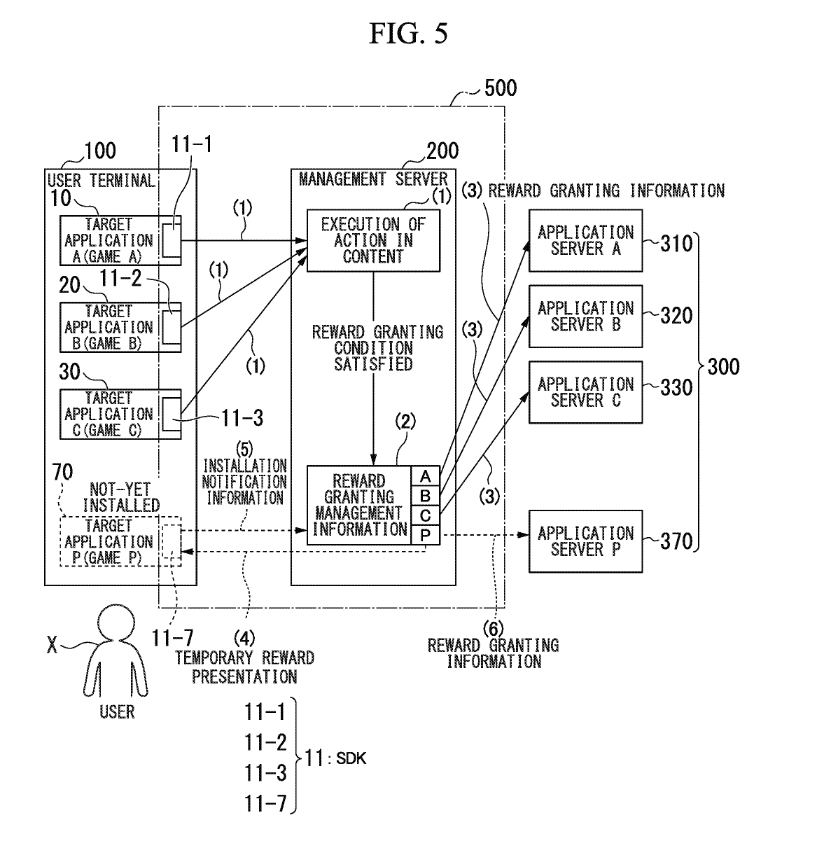

Next, referring to FIG. 5, the general constitution of the reciprocal campaign system according to the present embodiment will be described. FIG. 5 is a schematic representation of an example of the general constitution of a reciprocal campaign system in the network system 1 of the first embodiment.

The reference symbols assigned to the various elements of the schematic representation described using FIG. 1 are the same in FIG. 5. Similar to FIG. 1, the target application A (game A), the target application B (game B), the target application C (game C), and the target application P (game P) are target applications in the same campaign that is currently in progress (that is, target applications participating in the same campaign). In the following description, the target application A (game A), the target application B (game B), and the target application C (game C), which are installed in the user terminal 100 of the user X, are assigned the reference symbols of target application A10, target application B20, and target application C30. The target application P (game P), which is a target application not installed in the user terminal 100 of the user X is assigned the reference symbol of the target application P70.

Software for campaign processing (hereinafter referred to as the SDK (software development kit) 11) is embedded into a target application that accommodates the campaign system of the present embodiment. The SDK 11 is constituted, for example, as a collection of APIs (application programming interfaces) for intermediating between each target application accommodating the reciprocal campaign system installed in the user terminal 100.

In FIG. 5, the SDK 11-1 is embedded in the target application A10, the SDK 11-2 is embedded in target application B20, and the SDK 11-3 is embedded in the target application C30. The SDK 11-7 is embedded in the target application P70. The SDK 11-1, SDK 11-2, SDK 11-3, and SDK 11-7, which are each embedded in a target application and have same constitution, unless they are particularly distinguished, will be referred to as SDK 11, with the suffixes such as -1 and -2 omitted.

The above-described constitution that has the SDK 11 and the management server 200 is the main constitution of the reciprocal campaign system of the present embodiment (refer to reference symbol 500), and this will be noted below as the reciprocal campaign system 500.

Next, the SDK 11 and the management server 200, which are constituent elements of the reciprocal campaign system 500, will be described in detail.

(User Terminal (SDK) Functional Constitution)

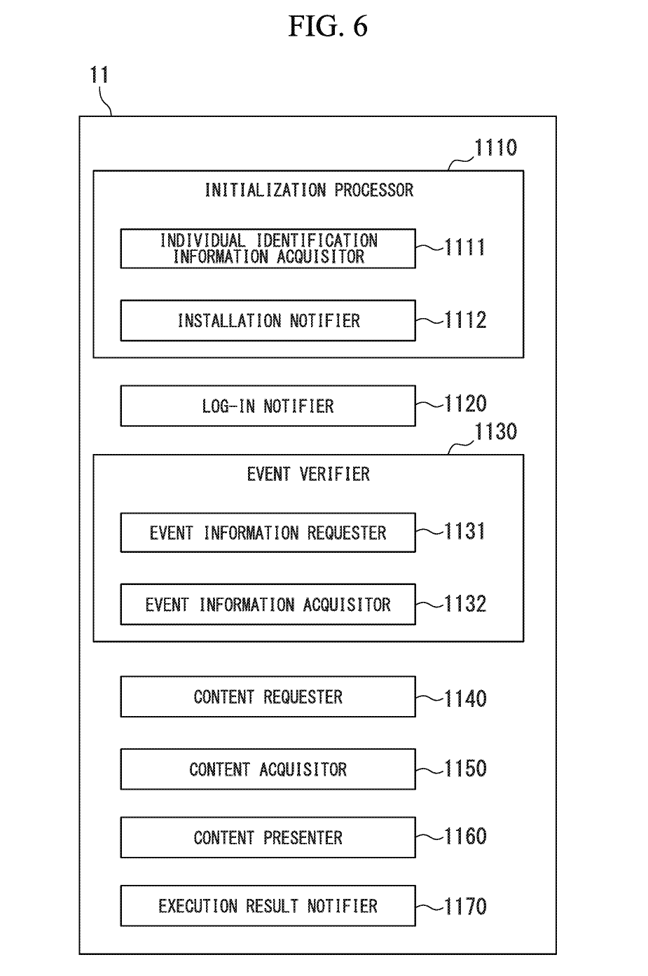

FIG. 6 shows an example of the functional constitution of the campaign processing executed based on the SKD 11 embedded in a target application by the terminal controller 150 in the user terminal 100 according to the present embodiment. Referring to FIG. 5, the functional constitution of the campaign processing executed by the user terminal 100 (SDK 11) in the reciprocal campaign system 500 will be described.

The SDK 11 has an initialization processor 1110, a log-in communicator 1120, an event verifier 1130, a content requester 1140, a content presenter 1150, a content presenter 1160, and an execution result notifier 1170.

When a target application of the SDK 11 embedded destination is installed in the user terminal 100, the initialization processor 1110, as the first-launch processing, acquires information regarding the target application from a target application into which the SDK 11 itself is embedded (for example, an application ID or application user ID). The initialization processor 1110 has a unique identification information acquisitor 1111 and an install notifier 1112.

The unique identification information acquisitor 1111 acquires unique identification information (hereinafter referred to as a reward user ID), which is unique identification information uniquely set for each user terminal 100 and which enables identification of a user terminal 100 (that is, enables identification of a user using the user terminal 100). For example, the unique identification information acquisitor 1111 generates a pseudo-random number series and uses the generated pseudorandom number series to generate a reward user ID corresponding to a user terminal 100 so that it does overlap with the reward user ID of another user terminal 100. The unique identification information acquisitor 1111 stores the acquired reward user ID into the inter-application common area of the terminal storage 140 so that it can be referenced from any target application installed in the user terminal 100.

In this case, if an installed target application is the first of a plurality of target applications to be installed into the user terminal 100, the unique identification information acquisitor 1111 acquires a reward user ID. For example, when each of a plurality of target applications is installed into the user terminal 100, the unique identification information acquisitor 1111 judges whether or not a reward user ID is stored in the terminal storage 140. If the judgment is that the reward user ID is not stored in the terminal storage 140, the unique identification information acquisitor 1111 acquires the reward user ID. Then, the reward user ID acquired by the unique identification information acquisitor 1111 is used for target applications that are subsequently installed.

The install notifier 1112 transmits to the management server 200 install notification information indicating that the target application (the target application in which the SDK 11 itself is embedded) was installed in the user terminal 100. In this case, the above-noted install notification information includes the application ID of the installed target application and the reward user ID identifying the user terminal 100. The install notifier 1112 transmits install notification information both in the case of a target application downloaded from a store site and installed by the user without going through the campaign processing by the reciprocal campaign system 500, and in the case of install via the campaign processing by the reciprocal campaign system 500 (the case in which the target application is simply installed).

The install notifier 1112 may transmit to the management server 200 install notification information that further includes the application user ID in the target application installed into the user terminal 100. That is, the install notifier 1112 functions as a user information notifier that transmits to the management server 200 the application user ID in the target application installed in the user terminal 100. Doing this enables the management server 200 that has acquired the install notification information to manage the application user ID in the target application that was installed and the reward user ID in the association with each other.

The timing of transmission of the application user ID is not restricted to being the timing of the transmission of the install notification information. For example, the application user ID may be included in information other than the install notification information for transmission to the management server 200.

If the target application installed in the user terminal 100 is launched and the user log-in is done, the log-in notifier 1120 transmits to the management server 200, for example only one time per day, log-in notification information indicating that the user has logged into the target application. In this case, the log-in notification information includes an application ID of the target application that was launched and a reward user ID identifying the user terminal 100. This enables the management server 200 to know the number of times a user logs into each target application in the user terminal 100.

The even verifier 1130 verifies information regarding a campaign of a target application (a target application in which the SDK 11 itself is embedded) installed in the user terminal 100 with the management server 200. In this case, the information regarding a campaign is whether a target application is participating in a campaign and, if participating, the campaign status, such as whether or not the campaign is currently in progress. Then, as a result of the verification, the event verifier 1130 acquires provision destination information indicting the provision destination of a campaign page containing content in accordance with the campaign status transmitted from the management server 200. The campaign page provision destination information is, for example, a URL (uniform resource locator) indicating a link destination of the campaign page, this being acquired along with the provision destination information indicting the provision destination of a campaign. In this case, provision destination information indication a provision destination of an advertising image (referred to as a banner) is, for example, a URL indicating the link destination of the advertising image. In the description below, the provision destination information of a campaign page will be referred to as a page URL, and the provision destination information of an advertising image will be referred to as a banner URL.

The event verifier 1130 passes the acquired banner URL and page URL to the target application in which the SDK 11 itself is embedded.

Specifically, the event verifier 1130 has an event information requester 1131 and an event information acquisitor 1132.

The event information requester 1131 sends to the management server 200 request information requesting verification of the campaign status in a target application of a plurality of target applications installed in the user terminal 100.

If the target application for which the event information requester 1131 has sent the above-described request information is an application participating in a campaign and the timing of the management server 200 receiving the above-described request information when the campaign is in progress, the event information acquisitor 1132 acquires a first page URL about which notification was made from the management server 200. In this case, the first page URL is the URL (uniform resource locator) indicating the link destination of a first page of campaign pages displayed on the user terminal 100 which are currently in progress. This campaign page includes a first content (for example, a scratch game) that can be executed in the user terminal 100.

The management server 200 manages a campaign notice period immediately before the campaign period set with respect to a target application participating in a campaign. This campaign notice period starts, for example, three days or one week before the start of a campaign and ends upon the start of the campaign.

If the target application for which the above-described request information was sent by the event information requester 1131 is an application participating in a campaign, the event information acquisitor 1132 acquires a second page URL, notification of which is made from the management server 200 when the timing of the management server 200 receiving the above-described request information is when the campaign is in notice period. In this case, the second page URL is, for example, the URL indicating the link destination of a second page of the campaign pages displayed on the user terminal 100 that are in the campaign notice period. This campaign page includes content (hereinafter referred to as the second content) indicating a prior notice of the start of a campaign period, this being, for example, information indicating the period of conducting the campaign or rewards that can gotten in the campaign.

The management server 200 also manages the campaign ending notice period immediately after the campaign period that is set with respect to a target application participating in the campaign. This campaign ending notice period is, for example, starts upon the end of the campaign and ends three days or one week after the last day of the campaign.

In the case in which the target application for which the above-described request information is transmitted from the event information requester 1131 is an application participating in a campaign and the timing of the management server 200 receiving the above-described request information is during the campaign ending notice period, the event information acquisitor 1132 acquires a third page URL of which notification was made from the management server 200. In this case, the third page URL is the URL indicating the link destination of the third page of campaign pages display on the user terminal 100 during the campaign ending notice period. This campaign page incudes content (hereafter referred to as the third content) indicting a notice of the end of the campaign period.

The event information acquisitor 1132, along with the above-described first page URL, second page URL, and third page URL, acquires from the management server 200 a banner URL indicating the link destination of an advertising image for the campaign. The event information acquisitor 1132 may, based on the timing of the management server 200 receiving the above-described request information, acquire a banner URL in accordance with each of the periods for which notification is made from the management server 200.

The target application, based on the banner and page URLs acquired by the event information acquisitor 1132, causes display on the target application display screen of an advertising image as an operator item for accessing the link destination of the campaign page. If this advertising image is tapped, the content requester 1140 transmits to the management server 200 campaign page display request information, which requests display of the campaign page, as a request to access the link destination of the campaign page from the target application.

That is, the content requester 1140 transmits to the management server 200 campaign page display request information that requests the display of a campaign page in any one of the applications installed in the user terminal 100 of a plurality of target applications.

By the content requester 1140 transmitting to the management server 200 campaign page display request information as a request to access the link destination of a campaign page, the content acquisitor 1150 acquires the link destination campaign page from the management server 200.

For example, by making a request to access the first page URL acquired by the event information acquisitor 1132, the content acquisitor 1150 acquires from the management server 200 a campaign page during the campaign period, which includes the first content that can be executed in the user terminal 100.

Also, by making a request to access the second page URL acquired by the event information acquisitor 1132, the content acquisitor 1150 acquires from the management server 200 a campaign page of a page that is in the campaign notice period that includes the second content indicating the campaign starting notice.

Also, by making a request to access the third page URL acquired by the event information acquisitor 1132, the content acquisitor 1150 acquires from the management server 200 a campaign page of a page that is in the campaign ending notice period that includes the third content indicating the campaign ending notice.

The content acquisitor 1150 acquires from the management server 200 content that includes information regarding a reward to be granted in accordance with the result of execution in the user terminal 100 of the first content executable in the user terminal 100 that was acquired during the campaign period. In this case, the result of execution in the user terminal 100 means the result of execution of action by the user having played (made an operation).

For example, the content acquisitor 1150 acquires from the management server 200 content that includes pre-grant notification information that gives notice before install of a reward granting application in which a reward will be granted in the reward granting application selected as an application in which a reward is granted from among applications not installed in the user terminal 100.

The content acquisitor 1150 acquires from the management server 200 content that includes granting notification information that gives notification that a reward will be granted in a reward granting application selected as an application in which a reward is granted from among applications installed in the user terminal 100. In this case, there is a case in which a target application for which an access request was made by the content requester 1140 to a first page URL selected as the reward granting application and a case in which a reward granting application was selected from among target applications installed in the user terminal 100 other than an target application that made a request for access to the first page URL.

The content acquisitor 1150, in response to the execution result notifier 1170 transmitting the first content execution result to the management server 200, acquires from the management server 200 content that includes pre-grant notification information or granting notification information.

The content presenter 1160 displays on the display 120 so as to present various campaign pages and content acquired by the content acquisitor 1150.

For example, the content presenter 1160 displays on the display 120 campaign pages of campaigns currently in progress, campaigns currently in the campaign notice period, and campaigns currently in the campaign ending notice period, that is, the campaign pages that include the first content, the second content, and the third content. The content presenter 1160 also displays on the display 120 content that includes pre-grant notification information or content that includes granting notification information acquired by the content acquisitor 1150.

The execution result notifier 1170 transmits to the management server 200 information indicating the result of executing an action by a user playing the first content, which can be executed and was provided from the management server 200 during a campaign period. The executable first content is content included in the campaign page acquired by the content acquisitor 1150 during a campaign period and presented by the content presenter 1160.

(Management Server Constitution)

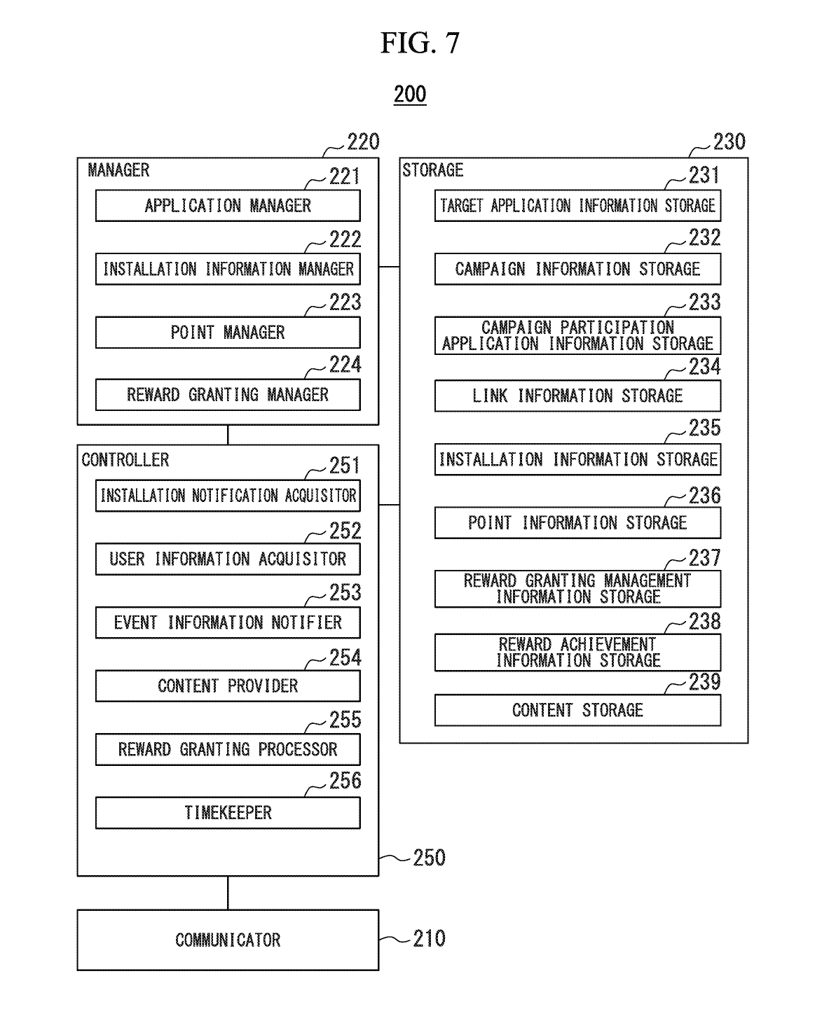

Next, referring to FIG. 7, the constitution of the management server 200 will be described in detail.

FIG. 7 shows an example of the constitution of a management server 200 according to the present embodiment. The management server 200 has a communicator 210, a manager 220, a storage 230, and a controller 250. The communicator 210 communicates with the user terminal 100 and the application server 300 via the network NW.

The manager 220 has an application manager 221, an install information manager 222, a point manager 223, and a reward granting manager 224. The manager 220 associates and stores into the storage 230 and manages various information.

The application manager 221 manages information (hereinafter referred to as target application information) regarding a plurality of target applications that are being managed. In this case, the plurality of target applications that are being managed are a plurality of target applications accommodating the reciprocal campaign system 500. The application manager 221 also manages information regarding campaigns having a campaign period set with respect to a plurality of target applications participating in the campaigns among the plurality of target applications. For example, the application manager 221 manages information regarding campaign names, campaign periods, and the period during which rewards are granted, in association with each other. The application manager 221 also manages information of target application participating in campaigns.

The application manager 221 manages the campaign notice period immediately before the campaign period set with respect to target applications participating in a campaign. The application manager 221 manages the campaign ending notice period immediately after the campaign period set with respect to target applications participating in a campaign.

The install information manager 222, based on the install notification information acquired from the user terminal 100, manages the reward user ID included in the install notification information and the application ID of the installed target application, in association with each other, as install information.

The install information manager 222 may manage the reward user ID, the application ID of the target application, and the application user ID of the target application included in the install notification information as install information associated with each other.

The point manager 223 manages points accumulated by a prescribed value, based on requests from each of a plurality of target applications installed in the user terminal 100. For example, when the point manager 223 acquires log-in notification information from the user terminal 100 indicating that a user has logged into a target application of the plurality of target applications installed in the user terminal 100, the point manager 223 calculates the log-in points that accumulate a prescribed value based on the acquired log-in notification information. The point manager 223 then manages the calculated log-in points and the acquired reward user ID and application ID included in the log-in notification information as the log-in points of each target application of the user, in association with each other. For example, each time it acquires log-in notification information from the user terminal 100, the point manager 223 adds 1 point to the log-in points of the target application with respect to the acquired log-in notification information. The point manager 223 periodically resets the log-in points. For example, the point manager 223 may reset the log-in points if a new campaign starts.

The reward granting manager 224 manages, as reward granting management information, the application ID of a reward granting application from the target applications not installed in the user terminal 100 of a plurality of target applications selected as a reward granting application and the reward user ID identifying the user terminal 100, in association with each other.

The reward granting manager 224 manages, as reward granting management information, the application ID of a reward granting application from the target applications installed in the user terminal 100 of a plurality of target applications selected as a reward granting application, the application user ID in the reward granting application, and the reward user ID identifying the user terminal 100, in association with each other.

For example, if a prescribed condition for granting a reward, based on the result of executing the first content provided to the user terminal 100, is satisfied, the reward granting manager 224 manages the reward granting management information of a reward granting application selected from among applications not installed in the user terminal 100 of a plurality of target applications participating in a campaign.

If a prescribed condition for granting a reward, based on the result of executing the first content provided to the user terminal 100, is satisfied, the reward granting manager 224 manages the reward granting management information of a reward granting application selected from among applications installed in the user terminal 100 of a plurality of target applications participating in a campaign.

That is, if, based on the result of executing the first content provided to user terminal 100, the prescribed condition for granting a reward is satisfied, the reward granting manager 224 manages the reward granting management information of a reward granting application selected from among applications installed in the user terminal 100 and those not installed in the user terminal 100 of a plurality of target applications participating in a campaign.

An arbitrary method can be used for selecting the reward granting application. The method for selecting reward granting application may be the method of selection in accordance with a prescribed rule or condition, or the method of selecting by a drawing. The reward granting application may be determined for each campaign.

The storage 230 stores various information managed by the manager 220 or the controller 250. For example, the storage 230 has a target application information storage 231, a campaign information storage 232, a campaign participation information storage 233, a link information storage 234, an install information storage 235, a point information storage 236, a reward granting management information storage 237, a reward achievement information storage 238, and a content storage 239. The various information may be stored in a format suitable for the use of the information, such as in a database table format or JSON (JavaScript (registered trademark) object notation) format.

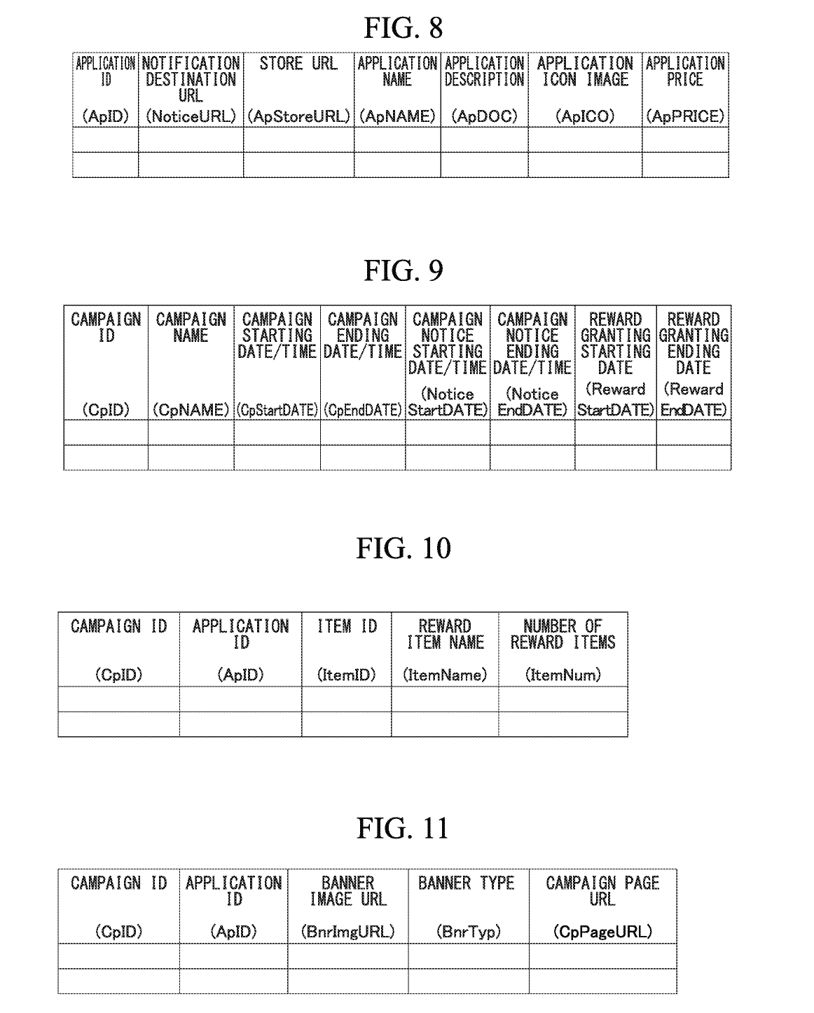

The target application information storage 231 stores target application information regarding target application accommodating the reciprocal campaign system 500. FIG. 8 shows an example of target application information stored in the target application information storage 231. In the target application information, the application ID of the target application (ApID), the notification destination URL (NoticeURL), the store URL (ApStoreURL), the application name indicating the name of the target application (ApNAME), the application description, which is descriptive information regarding the target application (ApDOC), an application icon image which is the image of an icon indicating the target application (ApICO), and an application price (ApPRICE) are associated with each other.

The notification destination (NoticeURL) is the URL (uniform resource locator) of the reward notification destination, in which is set, for example, the URL of the application server 300 handling the target application. The store URL (ApStoreURL) is the URL of the page of the sales site (application store 400) at which the target application can be downloaded. The application price (ApPriceURL) is the sales price of the target application. The above-noted target application information is, for example, set before being made downloadable from the application store 400, stored in the target application information storage 231, and managed by the application manager 221.

The campaign information storage 232 stores information (campaign information) regarding a campaign in which a target application participates. FIG. 9 shows an example of the campaign information stored in the campaign information storage 232. In the campaign information, the campaign ID (CpID), the campaign name (CpNAME), the campaign starting date or time (CpStartDATE), the campaign ending date or time (CpEndDATE), the campaign notice starting date or time (NoticeStartDATE), the campaign notice ending date or time (NoticeEndDATE), the reward granting starting date (RewardStartDATE), and the reward granting ending date (RewardEndDATE) are associated with each other.

The campaign ID (CpID) is identification information that identifies a campaign. The campaign name (CpNAME) is the name of the campaign. The campaign starting date or time (CpStartDATE) and the campaign ending date or time (CpEndDATE) indicate the starting and ending times of the campaign. That is, the campaign period is the period from the campaign starting date or time until the campaign ending date or time. By the user executing the first content included in a campaign during the campaign period, the user can get a reward in the selected reward granting application.

The campaign notice starting date or time (NoticeStartDATE) and the campaign notice ending date or time (NoticeEndDATE) indicate, respectively, the date or time of the start of the campaign notice period (second period) and the date or time of the campaign ending notice period (third period). In this example, the campaign notice period (second period) is set as the period from the campaign notice starting date or time (NoticeStartDATE) until the campaign starting date or time (CpStartDATE). The campaign ending notice period (third period) is the period from the campaign ending date or time (CpEndDATE) until the campaign notice ending date or time (NoticeEndDATE).

Although, in this campaign information example, the campaign starting date or time (CpStartDATE) is set to serve as both the campaign notice period (second period) ending date or time and the campaign period starting date or time, a constitution may be adopted in which these are separately set. In the same manner, although in this campaign information example, the campaign ending date or time (CpEndDATE) serves to set both the campaign period ending date or time and the campaign ending notice period starting date or time, a constitution may be adopted in which these are separately set.

If the granting application in which a user gets a reward during a campaign is installed in the user terminal 100, by the management server 200 transmitting reward granting information to application server 300 handling that reward granting application immediately after the reward is gotten, granting is done quickly in the application server 300. In contrast, if that reward granting application is not installed in the user terminal 100, by the management server 200 transmitting to the application server 300 handling that reward granting application after install into the user terminal 100 subsequent to the getting of the reward, the reward is actually granted in the application server 300. In this manner, when a reward granting application is not yet installed in the user terminal 100, the reward gotten by the user (that is, the temporarily granted award) is not actually granted until that reward granting application is installed into the user terminal 100. Given this, a reward granting period is established in accord with the reward granting starting date or time (RewardStartDATE) and the reward granting end date or time (RewardEndDATE). That is, if the reward granting application is installed during this reward granting time period, the temporarily granted reward is actually granted. In contrast, if the reward granting application is not installed during the reward granting time period, the temporarily granted reward is not actually granted.

For example, a reward granting time period that starts at the start of a campaign period or midway therein and that ends after the campaign period is set with respect to the campaign period. As one example, the campaign starting date or time and the reward granting starting date or time are set to the same date or time and the reward granting ending date or time is set to one week after the campaign ending date or time. If the campaign starting date or time and the reward granting starting date or time are the same date or time, the constitution need not set the reward granting starting date or time, in which case it is sufficient that at least the reward granting ending date or time be set as the reward granting time limit.

This campaign information is set before the campaign starting date or time, stored into the campaign information storage 232, and managed by the application manager 221. This campaign information is set to the same information in the application server 300 handling each of the target application conducting campaigns and the management server 200.

The constitution may be such that the campaign notice period or the campaign ending notice period is not set. The constitution may be such that the reward granting time period is not set separately from the campaign period, or such that the reward granting time period is the same period as the campaign period.

The campaign participation application information storage 233 stores information (hereinafter referred to as campaign participation application information) indicating target applications participating in a campaign set in the campaign information storage 232. In this case, because this is a reciprocal campaign between applications, at least two applications are set in one campaign. FIG. 10 shows an example of the campaign participation application information stored in the campaign participation application information storage 233. In the campaign participation application information, the campaign ID (CpID), the application ID (ApID) of the target application participating in the campaign of that campaign ID, the item ID (ItemID) identifying an item granted as a reward, a reward item name (ItemName) indicating the name of the item, and the number of reward items (ItemNum) indicating the number of items granted as the item reward are associated with each other.

A constitution may be adopted in which the above-described item ID (ItemID), reward item name (ItemName), and number of reward items (ItemNum) are not set. For example, if the content of a reward granted is established in the application server 300 regardless of the type of campaign, it is not necessary to notify the application server 300 of the content of the reward. In contrast, if the content of the reward is set in the campaign participation application information, the content of the reward may be set in accordance with the campaign, and a setting may be made so that the reward differs, depending upon whether the reward granting application is installed or not installed.

The link information storage 234 stores link information regarding the provision destination of a campaign advertising image transmitted to the user terminal 100, in response to the acquisition by the management server 200 of request information requesting information regarding the campaign from the user terminal 100.

FIG. 11 shows an example of link information stored in the link information storage 234. In the link information, the campaign ID (CpID), the application ID (ApID) of the target application participating in the campaign of that campaign ID, the banner image URL (BnrImgURL), the banner type (BnrTyp), and the campaign page URL (CpPageURL) are associated with each other.

The banner image URL (BnrImgURL) is a banner URL indicating the link destination of a campaign advertising image transmitted to the user terminal 100 in response to the acquisition by the management server 200 of request information requesting information regarding the campaign from the user terminal 100. The banner type (BnrType) is information indicating the type of advertising image, this being information for identifying the banner URL of the advertising image in accordance with the period of each campaign. For example, if the banner type (BnrTyp) is 1, this indicates the banner URL of the advertising image (currently in progress banner) transmitted during the campaign period. If the banner type (BnrTyp) is 2, this indicates the banner URL of the advertising image (prior notice banner) transmitted during the campaign notice period. If the banner type (BnrTyp) is 3, this indicates the banner URL of the advertising image (Ended notice banner) transmitted during the campaign ending notice period.

If, with respect to a same campaign, the advertising image to be placed is the same regardless of the target application, one advertising image data is stored in common as the link destination, and if advertising image is different for each target application, the advertising image data corresponding to each target application is stored into the link destinations corresponding to each of the target applications.

The campaign page URL (CpPageURL) is the page URL indicating the link destination of a campaign page transmitted to the user terminal 100 along with the banner URL of the campaign advertising page, in response to acquisition by the management server 200 of request information requesting information regarding the campaign from the user terminal 100. For example, the campaign page URL (CpPageURL) associated with the banner type (BnrTyp) set to 1 is set to the URL of the first page indicating the link destination of the campaign page transmitted during the campaign period. The campaign page URL (CpPageURL) associated with the banner type (BnrTyp) set to 2 is set to the URL of the second page indicating the link destination of the campaign page transmitted during the campaign notice period. The campaign page URL (CpPageURL) associated with the banner type (BnrTyp) set to 3 is set to the URL of the third page indicating the link destination of the campaign page transmitted during the campaign ending notice period.

The install information storage 235 stores install information managed by the install information manager 222, based on install notification information acquired by the management server 200 that was transmitted from the user terminal 100.

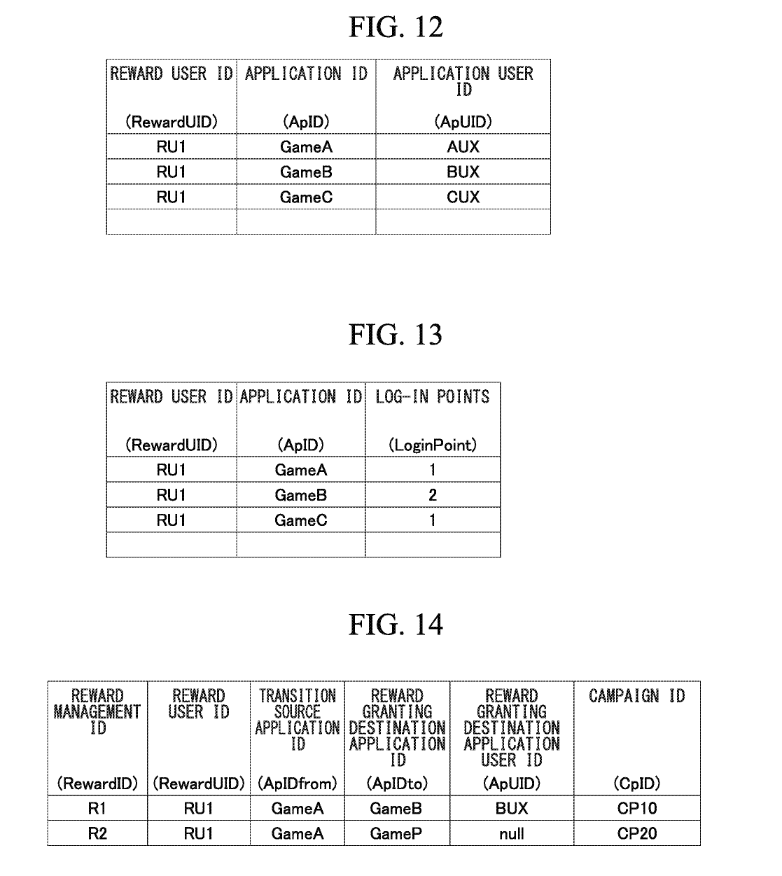

FIG. 12 shows an example of the install information stored in the install information storage 235. In the install information, the reward user ID (RewardUID) included in the acquired install notification information, the application ID (ApID), and the application user ID (ApUID) are associated with each other.

In the example shown in this drawing, the reward user ID of the user X is RU1, the application ID of the target application A10 is GameA, the application ID of the target application B20 is GameB, and the application ID of the target application C30 is GameC. The application user IDs of the user X in the target application A10, the target application B20, and the target application C30 are, respectively, AUX, BUX, and CUX.

That is, the example of install information shown in this drawing includes install information based on the install notification information of the target application A10, the target application B20, and the target application C30 installed in the user terminal 100 of the user X.

The point information storage 236 stores log-in point information managed by the point manager 223, based on log-in notification information acquired by the management server 200 and that was transmitted from the user terminal 100.

FIG. 13 shows an example of the log-in point information stored in the point information storage 236. In the log-in point information, the reward user ID (RewardUID) and the application ID (ApID) included in the acquired log-in notification information, and the log-in points (LoginPoint) are associated with each other. The log-in points (Login Point) are the log-in points calculated by the point manager 223 based on the acquired log-in notification information.

In the example of the log-in point information shown in this drawing, log-in points of target application A10, the target application B20, and the target application C30 for the user X are shown as being 1, 2, and 1, respectively. For example, the number of times the user X has logged into the target application A10 and the target application C30 are shown as 1 time and the number of times the user X has logged into the target application B20 is shown as 2 times.

The point information storage 236 may additionally store, based on the log-in notification information transmitted from the user terminal 100 and acquired by the management server 200, the log-in time indicating the date or time of the acquisition of the log-in notification information. For example, the point information manager 236 may store, as the most-recent log-in for each application, the date or time at the final acquisition of log-in notification information for each application from each user's user terminal 100.

The reward granting management information storage 237 stores reward granting management information indicating that a reward is to be granted in a reward granting application selected from a plurality of target applications.

FIG. 14 shows an example of reward granting management information stored in the reward granting management information storage 237. In the reward granting management information, the reward management ID (RewardID), the reward user ID (RewardUID), the transition source application ID (ApIDfrom), the reward granting destination application ID (ApIDto), the reward granting destination application user ID (ApUID), and the campaign ID (CpID) are associated with each other. The reward management ID (RewardID) is a management ID issued in the sequence of registration to each reward granting management information, so that identification is possible of each reward granting management information. The transition source application ID (ApIDfrom) is an application ID of a target application that has requested the first content executable in the user terminal 100 included in the campaign page, and the reward granting destination application ID (ApIDto) is an application ID of a reward granting application. The reward granting destination application user ID (ApUID) is the user ID in the reward granting application of a user who is using the user terminal 100 identified by the reward user ID. The campaign ID (CpID) is a campaign ID of a campaign that provides the first content executed in the user terminal 100.

In the reward granting management information having the reward management ID of R1 has RU1 as the user X reward user ID, GameA as the transition source application ID, GameB as the reward granting destination application ID, BUX as the reward granting destination application user ID, and CP10 as the campaign ID are associated with each other. This reward granting management information indicates that, in the target application A10 indicated by the transition source application ID, by the user X identified by the reward user ID executing the first content in the campaign having the campaign ID of CP10, the reward in the target application B20 is granted to the user X.

In the reward granting management information having the reward management ID of R2 has RU1 as the user X reward user ID, GameA as the transition source application ID, GameP as the reward granting destination application ID, and CP20 as the campaign ID are associated with each other. In this case, GameP is the application ID of the target application P70. That is, this reward granting management information indicates that the reward in the target application P70 that is not installed in the user terminal 100 is temporarily granted to the user X. In this case, because the target application P70 is not installed in the user terminal 100, the user ID of the user X is not yet registered in the target application P70. For this reason, the reward granting destination application user ID is set to null.

In this manner, in the reward granting management information stored in the reward granting management information storage 237, in the case of the application user ID in the reward granting application having been set, the reward granting application is one that is installed in the user terminal 100, and in the case of the reward granting source application user ID (ApUID) being set to null, the reward granting application is one that is not installed in the user terminal 100.

In this case, for reward granting management information in which the reward granting destination application user ID (ApUID) is set to null, because the application user ID in the reward granting application is unclear, the state is one in which a reward cannot be granted in the application server 300 handling the reward granting application. For this reason, the reward granting information based on this reward granting management information dos not notify the application server 300 handling the reward granting application. When a reward granting application not installed in the user terminal 100 is installed and the application user ID in the reward granting application is registered, the application user ID in the registered reward granting application is set into the reward granting destination application user ID (ApUID) that had been set to null. By doing this, in the application server 300 handling the reward granting application, a reward can be granted to the user indicated by the application user ID, and the reward granting information based on the reward granting management information can give notice to the application server 300 handling the reward granting application.

The reward achievement information storage 238 stores reward achievement information indicating whether or not notification was made to the application server 300 handling the reward granting application of the reward granting information based on the reward granting management information stored in the reward granting management information storage 237.

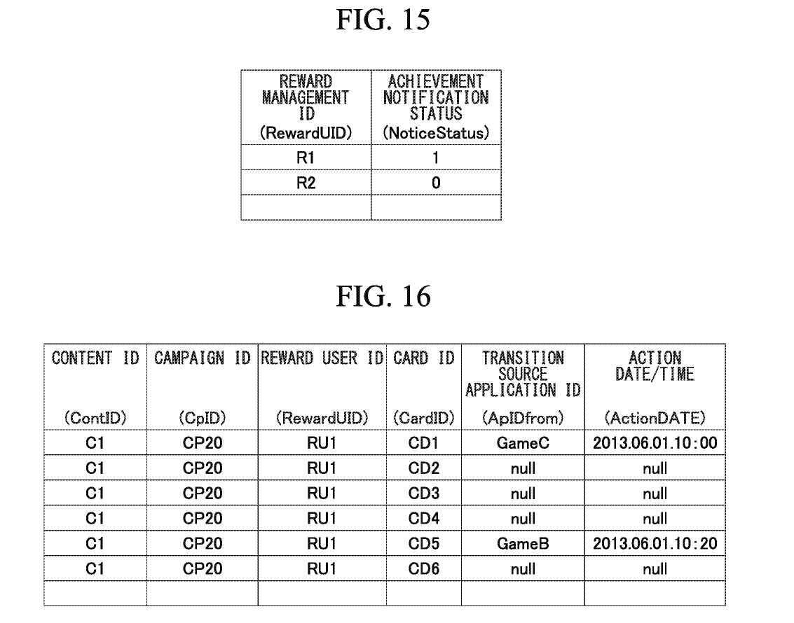

FIG. 15 shows an example of the reward achievement information stored in the reward achievement information storage 238. In the reward achievement information, the reward management ID (RewardID) and the achievement notification status (NoticeStatus) are associated with each other. The reward management ID (RewardID) corresponds to the reward management ID included in the reward granting management information stored in the reward granting management information storage 237. The achievement notification status (NoticeStatus) is set to flag information indicating the status of whether or not notice of the reward granting information based on the corresponding reward granting management information was made by the reward management ID (RewardID) to the application server 300 handling the reward granting application. In this case, the setting of the achievement notification status (NoticeStatus) to a flag value of 0 indicates that notice has not yet been made, and the setting of the achievement notification status (NoticeStatus) to a flag value of 1 indicates that the notice has already been made.

For example, when the reward granting manager 224 generates a new record of reward granting management information (one data of reward granting management information) and stores the data into the reward granting management information storage 237, it generates a new record of reward achievement information corresponding to the reward granting management information (one data of reward achievement information) and stores the data into the reward achievement information storage 238. In this case, when the reward granting manager 224 generates a new record of reward achievement information, it sets the achievement notification status (Notice Status) to a flag value of 0 (not yet notified) as an initial value. After that, when notice is given of reward granting information based on reward granting management information corresponding to this reward achievement information to the application server 300 handling the reward granting application, the reward granting manager 224 updates the achievement notification status (NoticeStatus) to a flag value of 1 (notice already made).

The content storage 239 stores information regarding various content provided to the user terminal 100. For example, the content storage 239 stores information regarding a campaign page corresponding to a link destination transmitted to the user terminal 100 (a campaign page during a campaign period, a campaign notice period, or a campaign ending notice period) or regarding a first content that can be executed in the user terminal 100.

The content storage 239 stores content usage status information indicating the usage status of the first content, based on the result of execution of the first content in the user terminal 100. In this case, the description will use the example of the scratch game described with reference to FIG. 2.

FIG. 16 shows an example of the content usage status information stored in the content storage 239. In the content usage status information, the content ID (ContID), the campaign ID (CpID), the reward user ID (RewardUID), the card ID (CardID), the transition source application ID (ApIDfrom), and the action date or time (ActionDATE) are associated with each other. The content ID (ContID) is identification information identifying the first content. The campaign ID (CpID) is the campaign ID of a campaign including that first content. The reward user ID (RewardUID) is the reward user ID identifying the user terminal 100 in which the first content was executed. The card ID (CardID) is identification information identifying scratch cards (for example, scratch cards having the reference symbols K41 to K46 shown in FIG. 2) displayed on the game screen (refer to G40 in FIG. 2) of the scratch game. The transition source application ID (ApIDfrom) is an application ID of a target application that has requested that first content. The action date or time (ActionDATE) indicates the date or time of acquisition of the action execution results with respect to that first content from the user terminal 100.

In the example of content usage status information shown in this drawing, the scratch card having the card ID of CD1 (for example, the scratch card having the reference symbol K41 shown in FIG. 2) is shown as being in the state of having been acted on (state of the card being flipped over) from the target application C30 indicated by the transition source application ID (GameC). The scratch card having the card ID of CD5 (for example, the scratch card having the reference symbol K45 shown in FIG. 2) is shown as being in the state of having been acted on (state of the card being flipped over) from the target application B20 indicated by the transition source application ID (GameB). The scratch cards having the card IDs of CD2, CD3, CD4, and CD6 (for example, the scratch cards having the reference symbols K42, K43, K44, and K46 shown in FIG. 2) have the transition source application ID set to null and are shown as being in the state of not having been acted on (state of a card not having been flipped over).

Next, returning to FIG. 7, the constitution of the controller 250 will be described.

The controller 250 has an install notification acquisitor 251, a user information acquisitor 252, an event information notifier 253, a content provider 254, a reward granting processor 255, and a timekeeper 256.

The install notification acquisitor 251 acquires from an application installed in the user terminal 100 (the SDK 11 of the target application) install notification information indicating that the application, of a plurality of target applications, has been installed. This install notification information includes the application ID of the target application and the reward user ID identifying that user terminal 100. The install notification information may further include an application user ID in the target application. The install notification acquisitor 251 supplies the acquired install notification information to the install information manager 222.

The user information acquisitor 252 acquires the application user ID of a user using the user terminal 100 in the target application for which the install notification acquisitor 251 acquired the install notification information. For example, the user information acquisitor 252 acquires the application user ID included in the install notification information acquired by the install notification acquisitor 251

The user information acquisitor 252 may acquire an application user ID included in information other than the install notification information. Also, the install notification acquisitor 251 may have the function of the user information acquisitor 252.

When the event information notifier 253 receives a request from a target application (the SDK 11 of the target application) installed in the user terminal 100, it transmits to the user terminal 100 a page URL of a campaign page that includes content in accordance with the campaign status of the requested target application.

For example, the event information notifier 253 acquires request information requesting information regarding a campaign from a target application (the SDK 11 of the target application) installed in the user terminal 100. Then, if the requested target application is a target application participating in a campaign and the timing of the acquisition of the request information was during the campaign period, the event information notifier 253 transmits the first page URL to the user terminal 100. As described above, the first page URL indicates the link destination of a campaign page that includes the first content (for example a scratch game) executable in the user terminal 100.

If the requested target application is a target application participating in a campaign and the timing of the acquisition of the request information was during the campaign notice period, the event information notifier 253 transmits the second notice page URL to the user terminal 100. As described above, the second page URL indicates the link destination of a campaign page that includes the second page indicating notice of the start of the campaign period.

If the requested target application is a target application participating in a campaign and the timing of the acquisition of the request information was during the campaign ending notice period, the event information notifier 253 transmits the third page URL to the user terminal 100. As described above, the third page URL indicates the link destination of a campaign page that includes the third page indicating notice of the end of the campaign period.

The event information notifier 253 may transmit the third page URL only to the user terminal 100 to which the first content executable in the user terminal 100 was provided (for example, the user terminal 100 of a user who has played the first content using the campaign). That is, the event information notifier 253 may, when the timing of the acquiring the request information is during the campaign ending notice period, transmit the third page URL to the user terminal 100 to which the first content has been provided based on an access request to access the first page URL from a target application installed in the user terminal 100.

Doing this enables the link destination of a campaign page including the third content indicating the notice of the end of a campaign period to not be notified to a user terminal 100 of a user who has not used the campaign.

The event information notifier 253, along with the above-described first page URL, second page URL, or third page URL, references link information stored in the link information storage 234 and transmits to the user terminal 100 a banner URL indicating the link destination of a campaign advertising image. For example, the banner URL is set to a banner image URL (BnrImgURL) included in the link information stored in the link information storage 234, and is a URL (BnrImgURL) set in the banner image URL associated with the banner type (BnrTyp) corresponding to each of the campaign periods.

In a target application installed in the user terminal 100, when an advertising image display based on the page URL and the banner URL transmitted by the event information notifier 253 is tapped, campaign page display request information requesting display of the campaign page of the link destination indicated by the page URL is transmitted from the target application (the SDK 11 of the target application). The content provider 254 acquires the campaign page display request information transmitted from the target application (the SDK 11 of the target application) installed in the user terminal 100 as a request to access the first page URL, a request to access the second page URL, or a request to access the third page URL.

The content provider 254, based on a request to access a first page URL from a target application (the SDK 11 of the target application) installed in the user terminal 100, transmits to the user terminal 100 the campaign page that includes the first content. The content provider 254, based on a request to access a second page URL from a target application (the SDK 11 of the target application) installed in the user terminal 100, transmits to the user terminal 100 the campaign page that includes the second content. The content provider 254, based on a request to access a third page URL from a target application (the SDK 11 of the target application) installed in the user terminal 100, transmits to the user terminal 100 the campaign page that includes the third content.

The content provider 254 limits the number of times of providing the first content in response to requests from the same target application within a prescribed time period to a prescribed number of times. For example, the content provider 254 limits the number of times that the first content can be executed to one time per day in response to requests to access the first page URL from the same target application. The above-noted prescribed number of times may be arbitrarily set for each campaign and each target application.

The reward granting processor 255, based on reward granting management information managed in the reward granting manager 224, transmits to the application server 300 handling a reward granting application reward granting information that was associated with the application user ID in the reward granting application.

For example, the reward granting processor 255 references the granting management information stored in the reward granting management information storage 237 and the reward achievement information stored in the reward achievement information storage 238 and extracts reward granting management information in which the achievement notification status (NoticeStatus) is set to a flag value of 0 (not yet notified). Of the extracted reward granting management information, if there is a reward granting management information for reward granting applications already installed in the user terminal 100, the reward granting processor 255 transmits to the application server 300 handing a reward granting application reward granting information that was associated with the application user ID in the reward granting application.

In this case, under the condition that the application user ID is set in the reward granting destination user ID (ApUID) included in the reward granting management information, the reward granting processor 255 judges that the reward granting application included in the reward granting management information has been installed into the user terminal 100.

If the reward granting destination user ID (ApUID) included in the reward granting management information is set to null, the reward granting processor 255 judges that the reward granting application included in the reward granting management information is not installed in the user terminal 100 (not yet installed). In this case, the reward granting processor 255, not sending the reward granting information until the application user ID is set in the reward granting destination application user ID, after the application user ID is set in the reward granting destination application user ID (ApUID), transmits to the application server 300 handling the reward granting application reward granting information that was associated with the application user ID in the reward granting application.

In this case, after the application user ID is set in the reward granting destination application user ID (ApUID) is after install information indicating that a not-yet-installed reward granting application has been installed into the user terminal 100 has been acquired by the install notification acquisitor 251 and also after the application user ID in the reward granting application has been acquired by the management server 200.

That is, if the reward granting processor 255, based on reward granting management information managed in the reward granting manager 224, judges that the install notification acquisitor 251 has acquired install notification information indicating that a reward granting application was installed into the user terminal 100 and also that the user information acquisitor 252 has acquired the application user ID in the reward granting application, it transmits to the application server 300 handling the reward granting application reward granting information that was associated with the application user ID in the installed reward granting application.

If a reward granting time period (reward granting time limit) is managed in the application manager 221, and the reward granting processor 255 judges that the install notification acquisitor 251 has acquired the install notification information indicating install, indicating that a reward granting application was installed into the user terminal 100 within the reward granting time limit and also the user information acquisitor 252 has acquired the application user ID in the reward granting application, the above-described reward granting information may be transmitted to the application server 300 handling the reward granting application.

The reward granting processor 255 may judge whether or not a reward granting application included in the reward granting management information has been installed into the user terminal 100 and whether or not the application user ID in the reward granting application has been acquired, based on whether or not the application user ID is set into the reward granting application user ID (ApUID) included in the reward granting management information, or based on the install information stored in the install information storage 235.

The timekeeper 256 keeps the time and acquires the current date or time. The timekeeper 256 may acquire the current date or time via the network NW from a date or time information providing server (not shown) that provides the current date or time data.

For example, the event information notifier 253, based on information indicating the current date or time kept by the timekeeper 256, judges whether or not the timing of acquisition of request information from the user terminal 100 requesting information regarding a campaign was during the campaign period, during the campaign notice period, during the campaign ending notice period, or at a time other than these periods. The reward granting processing 255, based on information indicating the current date or time kept by the timekeeper 256, judges whether or not the current date or time is during the campaign period or during the reward granting time period. The various information storages (231 to 239) managed by the storage 230 may store in each record a data registration date or time indicating the date or time that the record was generated and a data updating date or time indicating the date or time that a part of the generated record was updated. For example, in the data registration date or time stored in the install information storage 235, the date or time, as kept by the timekeeper 256, that the install information was acquired from the user terminal 100 is stored, this being data indicating the date or time of install of the target application corresponding to that install information in the user terminal 100.

(Campaign Processing Operation)

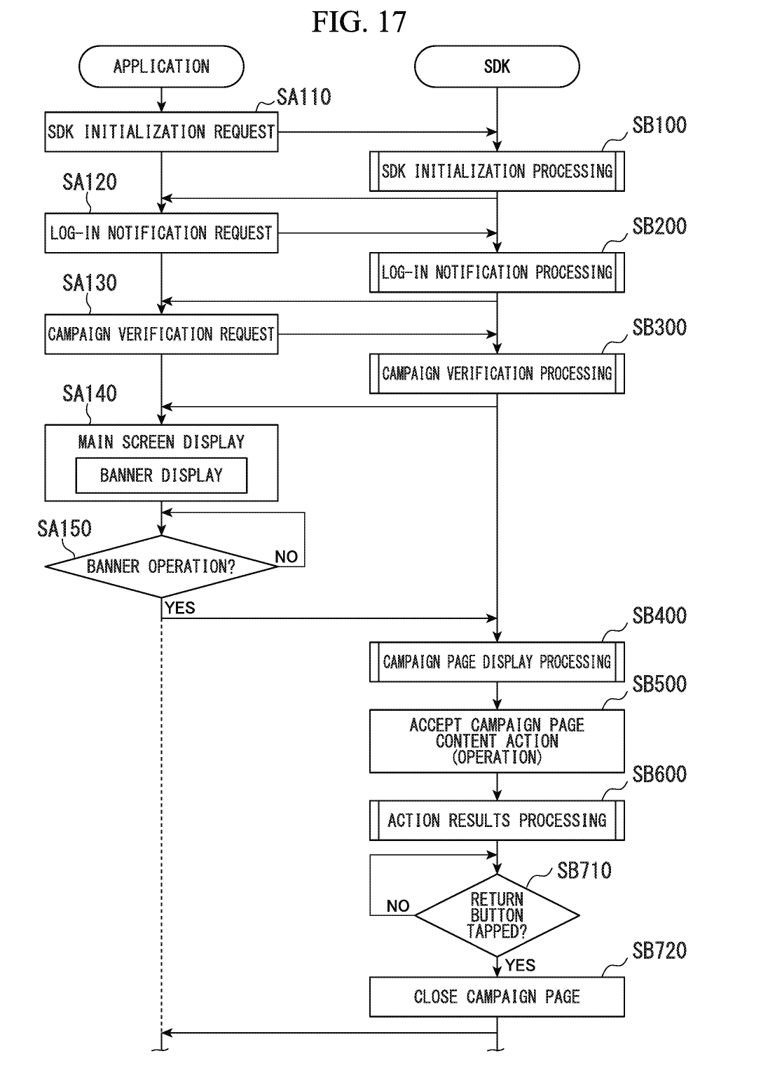

Next, referring to FIG. 17 to FIG. 23, the campaign processing operation by the reciprocal campaign system 500 according to the present embodiment will be described in detail.

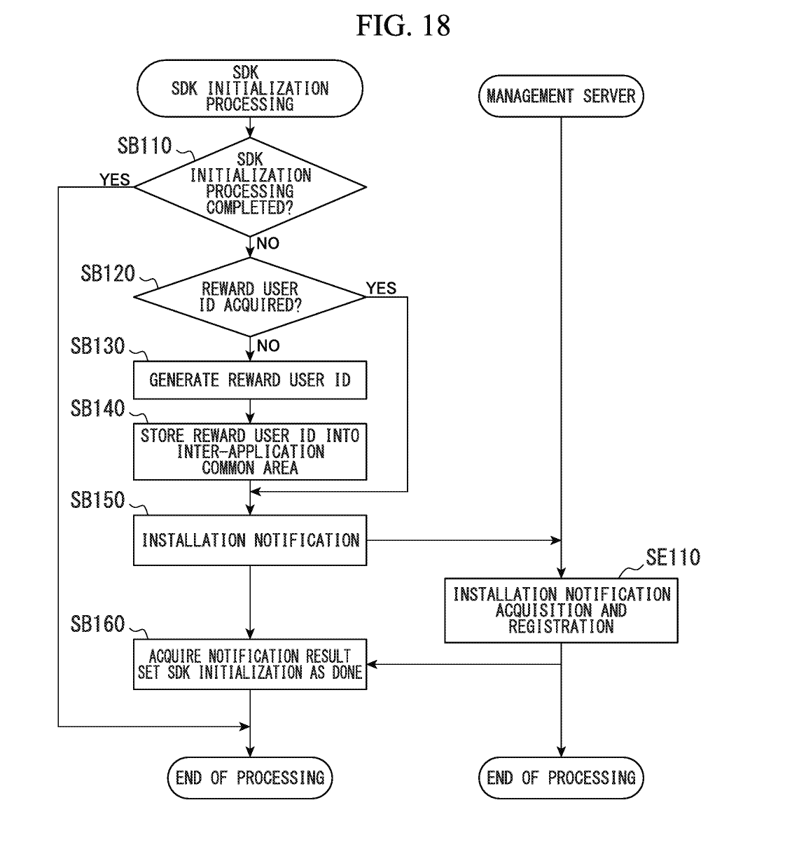

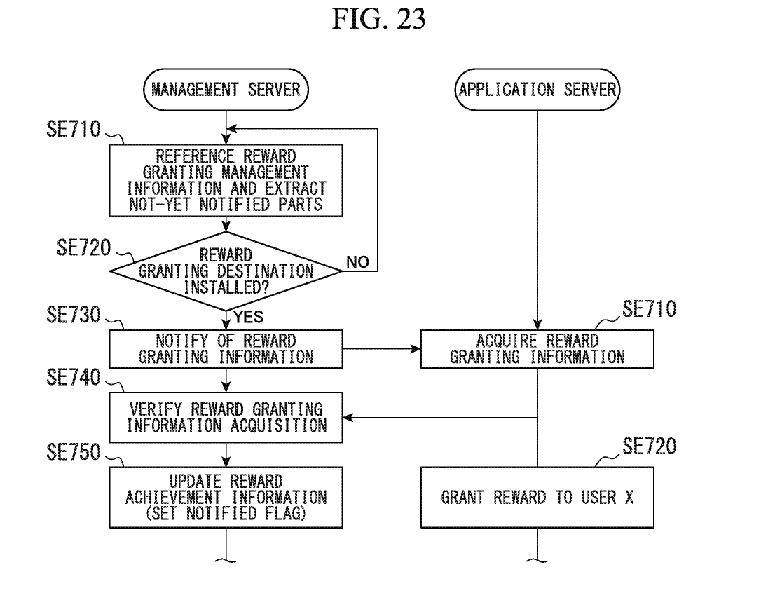

FIG. 17 is an operational drawing showing an example of the overall flow of operation in the first processing in the campaign processing. FIG. 18 through FIG. 22 show the detailed operation in the campaign processing shown in FIG. 17. FIG. 23 is an operational drawing showing an example of the operation in the second processing in the campaign processing. In this case, the first processing is processing whereby the management server 200 manages the rewards granted in a campaign as reward granting management information, and the second processing is processing whereby, based on the reward granting management information managed by the management server 200, the application server 300 grants rewards. At this point, the example described is the processing for the case in which the user X uses a campaign from the target application A10 installed in the user terminal 100.

First, referring to FIG. 17 to FIG. 22, the operation of the first processing in the campaign processing will be described.

(Operation in SDK Initialization Processing)

When the target application A10 is installed in the user X's user terminal 100 and launched, the target application requests the SDK 11-1 embedded therein to execute initialization processing of the SDK (step SA110).

Upon receiving the SDK initialization processing execution request from the target application A10, the SDK 11-1 executes SDK initialization processing. In this SDK initialization processing, the SDK 11-1 executes processing to acquire the reward user ID and processing to transmit the install notification information to the management server 200. The SDK 11-1, upon completion of the SDK initialization processing, responds to the target application A10 with a completion notification indicating that the initialization processing has been completed (step SB100).

At this point, referring to FIG. 18, the SDK initialization processing at this step SB100 will be described. The initialization processor 1110 of the SDK 11-1, as processing that is executed at only the first time of launching, acquires from the target application A10 the application ID (ApID) of the target application A10 in the embedded destination and the application user ID (ApUID) of the user X registered in the target application A10.

Next, the initialization processor 1110 of the SDK 11-1 judges whether or not the initialization processing has been completed (step SB110). If it is judged that the initialization processing has been completed (YES at step SB110), the initialization processing 1110 ends the SDK initialization processing without execution subsequent initialization processing. However, if the judgment is that the initialization processing has not been completed (NO at step SB110), the individual identification information acquisitor 1111 of the SDK 11-1 references the terminal storage 140 and judges whether or not the reward user ID has been acquired (step SB120). The judgment of whether or not the reward user ID has been acquired is made by whether or not a reward user ID is stored in the inter-application common area of the terminal storage 140 to enable referencing from any target application installed in the user terminal 100.

If the judgment is that the reward user ID has been acquired (YES at step SB120), the individual identification information acquisitor 1111 of the SDK 11-1 reads out the reward user ID from the terminal storage 140 and processing proceeds to step SB150.

If, however, the judgment is that the reward user ID has not been acquired (NO at step SB120), the individual identification information acquisitor 1111 of the SDK 11-1 generates and acquires a reward user ID (a unique ID in the reciprocal campaign system 500) corresponding to the user terminal 100 (step SB130).

Next the individual identification information acquisitor 1111 of the SDK 11-1 stores the acquired reward user ID into the inter-application common area of the terminal storage 140 (step SB140).

Continuing, the install notifier 1112 of the SDK 11-1 transmits to the management server 200 install notification information indicating that the target application A10 was installed into the user terminal 100 (step SB150). In this case, the install notification information includes the reward user ID (RewardUID) identifying the user terminal 100, the application ID (ApID) of the installed target application A10, and application user ID (ApUID) of the user X registered in the target application A10.

Next, the install notification acquisitor 251 the management server 200 acquires install notification information transmitted from the user terminal 100 (SDK 11-1). The install notification acquisitor 251 then transmits to the user terminal 100 (SDK 11-1) response information (notification results) indicating acquisition of the install notification information. The install information manager 222 stores into the install information storage 235 as install information, in association with each other, the reward user IS (RewardUID), the application ID (ApID) of the target application A10, and the application user ID (ApUID) of the user X in the target application A10, which are included in the install notification information acquired by the install notification acquisitor 251 (step SE110).

Upon acquiring the response information (notification result) from the management server 200, the initialization processor 1110 of the SDK 11-1 sets a flag that indicates that initialization has been done and ends the initialization processing (step SB160).

(Log-in Notification Processing Operation)

Returning to FIG. 17, next, the target application A10 requests the SDK 11-1 to execute log-in notification processing (step SA120). Upon receiving the request to execute log-in notification processing from the target application A10, the SDK 11-1 executes log-in notification processing. In this log-in notification processing, the SDK 11-1 transmits to the management server 200 log-in notification information indicating that the user X has logged into the target application A10. When the log-in notification processing has been completed, the SDK 11-1 responds to the target application A10 with a completion notification indicating that the log-in notification processing has been completed (step SB200).

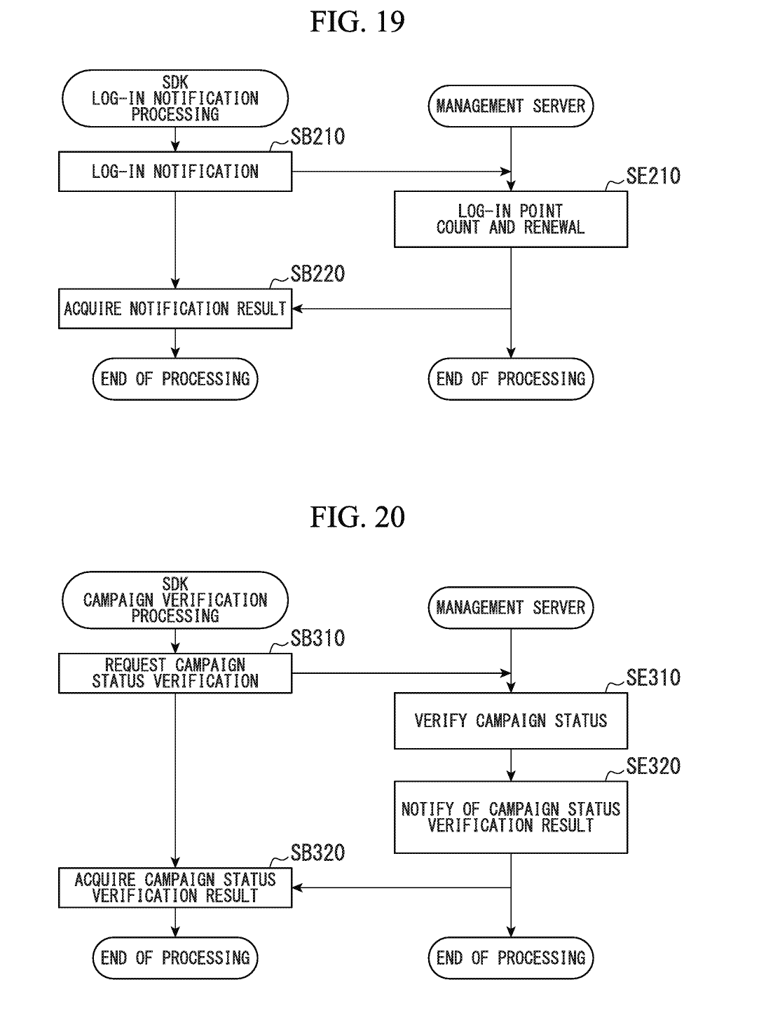

The log-in notification processing at step SB200 will now be described, with reference made to FIG. 19.

The log-in notifier 1120 of the SDK 11-1 transmits to the management server 200 log-in notification information indicating that the user X has logged into the target application A10 (step SB210). In this case, the log-in notification information includes the reward user ID (RewardUID) identifying the user terminal 100 and the application ID (ApID) of the target application A10. The log-in notifier 1120 transmits the log-in notification information to the management server 200 only one time per day. For example, the log-in notifier 1120 stores flag information into the terminal storage 140 that indicates that log-in notification information was transmitted to the management server 200 and, based on that flag information, limits the transmission of log-in notification information to one time per day.

Upon acquiring log-in notification information from the user terminal 100 (SDK 11-1), the point manager 223 of the management server 200, based on the acquired log-in notification information, calculates the log-in points by accumulating a prescribed value. The point manager 223, based on the calculated log-in points, the reward user ID (RewardUID) included in the log-in notification information, and the application ID (ApID), updates the point information stored in the point information storage 236. The point manager 223 transmits to the user terminal 100 (SDK 11-1) response information (notification results) indicating the updating of the point information based on the log-in notification information (step SE210).

The log-in notifier 1120 of the SDK 11-1 acquires the response information (notification results) transmitted from the management server 200 and ends the log-in notification processing (step SB220).

Rather than the log-in notifier 1120 of the SDK 11-1 limiting the transmission of log-in notification information to one time per day, the log-in notifier 1120 of the SDK 11-1 may limit the updating of the point information by the point manager 223 of the management server 200 to one time per day.

(Campaign Verification Processing Operation)

Returning to FIG. 17, the target application A10 next requests the SDK 11-1 to execute campaign verification processing (step SA130). Upon receiving the request from the target application A10 to execute campaign verification processing, the SDK 11-1 executes campaign verification processing. In the campaign verification processing, the SDK 11-1 verifies information regarding the campaign of the target application A10 (campaign status). When the campaign verification processing is completed, the SDK 11-1 responds to the target application A10 with a completion notification indicating that the campaign verification processing is completed (step SB300).

The campaign verification processing at step SB300 will now be described, with reference made to FIG. 20.

The event information requester 1131 of the SDK 11-1 transmits to the management server 200 request information that requests verification (campaign status verification) of the campaign status (step SB310).

The event information notifier 253 of the management server 200, upon receiving request information from the user terminal 100 (SDK 11-1) requesting campaign status verification, references the acquired date or time, the campaign information stored in the campaign information storage 232, and the campaign participation application information stored in the campaign participation application information storage 233 and verifies the campaign status of the target application A10 for which the request was made (step SE310). In this case, the campaign status of the target application A10 indicates one of the target application A10 being in a currently running campaign, being in a campaign notice period, being in a campaign ending notice period, or being in a period other than these periods.

Next, the event information notifier 253 of the management server 200 makes notification of the verification (campaign status verification result) of the campaign status of the target application A10. Specifically, the event information notifier 253 transmits to the user terminal 100 the URL of a campaign page and the URL of an advertising image that include content in accordance with the status of the campaign of the target application A10 (step SE320).

The event information acquisitor 1132 of the SDK 11-1 acquires from the management server 200 as campaign status verification result, the URL of a campaign page and the banner URL of an advertising image that include content in accordance with the status of the campaign of the target application A10 and stores these into the terminal storage 140 (step SB320).

Returning to FIG. 17, next, when the target application A10 receives completion notification from the SDK 11-1 indicating that the campaign verification processing has been completed, it displays an advertising image for displaying the campaign page at a prescribed position on the main screen displayed on the display 120 (for example, refer to the display screen G10 shown in FIG. 2). Specifically, the target application A10 references the terminal storage 140 and, based on the campaign page URL and the advertising image banner URL acquired by the event information acquisitor 1132 of the SDK 11-1, displays the advertising image linked to the banner URL as an operator item for displaying the campaign page to which the page URL links (step SA140).

If the advertising image is tapped (YES at step SA150), the target application A10 requests the SDK 11-1 to execute the campaign processing. In, however, the advertising image is not tapped (NO at step SA150), the condition in which the main screen is displayed continues.

Upon receiving a request to execute SDK campaign processing from the target application A10, the SDK 11-1 executes campaign page display processing (step SB400) and action result processing (step SB600).

In the campaign page display processing at step SB400, the SDK 11-1 acquires from the management server 200 and displays a campaign page in accordance with the tapped advertising image. For example, if the target application A10 is in a campaign currently in progress, the SDK 11-1 acquires from the management server 200 a campaign page that includes a first content executable in the user terminal 100 and displays the campaign page on the display 120 (for example, refer to the display screen G40 shown in FIG. 2).

Upon the input 110 accepting an action (tap) by the user X with respect to the first content of the campaign page displayed on the display 120 (step SB500), the SDK 11-1 executes the action results processing (step SB600).

In the action results processing at step SB600, the SDK 11-1 transmits to the management server 200 information indicating the action execution results of the user X with respect to the first content. Then, the SDK 11-1 acquires a campaign page according to the action execution results from the management server 200 and displays the campaign page on the display 120. For example, if the reward granting condition is satisfied according to the action execution results, the SDK 11-1 acquires from the management server 200 a campaign page that includes information indicting the reward to be granted in the reward granting application selected from a plurality of target applications and displays the campaign page on the display 120 (for example, refer to the display screens G60 and G70 shown in FIG. 2).

Next, if an icon as an operator item (Return button) for returning the display to the main screen of the target application A10 in the campaign page displayed on the display 120 is tapped (YES at step SB710), the SDK 11-1 ends the display of the campaign page that had been displayed on the display 120 and closes the campaign page (step SB720). This returns the display screen of the display 120 to the main screen of the target application A10.

The operation of the campaign page display processing at the above-described step SB400 and of the action results processing at the above-described step SB600 will be described below in detail, in which case the description of the processing operation will be for the case in which the target application A10 is in a campaign currently in progress.

(Campaign Page Display Processing Operation)

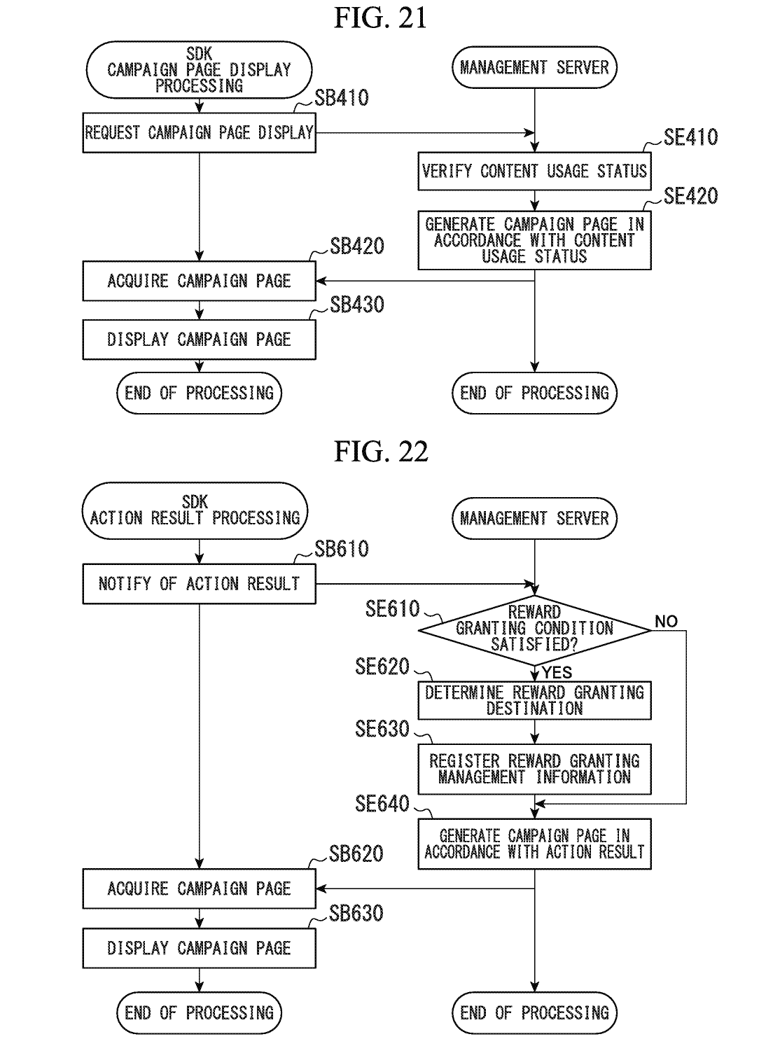

First, referring to FIG. 21, the operation in the campaign page display processing at step SB400 will be described.

The content requester 1140 of the SDK 11-1 transmits to the management server 200 campaign page display request information requesting display of a campaign page as a request to access a link destination of the campaign page from the target application A10 (step SB410). The campaign page display request information indicates a request to access the first page URL indicating the link destination of the campaign page that includes the first content executable in the user terminal 100. In this case, the request information includes, for example, the reward user ID identifying the user terminal 100, an application ID, a campaign ID, and the first page URL of the target application A10.

Upon acquiring the request information requesting access to the first page URL from the user terminal 100 (SDK 11-1), the content provider 254 of the management server 200 references the content usage status information stored in the content storage 239 and verifies the status of usage of the first content of the campaign page linked to the first page URL by the user X (step SE410).

Next, the content provider 254 of the management server 200, based on the results of the verification of the first content usage status, generates a campaign page in accordance with the first content usage status, and transmits the campaign page to the user terminal 100 (step SE420). If the first content is in a status in which execution is possible, the content provider 254 transmits to the user terminal 100 a campaign page including the executable first content. In the scratch game example, the first content being executable indicates the condition in which there is a scratch card that can be flipping over by tapping it.

The content acquisitor 1150 of the SDK 11-1 acquires the campaign page transmitted from the management server 200 (step SB420). Then, the content provider 1160 of the SDK 11-1 displays on the display 120 the campaign page acquired by the content acquisitor 1150 (step SB430). This causes the display of a campaign page that includes the executable first content on the display 120 of the user terminal 100 (for example, refer to the display screen G40 shown in FIG. 2).

In contrast, if the first content is in a status not enabling execution, the content provider 254 transmits to the user terminal 100 a campaign page that includes information indicating that the first content cannot be used. In the scratch game example, the first content not being executable means the condition in which there is no scratch card that can be flipped over by tapping.

The above displays on the display 120 of the user terminal 100 a campaign page including information indicating that the first content cannot be used (for example, refer to the display screen G50 shown in FIG. 2).

(Action Results Processing Operation)

Next, referring to FIG. 22, the operation in the action result processing at step SB600 will be described. In this case, the first content displayed on the display 120 of the user terminal 100 will be assumed to be executable.

The execution results notifier 1170 of the SDK 11-1 transmits to the management server 200 information indicating the action execution result of the user X with respect to the first content (step SB610).

The reward granting manager 224 of the management server 200, based on the information indicting the action execution results acquired from the user terminal 100 (SDK 11-1), judges whether or not the reward granting condition has been satisfied (step SE610).

For example, in the example in which the first content is a scratch game, the reward granting manager 224 judges that the reward granting condition has been satisfied each time the user X flips over a scratch card. As described above, the reward granting condition for granting a reward is not limited to this. For example, there may be a card that is a “Hit” or a “Miss” card that can be distinguished only after a scratch card is flipped over, with a reward being granted only in the case of flipping over a Hit card. Also, a reward may be granted when all of the displayed scratch cards are flipped over.

If the judgment at step SE610 is that the reward granting condition has been satisfied (YES at step SE610), the reward granting manager 224 of the management server 200 selects a reward granting application for granting a reward from a plurality of target application managed by the application manager 221, and determines the target application of the reward granting destination (step SE620).

Next, the reward granting manager 224 of the management server 200 generates a new record of reward granting management information indicating that a reward will be granted to the user X in the reward granting application selected at step SE620, and registers this into the reward granting management information storage 237 (step SE630).

In this case, the reward granting manager 224 references the install information stored in the install information storage 235 and judges whether or not install information based on install notification information indicating that the selected reward granting application is installed in the user terminal 100 of the user X.

If the judgment is made that install information corresponding to the reward granting application is stored, the reward granting manager 224 generates a new record of reward granting information, in which the reward user ID, the target application A10 application ID as the transition source application ID, the application ID of the reward granting application, the application user ID of the reward granting application, and the campaign ID are associated with each other and stores the record in the reward granting management information storage 237.

If, however, the judgment is that install information corresponding to the reward granting application is not stored, the reward granting manager 224 generates a new record of reward granting management information, in which the reward user ID, the target application A10 application ID as the transition source application ID, the application ID of the reward granting application, and the campaign ID are associated with each other and stores the record in the reward granting management information storage 237.

When storing the new record of reward granting management information into the reward granting management information storage 237, the reward granting manager 224 generates a new record of reward achievement information corresponding to the reward granting management information, sets the achievement notification status to a flag value of 0 (not yet notified) and stores this into the reward achievement information storage 238.

Next, the content provider 254 of the management server 200 generates a campaign page in accordance with the user X action execution results with respect to the first content. That is, the content provider 254, based on the reward granting management information registered by the reward granting manager 224, generates a campaign page that includes information regarding a reward granting application in which a reward will be granted to the user X (step SE640).

For example, if the target application P70 that is not installed in the user terminal 100 is selected as the reward granting application, the content provider 254 generates a campaign page that includes information regarding the target application P70 in which a reward was temporally granted before being installed into the user terminal 100 of the user X (that is, pre-grant notification information). If the target application A10, the target application B20, or the target application C30 that is already installed in the user terminal 100 is selected as the reward granting application, the content provider 254 generates a campaign page that includes information regarding the target application A10, the target application B20, or the target application C30, in which a reward is granted (that is, granting notification information).

The content acquisitor 1150 of the SDK 11-1 acquires the campaign page transmitted from the management server 200 (step SB620). Then the content presenter 1160 of the SDK 11-1 causes the display 120 to display the campaign page acquired by the content acquisitor 1150 (step SB630). This causes the display 120 of the user terminal 100 to display the campaign page that includes information regarding the reward granting application in which a reward will be granted (for example, refer to display screen G70 shown in FIG. 2).

(Reward Granting Processing Operation) Next, FIG. 23 shows an example of the operation in the second processing in the campaign processing. The second processing is processing in which, based on reward granting management information managed by the management server 200, a reward is granted in the application server 300.

The reward granting processor 255 of the management server 200, of the reward granting management information managed in the reward granting manager 224, extracts reward granting management information regarding which notification has not yet been made to the application server 300 handing a reward granting application. Specifically, the reward granting processor 255 references the reward granting management information stored in the reward granting management information storage 237 and the reward achievement information stored in the reward achievement information storage 238 and, of the reward granting management information that includes a reward user ID identifying the user terminal 100 of the user X, extracts reward granting management information in which the achievement notification status (NoticeStatus) is set to a flag of value 0 (not yet notified) (step SE710).

The reward granting processor 255 judges whether or not the reward granting application included in the reward granting management information extracted at step SE710 has been installed in the user terminal 100 (step SE720). For example, under the condition that an application user ID is set in the reward granting destination application user ID included in the reward granting management information, the reward granting processor 255 judges that the reward granting application included in the reward granting management information is already installed in the user terminal 100. If null is set in the reward granting destination application user ID included in the reward granting management information, the reward granting processor 255 judges that the reward granting application included in the reward granting management information is not already installed in the user terminal 100 (is uninstalled).

At step SE720, if the judgment is that the reward granting application included in the reward granting management information is not already installed in the user terminal 100 (is uninstalled) (NO at step SE720), the reward granting processor 255 returns to the processing of step SE710. For example, regarding reward granting management information in which the reward granting application is the target application P70 (refer to FIG. 14), judgment is that the target application P70 is not already installed in the user terminal 100 (uninstalled).

At step SE720, if the judgment is that the reward granting application including the reward granting management information is already installed in the user terminal 100 (YES at step SE710), the reward granting processor 255 transmits to the application server 300 handling the reward granting application indicated by the reward granting destination application ID reward granting information associated with the application user ID set in the reward granting destination application user ID included in the reward granting management information (step SE730).

Consider that the target application P70 that was not yet installed has been installed into the user terminal 100 of the user X. In this case, the reward granting manager 224 sets the application user ID included in the install notification information of the target application P70 acquired from the user terminal 100 (SDK 11-1) by the install notification acquisitor 251 into the reward granting destination application user ID included in the reward granting management information (refer to FIG. 14), in which the reward granting application is the target application P70.

By doing this, the target application P70 is judged to have already been installed in the user terminal 100, and the reward granting processor 255 transmits to the application server P370 handling the target application P70 indicated by the reward granting destination application ID reward granting information associated with the application user ID set in the reward granting destination application user ID included in the reward granting management information.

In the case in which, at the point at which the reward granting management information is generated, the target application A, target application B, or target application C that has already been installed in the user terminal 100 is a reward granting application, the judgment is made immediately at step SE720 that install has already been done, and the reward granting processor 255 transmits reward granting information associated with the application user ID of the target application A, target application B, or target application C to the application server A310, the application server B320, or the application server C330 handling the target application A, target application B, or target application C.

Upon acquiring reward granting information in association with the application user ID in the reward granting application transmitted form the management server 200, the application server 300 transmits response information indicating the acquisition to the management server 200 (step SF710). Then, the application server 300, based on the acquired reward granting information, grants a reward to the user indicated by the application user ID in the reward granting application (step SF720). In this case, the reward granted by the application server 300 may be a pre-established reward or, if information regarding the reward set in the management server 200 (campaign participation application information storage 233) is included in the reward granting information, it may be that set reward.

The reward granting manager 224, by acquiring response information from the application server 300 indicating the acquisition of reward granting information, verifies that reward granting information was received by the application server 300 (step SE740). Then, the reward granting manager 224, upon verifying the acquisition by the application server 300 of the reward granting information, updates to a flag value of 1 (already notified) the achievement notification status included in the reward granting achievement information associated with the reward management ID in the reward granting management information corresponding to the reward granting information of the reward granting achievement information stored in the reward achievement information storage 238 (step SE750).

(Summary)

(1) As has been described above, the management server 200 (an example of a management device) according to the present embodiment has an application manager 221 that manages information regarding a plurality of target applications to be managed and a user information acquisitor 252 that, of a plurality of target applications, acquires an application user ID (an example of user information) of a user who uses a user terminal 100 in each of the applications from each of a plurality of applications installed in the user terminal 100 (an example of a terminal device).

The management server 200 has a content provider 254 and a reward granting processor 255. The content provider 254 transmits (provides) to the user terminal 100 a first content (an example of content) executable in the user terminal 100. The reward granting processor 255, based on the results of executing in the user terminal 100 the first content provided by the content provider 254, of a plurality of target applications installed in at least the user terminal 100, transmits to the application server 300 (an example of a server device) handling a reward granting application installed in the user terminal 100 reward granting information associated with user information in the reward granting application selected as a target application in which a reward is granted.

In this manner, the management server 200, by conducting a campaign targeted at a plurality of target applications, one of the target applications installed in the user terminal 100 of the user grants a reward, in accordance with the results of a user executing a first content provided in a campaign. This enables an increase in the motivation for a user to use a target application. For example, when a reward is granted in a target application which a user does not use that much, the motivation for the user to use that target application again is increased. That is, the management server 200 can increase the motivation for a user to once again use an application that the user no longer uses.

(2) The management server 200 has an install notification acquisitor 251 that, from an application installed in the user terminal 100 of a plurality of target applications, acquires install notification information that indicates the application was installed and that includes the application ID of the application (an example of identification information) and a reward user ID (an example of an individual identification information) identifying the user terminal 100 into which the application is installed. The management server 200 has a reward granting manager 224, which manages the application ID of a reward granting application selected based on the result of executing the first content (an example of a content) and a reward user ID identifying the user terminal 100, in association with each other, as reward granting management information. The individual identification information, in addition to the reward user ID generated uniquely in the reciprocal campaign system 500, may be an identification number, such as a UDID (Unique Device Identifier), an IMEI (International Mobile Equipment Identity), or an IMSI (International Mobile Subscriber Identity), or the like uniquely assigned to the user terminal 100. Also, these identification numbers may be used for hashing or encryption. That is, it is sufficient that this be identification information uniquely assigned in a user terminal 100, which is set or generated either within the reciprocal campaign system 500 or outside thereof.

If the reward granting application managed as reward granting management information in the reward granting manager 224 is an application installed in the user terminal 100, the reward granting processor 255 transmits (notifies) to the application server 300 handling the reward granting application reward granting information that was associated with the application user ID (an example of a user information) in the reward granting application.

If the reward granting application managed as reward granting management information in the reward granting manager 224 is an application not installed in the user terminal 100, if the reward granting processor 255, based on the reward granting management information managed in the reward granting manager 224, judges that the install notification acquisitor 251 acquired install notification information indicating that the reward granting application was installed into the user terminal 100 and also the user information acquisitor 252 acquired the application user ID in the reward granting application, the reward granting processor 255 transmits (notifies) to the application server 300 handling the reward granting application reward granting information associated with the application user ID in the reward granting application.

In this manner, by conducting a campaign targeted at a plurality of target applications the management server 200 can, in accordance with the result of a user executing the first content, which is provided in a campaign, not only grant a reward to a target application installed in the user terminal 100, but also temporarily grant a reward to a target application not installed in the user terminal 100. Alternatively, by conducting a campaign targeted at a plurality of target applications the management server 200 of a plurality of target application in accordance with the result of a user executing the first content, which is provided in a campaign, not only may a reward be granted to a target application installed in the user terminal 100, but also a reward may be temporarily granted to a target application not installed in the user terminal 100. That is, as the reward granting applications, the reward granting processor 255, regardless of whether they are installed in the user terminal 100, may select from all of a plurality of target applications managed by the application manager 221 or may select from all of a specific plurality of target applications managed by the application manager 221. A target application satisfying a prescribed condition or a specific application may be excluded. In this case, the term specific application indicates, for example, from among a plurality of target applications, a target application that is participating in a campaign. In the following, the target application participating in a campaign will be referred to as a specific application.

Doing the above enables an increase in the motivation for a user to use a target application that the user has not yet used. The result is the effect of increasing the number of installs of a target application.

In the management server 200, because reward granting management information for a target application that is temporarily granted a reward before install into the user terminal 100 is generated and managed, and the reward is actually granted to the target application based on the reward granting management information after install, it is not necessary on the target application or application server 300 side to manage rewards for users who have not yet used (are not registered in) applications.

In addition to managing the application ID (an example of identification information) of an application installed in the user terminal 100 and a reward user ID (an example of individual identification information) identifying the user terminal 100, which are included in the install notification information, in association with each other, the install information manager 222 manages the reward user ID and the application user ID in the application (an example of user information) in association with each other.

(3) The application manager manages a reward granting time limit that establishes at least an ending date or time. If the reward granting processor 255 judges that the install notification acquisitor 251 has acquired install notification information indicating that the reward granting application was installed into the user terminal 100 within the reward granting time limit and also the user information acquisitor 252 has acquired the application user ID (an example of user information) in the reward granting application, it transmits (makes notification of the) reward granting information.

In this manner because a time limit for granting a reward is set, it is possible to heighten the motivation for the user to install and use a target application in which a reward has been temporarily granted.

The install information manager 222 may either directly or indirectly associate and manage install date or time information based on the timing of the acquisition of install notification information, an application ID (an example of identification information) of an application that was installed in the user terminal 100, and a reward user ID (an example of individual identification identifying the user terminal 100, which are included in the install notification information. In the case, the reward granting processor 255 transmits (notifies of) reward granting information, if it judges that the install notification acquisitor 251 has acquired install notification information indicating that the reward granting application was installed into the user terminal 100 and also the user information acquisitor 252 has acquired the application user ID (an example of user information) in the reward granting application, and in which install date or time information corresponding to the reward granting application and managed by the install information manager is within the reward granting time limit.

(4) The content provider 254 transmits (provides) to the user terminal 100 the first content (an example of a content) executable in the user terminal 100. If, based on the result of executing the first content provided to the user terminal 100 by the content provider 254, a prescribed condition for reward granting is satisfied, the reward granting manager 224 manages the reward granting management information of reward granting application selected from among applications not installed in the user terminal 100 of a plurality of target applications.

In this manner, for example, in contrast to a banner advertisement that simply displays an advertisement, because the first content executable in the user terminal 100 is provided and a reward is granted in accordance with the result of that execution, it is possible to heighten the interest of the user, and to further increase the motivation for the user to install and use the target application.

(5) The first content (an example of a content) transmitted (provided) by the content provider 254 is accepted by an operation of the user of the user terminal 100 and processing providing a result in accordance with that operation is executed. If, in the first content provided by the content provider 254 to the user terminal 100, the prescribed condition for reward granting was satisfied in accordance with the operation, the reward granting manager 224 manages the reward granting management information of reward granting application selected from among applications not installed in the user terminal 100 of a plurality of target applications. As the reward granting applications, selection from among specific applications installed in the user terminal 100 may be made, or selection may be made of a plurality of specific applications may be made, regardless of whether or not they are installed in the user terminal 100.

In this manner, for example, in contrast to a banner advertisement that simply displays an advertisement, because the first content that accepts a user operation is provided and a reward is granted in response to the result of that operation, it is possible to heighten the sense of participation and possible to further increase the motivation for the user to install and use the target application. For example, if the first content has a drawing element, if a reward can be gotten by a user operation, because of the feeling of satisfaction that the user himself or herself has gotten the reward by good fortune, it is possible to lead to the install of the target application.

(6) If a prescribed condition for granting a reward is satisfied in the first content (an example of a content) provided by the content provider 254, the reward granting manager 224 manages reward granting management information of a reward granting application selected from among applications not installed in the user terminal 100 and applications installed in the user terminal 100 of a plurality of target applications.

By doing this, the management server 200 can manage both target applications installed in the user terminal 100 and target applications not installed in the user terminal 100 so that rewards are granted in both.

For example, a user can exist who is mainly interested in the applications currently being used and does not have an interest in new applications. In this case, it can be envisioned that there will not be interest in the first content itself. Given this, by making it possible to get a reward with respect to a target application that the user is already using in accordance with the result of executing the first content, it is possible to make the user interested in the first content. By doing this, it is possible to have the user use the first content, even in the case of a user with little interest in the new application. After that, by granting a reward in the new target application that the user has not yet installed, it is possible to impart to the user a trigger for having an interest in the target application.

(7) The content provider 254, in response to a request from an application installed in the user terminal 100 of a plurality of target applications, transmits (provides) the first content (an example of a content). The reward granting manager 224 manages reward granting management information of a reward granting application selected from among applications other than the application requesting the first content of the plurality of target applications.

In this manner, because a reward is granted in a target application selected from among applications other than the transition destination application of a plurality of target applications accommodating the reciprocal campaign system 500, it is possible to heighten the motivation for the user to use the target application. Therefore, it is possible to make reciprocal transfer of customers to a target application not installed in the user terminal 100, and to promote use of a target application that, although installed in the user terminal 100, is not used that much.

A target application that requested the first content may be included in the reward granting applications. In this case as well, it is possible to further promote use of the target application that requested the first content.

(8) The content provider 254 may limit the provision of the first content in response to a request from the same application within a prescribed period of time to a prescribed number of times, for example, to one time per day.

In this manner, because the execution of the first content by the same application is limited, it is possible provide a trigger for the user to play many target applications. It is also possible to heighten the motivation for the user to install and use a target application not installed in the user terminal 100.

(9) The user terminal 100 can communicate with the management server 200 managing the information regarding a plurality of target applications being managed and has a content acquisitor 1150, a content presenter 1160, and an execution result notifier 1170.

The content acquisitor 1150 acquires a first content (an example of a content) executable in the user terminal 100 (an example of the user's own terminal device), which has been transmitted (provided) from the management server 200. The content presenter 1160 presents the first content that is executable and was acquired by the content acquisitor 1150. The execution result notifier 1170 transmits (notifies) to the management server 200 the results of executing the first content, which is executable and which was presented by the content presenter 1160.

The content acquisitor 1150, in response to the execution result notifier 1170 transmitting (notifying) the result of executing the first content to the management server 200, acquires from the management server 200 a first content, which includes pre-grant notification information that makes notification before the install of a reward granting application that a reward has been granted in a reward granting application selected as an application in which a reward will be given, from among application not installed in the user terminal 100 (an example of the user's own terminal device) of a plurality of target applications. The content presenter 1160 then presents the first content, which includes the pre-grant notification information acquired by the content acquisitor 1150.

In this manner, before the target application is installed, the user terminal 100 displays that a reward was temporarily granted in a target application not installed in itself, in response to the result of executing the first content. This enables an increase in the motivation for a user to use a target application that the user has not yet used.

(10) The content acquisitor 1150, in response to the execution result notifier 1170 transmitting to (notifying) the management server 200 the results of executing the first content (an example of a content), acquires from the management server 200 the first content, which includes granting notification information giving notification that a reward will be granted in a reward granting application selected as an application to which a reward is granted from among applications installed in the user terminal 100 (an example of the user's own terminal device) of a plurality of target applications. The content presenter 1160 then presents the first content, in which the granting notification information acquired by the content acquisitor 1150 is included.

In this manner, the user terminal 100 displays that a reward has been granted in one of the target applications installed in itself, in response to the result of executing the first content. This enables an increase in the motivation for the user to use the target application. For example, if a reward is granted in a target application that the user is not using that much, it is possible to heighten the motivation for the user to use that target application once again. That is, the user terminal 100 can increase the motivation for a user to use once again an application that the user has stopped using.

(11) The user terminal 100 has a content requester 1140 that requests from the management server 200 an executable first content (an example of a content) in an application installed in the user terminal 100 (an example of a the user's own terminal device) from among a plurality of target applications. The content acquisitor 1150 then acquires the executable first content transmitted (provided) from the management server 200 in response to the requesting from the content requester 1140.

In this manner, because the first content is executed from a target application installed in the user terminal 100, it is possible to perform reciprocal transfer of customers between a plurality of target applications. Thus, the effect of increasing the number of installs of target applications is achieved.

(12) In the management server 200, in addition to the management of each application ID (an example of identification information) of a plurality of target application, an application ID of a reward granting application and a reward user ID (an example of individual identification information) identifying the user terminal 100 are managed in association with each other as reward granting management information.

The content acquisitor 1150 of the user terminal 100, in response to the execution results notifier 1170 transmitting (notifying) to the management server 200 the result of executing the first content, acquires from the management server 200 the first content, which includes pre-grant notification information based on the reward granting management information managed by the management server 200.

The user terminal 100 has an install notifier 1112. The install notifier 1112 transmits (notifies) to the management server 200 install notification information indicating that an application of a plurality of target applications was installed in the user terminal 100 (an example of the user's own terminal device), which is install notification information in which an application ID (an example of identification information) of the application and a reward user ID (an example of individual identification information) identifying the user terminal 100 are included.

If a target application is installed in the user terminal 100, this enables management of the application ID of the installed target application and the reward user ID identifying the user terminal 100 in association with each other. It is therefore possible for the management server 200 to identify the installed target applications for each user terminal 100.

(13) The install notifier 1112 also has the function of a user information notifier. The user information notifier transmits (notifies) to the management server 200 the application user ID (an example of user information) of a user using the user terminal 100 in an application installed in the user terminal 100 (an example of the user's own terminal device) of a plurality of target applications.

By doing this, if a target application is installed in the user terminal 100, the management server 200 can manage the application user ID of the installed application, the application ID of the target application, and the reward user ID identifying the user terminal 100 in association with each other. Thus, the management server 200 can identify the application user ID in the target applications installed in each user terminal 100.

(14) The user terminal 100 has an individual identification information acquisitor 1111. If the application installed in the user terminal 100 (an example of a the user's own terminal device) is the target application of a plurality of target applications that is first installed in the user terminal 100, the individual identification information acquisitor 1111 acquires the reward user IS (an example of individual identification information) and stores the acquired reward user ID (an example of individual identification information) into the terminal storage 140 (an example of a storage) so that it can be referenced from any target application installed in the user terminal 100.

That is, the reward user ID (an example of individual identification information) identifying the user terminal 100 is acquired under the condition that the target application, of the plurality of target applications, that was first installed in the user terminal 100 is launched, and is stored in the user terminal 100 so that it can be referenced from any target application installed in the user terminal 100. The reward user ID can be generated by any one of the user terminal 100, the application server 300, or the management server 200 in the reciprocal campaign system 500 and the generated reward user ID is acquired at the user terminal 100.

In this manner, in the reciprocal campaign system 500, the user terminal 100 automatically acquires the reward user ID when a target application is first installed, and the acquired reward user ID can be used in common even by subsequently installed applications. For this reason, it is possible to acquire the reward user ID and use the system without having the user make any special operations.

Specifically, when each of a plurality of target applications is installed in the user terminal 100, the individual identification information acquisitor 1111 judges whether or not the reward user ID (an example of individual identification information) is stored in the terminal storage 140 (an example of a storage) and, if the judgment is that the reward user ID is not stored in the terminal storage 140, acquires the reward user ID.

This enables the user terminal 100 to acquire the reward user ID when a target application is first installed and launched.

(15) Applications that are targets selected as reward granting applications for which the above-described reward granting management information is managed are a plurality of specific applications participating in a campaign of a plurality of target applications.

The application manager 221 of the application server 200 manages information regarding a plurality of specific applications of a plurality of target application that are the targets of management. The user information acquisitor 252 acquires the application user ID (an example of user information) of a user who uses the user terminal 100 in each of the applications, from a plurality of applications installed in the user terminal 100 of a plurality of specific applications. The content provider 254 transmits (provides) to the user terminal 100 a first content executable in the user terminal 100.

The reward granting processor 255, based on the result of execution in the user terminal 100 of the first content provided by the content provider 254, from at least a plurality of specific applications installed in the user terminal 100, transmits (notifies) to the application server 300 (an example of a server device) handling the reward granting application installed in the user terminal 100 reward granting information, which is associated user information in the reward granting application selected as a specific application in which a reward is to be granted.

In this manner, by conducting a campaign targeted at two or more specific application of a plurality of target applications, the management server 200, in response to the result of the user executing the first content provided in the campaign, grants a reward to one of the specific applications installed in the user terminal 100 of that user. This enables an increase in the motivation for the user to use the specific application. For example, if a reward is granted in a specific application that the user does not use that much, it is possible to heighten the motivation to use that specific application once again.

The content acquisitor 1150 of the user terminal 100, in response to the execution result notifier 1170 transmitting (notifying) the management server 200 of the result of executing the first content, acquires from the management server 200 a first content, which includes granting notification information that gives notification that a reward will be granted in a reward granting application selected as an application in which a reward will be granted from among applications installed in the user terminal 100 (an example of the user's own terminal device) of a plurality of specific applications. Then, the content presenter 1160 presents the first content, which includes the granting notification information acquired by the content acquisitor 1150.

In this manner, in reciprocal campaign system 500, by conducting a campaign targeted at a plurality of target applications, a reward is granted to any one specific application, in response to the result of executing the first content provided to the specific applications participating in the campaign. This evokes a special feeling on the part of user with respect to the campaign, and enables a heightening of the motivation for the user to use the target application.

(16) For example, the application manager 221 manages a campaign period (an example of a first period) set with respect to a plurality of specific applications. The content provider 254 transmits (provides) to the user terminal 100 the first content in this campaign period.

The content acquisitor 1150 of the user terminal 100 acquires from the application server 200 first content, which is executable during the campaign period (an example of a first period).

In this manner, in the reciprocal campaign system 500, because the user terminal 100 is made to be able to execute the first content during the campaign period, it is possible to evoke a special feeling on the part of the user for a limited time and to heighten the motivation for the user to use the target application.

(17) The content acquisitor 1150 of the user terminal 100 may acquire from the management server 200 a first content that includes granting notification information indicating that a reward was granted in a reward granting application selected from applications different from an application that requested the executable first content.

This enables the user terminal 100 to present to the user the fact that a reward was granted in an application differing from the application that has executed the first content.

(18) The reward granting applications may include an application that is not installed in the user terminal 100 (an example of the user's own terminal device).

This enables the user terminal 100 to present to the user the fact that a reward was temporarily granted in a not-yet-installed application.

(19) The application manager 221 of the management server 200 manages information regarding a plurality of target applications that are being managed and information regarding a campaign (an example of an event) having a campaign period (an example of a first period) set with respect to a plurality of specific applications of the plurality of target applications.

The management server 200 further has an event information notifier 253, which, in response to the receiving a request from an application installed in the user terminal 100 of a plurality of target applications, when the application that made the request being a specific application, transmits (notifies) to the user terminal 100 a first page URL (an example of a first provision destination information) indicating the provision destination of the first content transmitted (provided) when the timing of receiving the request is during the campaign period.

The content provider 254, based on the request to access the first page URL from the application installed in the user terminal 100, transmits (provides) the first content to the user terminal 100.

In this manner, in response to an inquiry from a target application installed in the user terminal 100, a judgment is made of whether or not the target application is in a currently running campaign and, if it is, notification is made of the page URL of the campaign page to the target application. This eliminates the need for the target application or the application server 300 to manage the campaign page URL. For example, in cases such as when different campaigns are being conducted at the same time and different campaign pages are provided for each campaign, it is possible to handle diverse requirements from the campaign operator side. In this manner, by managing the periods and each content for the campaigns, the management server 200 can provide to the user information regarding a campaign in accordance with the campaign period, without changing the program of the target application installed in the user terminal 100. In this case, changing the program refers to a change requiring the updating of the program.

(20) The user terminal 100 can communicate with the management server 200 that manages information regarding a plurality of target application that are being managed and information regarding campaign (an example of an event) having a campaign period (an example of a first period) set with respect to a plurality of specific applications of the plurality of target applications.

The user terminal 100 has an event information requester 1131, an event information acquisitor 1132, a content acquisitor 1150, and a content presenter 1160.

The event information requester 1131 transmits to the management server 200 request information requesting information regarding a campaign in an application, of a plurality of target applications, installed in the user terminal 100 (an example of the user's own terminal device).

If the application with regard to which the event information requester 1131 transmitted the above-noted request information is a specific application, the event information acquisitor 1132 acquires the first page URL (an example of a first provision destination information) that was notified about from the management server 200 when the timing of the management server 200 receiving the above-noted request information was during the campaign period.

The content acquisitor 1150, by requesting to access the first page URL (an example of a first provision destination information) acquired by the event information acquisitor 1132, acquires the first content transmitted (provided) from the management server 200. The content presenter 1160 displays (presents) the first content acquired by the content acquisitor 1150 on the display 120.

In this manner, because the management server 200 judges whether or not the installed target application is in the campaign page, even if the user terminal 100 does not manage the campaign period, it is possible to acquire the page URL of the campaign page from the management server 200 during the campaign period. That is, without changing the installed target application program, the user terminal 100 can provide to the user information regarding a campaign in accordance with the campaign page.

(21) The application manager 221 of the management server 200 manages the campaign notice period (an example of a second period) immediately before the campaign period (an example of a first period) set with respect to a plurality of specific applications.

The event information notifier 253 of the management server 200, in response to a receiving a request from an application installed in the user terminal 100, if the application making the request is a specific application, transmits (notifies) to the user terminal 100 the second page URL (an example of a second provision destination information) indicating the second content provision destination that is provided when the timing of the receiving of the request was during the campaign notice period.

In this case, the second content is content indicating a notice of the start of the campaign period (an example of a first period) in which the first content is provided.

In this manner, the management server 200, in response to an inquiry from a target application installed in the user terminal 100, can judge whether or not the target application is in the campaign notice period and, if it is in the campaign notice period, can notify the target application of the page URL of the campaign page that includes content indicating a notice of the start of the campaign.

(22) As described above, the management server 200 manages a campaign notice period (an example of a second period) immediately before a campaign period (an example of a first period) set with respect to a plurality of specific applications.

If the application about which the event information requester 1131 transmitted the above-noted request information is a specific application, the event information acquisitor 1132 of the user terminal acquires a second page URL (an example of a second provision destination information) about which notification was made from the management server 200 when the timing of the management server 200 receiving the above-noted request information was during the campaign notice period.

By requesting access to the second page URL acquired by the event information acquisitor 1132, the content acquisitor 1150 acquires the second content transmitted (provided) from the management server 200. The content presenter 1160 displays (presents) the second content acquired by the content acquisitor 1150 on the display 120.

In this manner, because the management server 200 judges whether or not an installed target application is in the campaign notice period, the user terminal 100, without managing the campaign notice period, can acquire from the management server 200 the page URL of the campaign page that includes the second content that indicates a notice of the campaign if it is during the campaign notice period. This enables the user terminal 100 to notify the user of the start of a campaign, enabling a promotion of the application to the user.

(23) The application manager 221 of the management server 200 manages a campaign ending notice period (an example of a third period) immediately after the campaign period (an example of a first period) set with respect to a plurality of specific applications.

In response to receiving a request from an application installed in the user terminal 100, the event information notifier 253 of the management server 200, if application making the request is a specific application, transmits (notifies) to the user terminal 100 the third page URL (an example of a third provision destination information) indicating the provision destination of the third content that is transmitted (provided) when the timing of the receiving of the request is during the campaign ending notice period.

In this case, the third content indicates a notice of the end of the campaign period (an example of a first period), in which the first content is provided.

In this manner, the management server 200, in response to an inquiry from a target application installed in the user terminal 100, can judge whether or not the target application is in the campaign ending notice period and can notify the target application of the page URL of the campaign that includes the third content that indicates a notice of the end of the campaign if it is during the campaign ending notice period.

(24) As described above, the management server 200 manages a campaign ending notice period (an example of a third period) immediately after the campaign period (an example of a first period) set with respect to a plurality of specific applications.

If the application about which the event information requester 1131 transmitted the request information is a specific application, the event information acquisitor 1132 of the user terminal 100 acquires the third page URL (an example of a third provision destination information) about which notification was made from the management server 200 when the timing of the management server 200 receiving the above-noted request information is during the campaign ending notice period.

By the content acquisitor 1150 making a request to access the third page URL acquired by the event information acquisitor 1132, it acquires the third content provided from the management server 200. The content presenter 1160 displays (presents) the third content acquired by the content acquisitor 1150 on the display 120.

In this manner, because the management server 200 judges whether or not an installed target application is in the campaign ending period, the user terminal 100, without managing the campaign ending notice period, can acquire from the management server 200 the page URL of the campaign that includes the third content indicating a notice of the end of the campaign if it is during the campaign ending notice period. This enables the user terminal 100 to notify the user of the end of the campaign.

(25) The event information notifier 253 of the management server 200, in response to receiving a request from an installed application, may make notification of a third page URL (an example of a third provision destination information) to the user terminal 100 to which the content provider 254 transmitted (provided) the first content based on a request to access the first page URL (an example of a first provision destination information) from an application installed in the user terminal 100.

This enables making it so that notification of the link destination of a campaign that includes the third content that indicates a notice of the end of a campaign period is not made to a user terminal 100 of a user who is not using the campaign.

(26) The user information acquisitor 252 of the management server 200 acquires from an application installed in the user terminal 100 an application user ID (an example of user information) of a user using the user terminal 100 in the application.

The reward granting processor 255 of the management server 200, based on the result of executing the first content transmitted (provided) by the content provider 254 in the user terminal 100, makes notification to the application server 300 handling a reward granting application of reward granting information associated with at least the application user ID in the reward granting application selected as an application in which a reward is to be granted, from among a plurality of specific applications.

This enables the management server 200 have a reward granted with respect to a user who is participating in a campaign indicated by the application user ID in the selected reward granting application of at least the plurality of specific applications. As the reward granting applications, selection from among specific applications installed in the user terminal 100 may be made, selection may be made from among specific applications not installed in the user terminal 100, or selection may be made from among a plurality of specific applications, regardless of whether or not they are installed in the user terminal 100.

### Second Embodiment

Next, the second embodiment of the present invention will be described. Because the constitution of the reciprocal campaign system of the present embodiment is the same as that of the first embodiment, the description will be of the characteristic features of the processing of the present embodiment. In the campaign processing in the first embodiment, in response to a request from a target application installed in the user terminal 100, if that target application is in the campaign period and the first content of the campaign is in an executable status, the executable first content is provided to the user terminal 100. In the campaign processing of the present embodiment, if a further prescribed providing condition is satisfied, the first content executable in the user terminal 100 is provided to the user terminal 100.

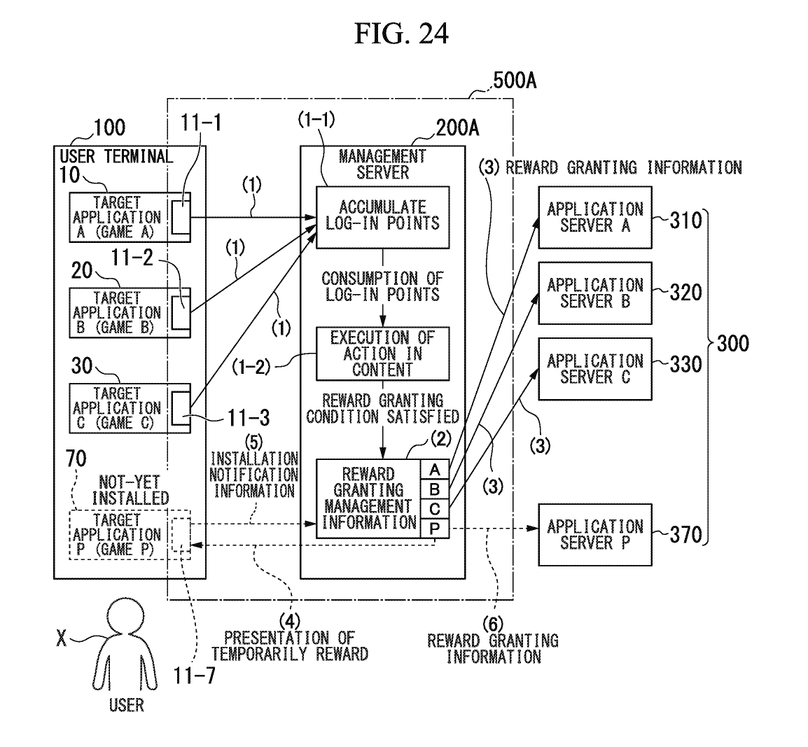

FIG. 24 is a schematic representation describing the campaign processing in the present embodiment. The reciprocal campaign system 500A shown in this drawing, the processing executed by the management server 200A is different from the processing of the management server 200 shown in FIG. 5. In FIG. 24, constituent elements corresponding to parts that have been shown in FIG. 5 are assigned the same reference symbols, and the descriptions thereof will be omitted.

(1-1) If the management server 200A acquires campaign page display request information from any of the target application A10, the target application B20, and the target application C30, by the consumption of log-in points that had been accumulated by logging into each target application, it transmits to the user terminal 100 the first content, which is executable in the user terminal 100. That is, in exchange for subtracting a prescribed number of points from the accumulated log-in points, the first content is transmitted to the user terminal 100.

The log-in points accumulated by logging into each target application are managed by storing point information into the point information storage 236. The content provider 254, when the first content is transmitted to the user terminal 100, the log-in points managed by the point information is updated to an updated value by subtracting therefrom a prescribed number of points. The prescribed number of points is a number of points established for each individual campaign or for each individual application. Therefore, if the number of log-in points managed by the point information has not reached the prescribed number of points, the content provider 254 does not transmit the first content to the user terminal 100.

(1-2) The subsequent processing done by the management server 200 if the first content is transmitted to the user terminal 100 is the same as in the first embodiment, and when the user X executes the first content in the user terminal 100, the user terminal 100 transmits the action execution result in the first content to the management server 200.

(Summary)

As described above, the content provider 254 of the management server 200 transmits (provides) to the user terminal 100 the first content based on a request from an application installed in the user terminal 100 (an example of the user's own terminal device) from among a plurality of target applications, if a prescribed condition has been satisfied.

In this manner, because the management server 200 requires a prescribed provision condition for providing the first content, in addition to presenting a special feeling regarding the content, this enables the imparting to the user of a feeling of achievement if the first content is provided to the user

For example, the point manager 223 of the management server 200 accumulates and manages the prescribed points (an example of a value) based on requests from each of a plurality of target application installed in the user terminal 100. The content provider 254 then, based on requests from each of the plurality of target applications, transmits (provides) to the user terminal 100 the first content, in exchange for subtracting the accumulated number of the prescribed number of points (an example of a value) managed by the point manager 223.

In this manner, the management server 200, for example, by providing the first content in accordance with the number of log-install, can promote use of a target application by the user for the purpose of earning points.

### Third Embodiment

Next, the third embodiment of the present invention will be described. Because the constitution of the reciprocal campaign system of the present embodiment is the same as that of the first embodiment, the description will be of the characteristic features of the processing of the present embodiment. In the campaign processing in the first embodiment, by executing the first content provided in a campaign from a target application installed in the user terminal 100, any one of the target application participating in the same campaign is selected as a reward granting application, regardless of whether it is installed in the user terminal 100. In the campaign processing of the present embodiment, of the target applications participating in the same campaign, only a target application not installed in the user terminal 100 is selected as a reward granting application.

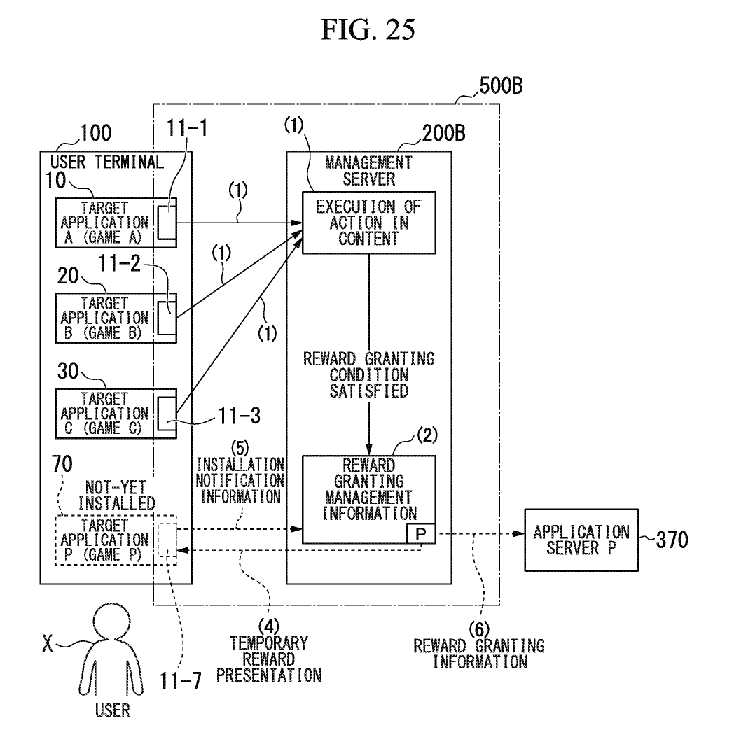

FIG. 25 is a schematic representation describing the campaign processing according to the present embodiment. In the reciprocal campaign system 500B shown in this drawing, the processing executed by the management server 200B is different from the processing by the management server 200 shown in FIG. 5. In FIG. 25, constituent elements corresponding to parts that have been shown in FIG. 5 are assigned the same reference symbols, and the descriptions thereof will be omitted.

As shown in the drawing, the reward granting manager 224 of the management server 200B selects a reward granting application (the target application P70) from target applications not installed in the user terminal 100 of a plurality of target applications participating in the same campaign as the target application that requested the first content (any one of the target application A10, the target application B20, and the target application C30). Then, the reward granting manager 224 manages reward granting management information of the reward granting application (the target application P70) selected from the target applications not installed in the user terminal 100. After the reward granting application (the target application P70) is installed into the user terminal 100, the reward granting manager 224 grants a reward to the user X, based on that reward granting management information.

If there is no target application not installed in the user terminal 100, the reward granting manager 224 may be made to select a reward granting application from among target applications that are installed in the user terminal 100.

In the present embodiment as well, similar to the campaign processing described in the second embodiment, if a prescribed provision condition is satisfied, the first content executable in the user terminal 100 may be provided to the user terminal 100.

(Summary)

As described above, the management server 200B (an example of a management device) of the present embodiment has at least an application manager 221, an install notification acquisitor 251, a user information acquisitor 252, a reward granting manager 224, and a reward granting processor 255.

The application manager 221 manages information regarding a plurality of target applications that are being managed. The install notification acquisitor 251 acquires install notification information indicating that an application has been installed from applications installed in the user terminal 100 (an example of a terminal device), of a plurality of target applications, this install notification information including an application ID (an example of identification information) and a reward user ID (an example of individual identification information) identifying the user terminal 100 installing the application. The user information acquisitor 252 acquires an application user ID (an example of user information) of a user who uses a user terminal 100 in an application regarding which the install notification acquisitor 251 acquired install notification information. The individual identification information, in addition to the reward user ID generated uniquely in the reciprocal campaign system 500B, may be an identification number, such as a UDID (Unique Device Identifier), an IMEI (International Mobile Equipment Identity), or an IMSI (International Mobile Subscriber Identity), or the like uniquely assigned to the user terminal 100. Also, these identification numbers may be used for hashing or encryption. That is, it is sufficient that this be identification information uniquely assigned in a user terminal 100, which is set or generated either within the reciprocal campaign system 500B or outside thereof.

The reward granting manager 224 manages, as reward granting management information, an application ID (an example of identification information) of a reward granting application selected as an application in which a reward will be granted from among applications not installed in the user terminal 100 of a plurality of target applications and a reward user ID (an example of individual identification information) identifying the user terminal 100, in association with each other.

If the reward granting processor 255, based on the reward granting management information managed in the reward granting manager 224, judges that the install notification acquisitor 251 has acquired install notification information indicating that install of the reward granting application has been done into the user terminal 100, and also if the user information acquisitor 252 has acquired the application user ID (an example of user information) in the reward granting application, it transmits (notifies) to the application server 300 (an example of a server device) handling the reward granting application reward granting information that was associated with the application user ID (an example of user information) in the reward granting application.

In this manner, the management server 200B manages a reward in a target application not installed in the user terminal 100 in association with a reward user ID identifying the user terminal 100 and the application ID identifying the target application. This enables the management server 200B to temporarily grant a reward in a target application not yet installed in the user terminal 100 before the target application is installed. This enables a heightening of the motivation for the user to use a target application that the user has not yet used.

The content provider 254 transmits (provides) to the user terminal 100 a first content executable in the user terminal 100. If a prescribed condition for granting a reward is satisfied, based on the result of executing the first content provided by the content provider 254 to the user terminal 100, the reward granting manager 224 manages reward granting management information of a reward granting application selected from among applications not installed in the user terminal 100 of a plurality of target applications.

In this manner, for example, in contrast to a banner advertisement that simply displays an advertisement, because the first content executable in the user terminal 100 is provided and a reward is granted in accordance with the result of that execution, it is possible to heighten the interest of the user, and to further increase the motivation for the user to install and use the target application.

The content provider 254 transmits (provides) the first content in response to a request from an application installed in the user terminal 100 of a plurality of target applications. The reward granting manager 224 manages reward granting management information of a reward granting application selected from among application other than the application that requested the first content of the plurality of target applications.

Because customer transfer to a target application not installed in the user terminal 100 is possible from a target application installed in the user terminal 100, the effect of increasing the number of installs of target applications is achieved.

### Fourth Embodiment

Next, the fourth embodiment of the present invention will be described. Because the constitution of the reciprocal campaign system of the present embodiment is the same as that of the first embodiment, the description will be of the characteristic features of the present embodiment. In the campaign processing of the first embodiment, by executing the first content provided in a campaign from a target application installed in the user terminal 100, any one target application participating in the same campaign is selected as a reward granting application, regardless of whether or not it is installed in the user terminal 100. In the processing of the present embodiment, a reward granting application is selected from among target applications not installed in the user terminal 100, in response to the result of executing the first content from an application other than a target application, regardless of the campaign.

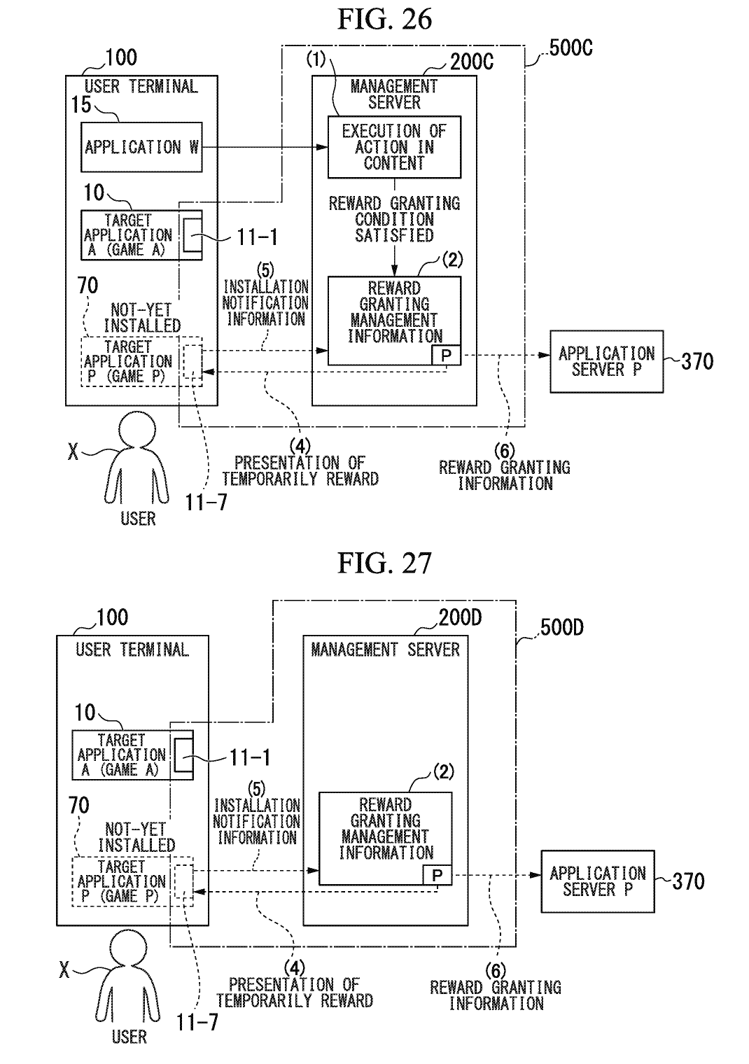

FIG. 26 is a schematic representation describing the processing in the present embodiment. In the reciprocal campaign system 500C shown in this drawing, the processing executed by the management server 200C differs from the processing of the management server 200 shown in FIG. 5. In FIG. 26, constituent elements corresponding to constituent elements shown in FIG. 5 are assigned the same reference symbols, and the descriptions thereof will be omitted.

The management server 200C acquires the result of executing the first content from an application W15 installed in the user terminal 100. The reward granting manager 224 of the management server 200C, in response to obtaining this execution result, selects a reward granting application from target applications not installed in the user terminal 100 and manages reward granting management information.

In this case, the application W15 is an application other than a target application. The application W15, therefore, is an application that does not accommodate the reciprocal campaign system 500C and does not participate in a campaign. The application W15 has a function of acquiring and displaying the first content provided from the management server 200C, unrelated to a campaign processing, and a function of transmitting the management server 200C the result of executing the first content. The application W15 also has a function of reading out the reward user ID identifying the user terminal 100 into which it itself is installed from the terminal storage 140 and transmitting it to the management server 200C. This enables the management server 200C to acquire the result of execution of the first content from the application W15 and acquire the reward user ID identifying the user terminal 100 into which the application W15 is installed, to select a reward granting application from among target applications not installed in the user terminal 100, and to manage the reward granting management information.

If there is no target application not installed in the user terminal 100, the reward granting manager 224 may be made to select a reward granting application from among target applications that are installed in the user terminal 100.

In this embodiment as well, similar to the campaign processing described in the second embodiment, if a prescribed provision condition is satisfied, the first content executable in the user terminal 100 may be provided to the user terminal 100.

(Summary)

In this manner, the content provider 254 of the management server 200C provides the first content in response to a request from an application, other than the plurality of target applications, running in the user terminal 100 (an example of a terminal device). The reward granting manager 224, based on the result of executing the first content, manages reward granting management information of a reward granting application selected from a plurality of target applications.

This enables the management server 200C (an example of a management device), in response to the result of execution of the first content in an application other than a target application, to have a reward granted to any target application. In the reciprocal campaign system 500C, therefore, a customer can be transferred from application other than a target application to a target application not installed in the user terminal 100 or it is possible to promote the use of a target application that is installed in the user terminal 100 but not used that much.

Also, a functionality limited to a function of transmitting to the management server 200C the results of executing the first content and a function of transmitting to the management server 200C the reward user ID may be implemented as a function of the SDK embedded in the application W15. The SDK, in contrast to the SDK 11, does not have a function in the reciprocal campaign system 500C.

For example, in a target application accommodating the reciprocal campaign system 500C, if it is decided to stop the service of the system, an SDK having the above-described limited functions can be embedded, so that customers are transferred to some target applications accommodating the system (outbound only). Although the application W15 can execute the first content, because it is not granted a reward, it does not correspond to a target application.

Although, in the same manner as the application W15 in which an SDK having the above-described limited functions is embedded, a target application into which the SDK 11 is embedded transfers customers to some target application (outbound only), in order that a reward is not granted, flag information indicating the exclusion from targets for granting rewards may be stored into the target application information storage 231.

### Fifth Embodiment

Next, the fifth embodiment of the present invention will be described. The constitution of the network system 1 of the present embodiment is the same as in the first embodiment. In this case, the characteristic features of the present embodiment will be described. In the campaign processing in the first embodiment, by executing the first content provided in a campaign from a target application installed in the user terminal 100, a reward granting application of any one of target applications participating in the same campaign is selected, regardless of whether or not it is installed in the user terminal 100. In the processing of the present embodiment, regardless of the campaign and the result of executing the first content, based on the reward granting management information set in the management server, a reward is granted if a target application not installed in the user terminal 100 is installed in the user terminal 100.

FIG. 27 is a schematic representation describing the processing according to the present embodiment. In the reciprocal campaign system 500D shown in this drawing, the processing executed by the management server 200D is different from the processing by the management server 200 shown in FIG. 5. In FIG. 27, constituent elements corresponding to constituent elements shown in FIG. 5 are assigned the same reference symbols, and the descriptions thereof will be omitted.

The reward granting manager 224 of the management server 200D manages the reward user ID identifying the user terminal 100 of the user X and the application ID of the reward granting application selected from among target applications not installed in the user terminal 100, in association with each other, as reward granting management information. This reward granting management information may be generated at the timing of the acquisition by the management server 200D of install notification information of the target application installed in the user terminal 100, with the reward user ID included in the install information and the application ID of the selected reward granting application associated with each other. The reward granting management information may be generated at the timing of the reaching of a prescribed number of times, based on the number of times that install notification information is acquired from the user terminal 100 by the management server 200D.

The management server 200D may be determined at the timing of acquisition of install notification information indicating that the target application was installed into the user terminal 100, with a first drawing conducted to determine whether or not a reward is to be granted with respect to the reward user ID included in the install notification information, and a second drawing may be conducted to determine the reward granting application that will be granted the reward. By being based in this manner on the install notification information, it is possible to prevent a reward being granted to a dormant user not playing the target application.

(Summary)

As described above, the management server 200D (an example of a management device) according to the present embodiment has at least an application manager 221, an install notification acquisitor 251, a user information acquisitor 252, a reward granting manager 224, and a reward granting processor 255.

The application manager 221 manages information regarding a plurality of target application that are being managed. The install notification acquisitor 251 acquires install notification information indicating that an application of a plurality of target applications has been installed into the user terminal 100 (an example of a terminal device) and that includes an application ID (an example of identification information) of the target application and a reward user ID (an example of individual identification information) identifying the user terminal 100 into which the target application was installed. The user information acquisitor 252 acquires an application user ID (an example of user information) of the user using the user terminal 100 in the application for which the install notification information was acquired by the install notification acquisitor 251.

The reward granting manager 224 manages, as a reward granting management information, an application ID (an example of identification information) of a reward granting application that is selected as an application in which a reward is granted from among applications not installed in the user terminal 100 of a plurality of target applications and a reward user ID (an example of individual identification information) identifying the user terminal 100, associated with each other.

If the reward granting processor 255, based on the reward granting management information managed in the reward granting manager 224, judges that the install notification acquisitor 251 has acquired install notification information indicating that the reward granting application has been installed into the user terminal 100, and also if the user information acquisitor 252 has acquired the application user ID (an example of user information) in the reward granting application, it transmits (notifies) to the application server 300 (an example of a server device) handling the reward granting application reward granting information that was associated with the application user ID (an example of user information) in the reward granting application.

In this manner, the management server 200D manages rewards in a target application not installed in the user terminal 100, in association with the reward user ID identifying the user terminal 100 and the application ID of the target application. This enables the management server 200D to temporarily grant a reward in a target application not installed in the user terminal 100 before the target application is installed. This enables a heightening of the motivation for a user to use a target application that the user is not using that much.

By generating the reward granting management information at the timing of the reward granting manager 224 acquiring the install notification information, it is possible to generate and manage the reward granting management information so that a reward is granted to the target application that transmitted the install notification information, and to cause the granting of a reward to the target application. In this case, it is also possible to grant a reward to a target application that is first installed in the user terminal 100.

### Sixth Embodiment

Next, the sixth embodiment of the present invention will be described. Because the reciprocal campaign system of the present embodiment is the same as that of the first embodiment, the characteristic features of the processing will be described. In the campaign processing of the first embodiment, by executing the first content provided in a campaign from a target application installed in the user terminal 100, one target application participating in the same campaign is selected as the reward granting application, regardless of whether it is installed in the user terminal 100. In the campaign processing of the present embodiment, only a target application installed in the user terminal 100 of target applications participating in the same campaign is selected as the reward granting application.

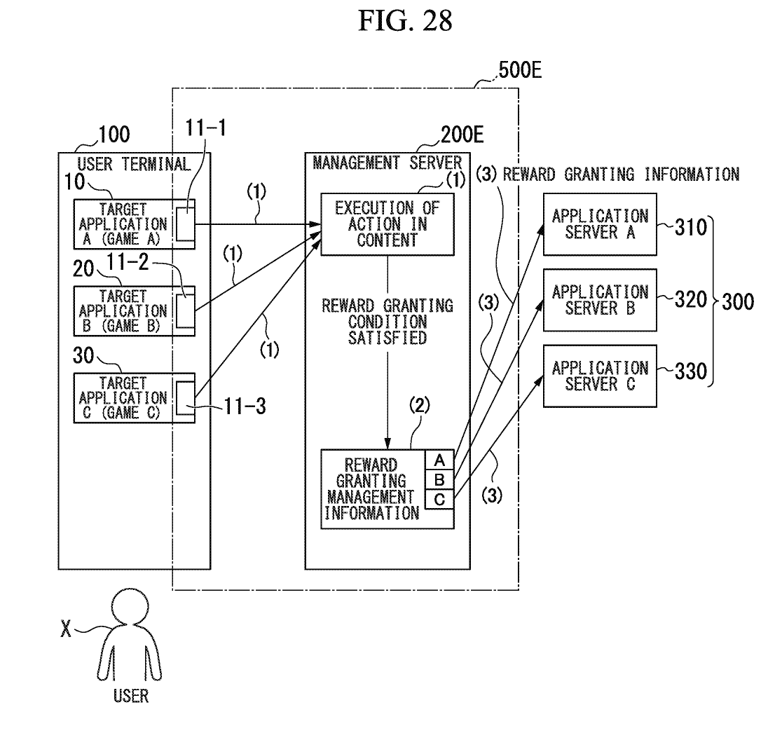

FIG. 28 is a schematic representation describing the campaign processing in the present embodiment. In the reciprocal campaign system 500E shown in the drawing, the processing executed by the management server 200E is different from the processing by the management server 200 shown in FIG. 5. In FIG. 28, constituent elements corresponding to ones shown in FIG. 5 are assigned the same reference symbols, and the descriptions thereof will be omitted.

As shown in the drawing, the reward granting manager 224 of the management server 200E selects a reward granting application from among target applications (that is, the target application A10, the target application B20, and the target application C30) installed in the user terminal 100 of the plurality of target applications participating in the same campaign as a target application that requested the first content (that is, any one of the target application A10, the target application B20, and the target application C30). Then, the reward granting manager 224 manages reward granting management information of the reward granting application selected from the target application A10, the target application B20, and the target application C30.

Of the target applications installed in the user terminal 100 (the target application A10, the target application B20, and the target application C30), selection may be made as the reward granting application of a target application that is different from the target application that requested the first content (that is, one of the target application A10, the target application B20, and the target application C30).

In the present embodiment as well, similar to the campaign processing described in the second embodiment, if a prescribed provision condition is satisfied, the first content executable in the user terminal 100 may be provided to the user terminal 100.

(Summary)

As described above, the management server 200E of the present embodiment (an example of a management device) has at least an application manager 221, a user information acquisitor 252, a content provider 254, and a reward granting processor 255.

The application manager 221 manages information regarding a plurality of target applications being managed.

The user information acquisitor 252 acquires the application user ID (an example of user information) of a user using the user terminal 100 in each of the applications from among a plurality of application installed in the user terminal 100 of a plurality of target applications. The content provider 254 transmits (provides) to the user terminal 100 the first content, which can be executed in the user terminal 100.

The reward granting processor 255, based on the result of execution in the user terminal 100 of the first content provided by the content provider 254, transmits (notifies) to the management server 300 (an example of a server device) handling the reward granting application reward granting information in which at least an application user ID in the reward granting application selected as a target application in which a reward will be granted from among a plurality of applications installed in the user terminal 100 is associated.

In this manner, by the management server 200E conducting a campaign targeted at a plurality of target applications, a reward is granted to one of the target application installed in the user terminal 100 of the user in accordance with the result of execution of the first content provided in the campaign. This enables a heightening of the motivation for the user to use the target application. For example, the management server 200E may grant a reward to a target application different from the target application that requested the first content and, if a reward is granted to a target application that the user is not using that much, it is possible to heighten the motivation for the user to use the target application once again. That is, according to the present embodiment, it is possible to heighten the motivation for a user to once again use an application that the user had stopped using.

### Seventh Embodiment

Next, the seventh embodiment of the present invention will be described. Because the constitution of the reciprocal campaign system of the present embodiment is the same as that of the first embodiment, the characteristic features of the processing will be described.

In the earlier described embodiments, the description is an example for the case in which the communicator 210 of the management server 200 communicates install notification information, user information, the executable first content and information of the provision destination thereof, the result of executing the executable first content, the content including the pre-grant notification information and the provision destination information thereof and the like directly with the user terminal 100. In the same manner, the description is an example for the case in which the terminal communicator 130 of the user terminal 100 communicates install notification information, user information, the executable first content and the provision destination information thereof, the result of executing the executable first content, and the content including the pre-grant notification information and the provision destination information and the like directly with the management server 200.

In this case, the communicator 210 of the management server 200 may communicate directly with the user terminal 100 after a communication session is established via the application server 300 (an example of a server device) handling the target application installed in the user terminal 100. In the same manner, the terminal communicator 130 (an example of a transmitter/receiver) of the user terminal 100 may communicate directly with the management server 200 after establishing a communication session via the application server 300 (an example of a server device) handling the target application installed in the user terminal 100 (an example of the user's own terminal device).

If communication is done from the user terminal 100 directly with the management server 200, a communication session may be established as required. That is, both the case in which communication is done directly with the management server 200 before establishing the communication session and the case in which communication is done directly with the management server 200 after establishing the communication session may be included.

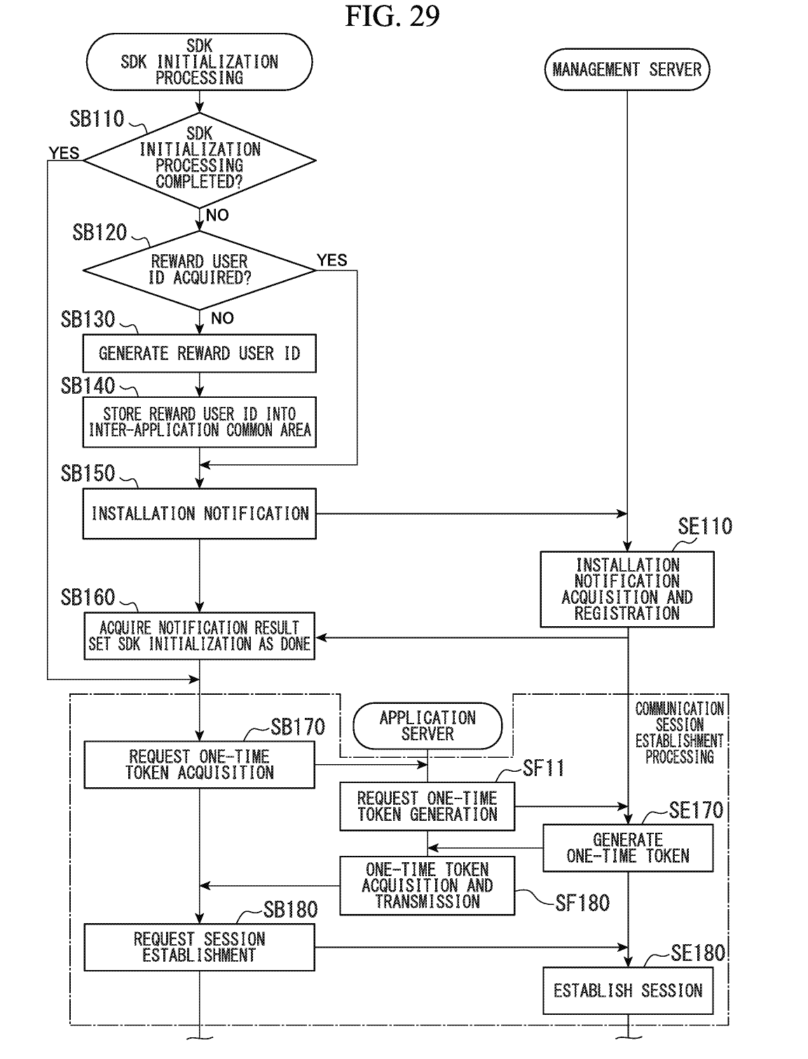

FIG. 29 is an operational drawing showing an example of the operation of establishing a communication session. The processing to establish a communication session (communication session establishment processing) is performed as required before communicating with the management server 200 after launching a target application installed in the user terminal 100. For example, as shown in FIG. 29, at the very end of the SDK initialization processing shown in FIG. 19 (after the processing of step SB160), communication session establishment processing is done. FIG. 29 shows the processing done to establish a communication session when communication is done directly to the management server 200 from the SDK 11 of a target application installed in the user terminal 100. This communication session establishment processing can be done in the same way when communication is done directly to the management server 200 from a target application. The user terminal 100 and the application server 300 are taken to have already established a communication session.

After the processing of step SB160, the SDK 11 of the user terminal 100 transmits to the application server 300 one-time token acquisition request information that requests the acquisition of a one-time token (step SB170). Upon acquiring the one-time token acquisition request information from the user terminal 100 (SDK 11), the application server 300 transmits to the management server 200 one-time token generation request information, based on the acquired one-time token acquisition request information (step SF170). When it acquires the one-time token generation request information from the application server 300, the management server 200 generates a one-time token and transmits the generated one-time token to the application server 300 (step SE170). When the application server 300 acquires the one-time-token from the management server 200, the application server 300 transmits the acquired one-time-token to the user terminal 100 (SDK 11) (step SF180). When the SDK 11 of the user terminal 100 acquires the one-time-token from the application server 300, it transmits to the management server 200 session establishment request information that includes the acquired one-time-token (step SB180). Upon acquiring the session establishment request information from the user terminal 100 (SDK 11), if the one-time-token included in the acquired session establishment request information is correct, (that is, if there is a match with the one-time-token transmitted to the user terminal 100 (SDK 11)), the communication session is established and communication by the reciprocal campaign system 500 is permitted (step SE180). After that, for example, campaign processing is performed as it was by the reciprocal campaign system 500 as shown in FIG. 17 to FIG. 23. If the one-time-token included in the session establishment request information acquired from the user terminal 100 (SDK 11) was incorrect, a communication error occurs, and communication by the reciprocal campaign system 500 is not permitted. If the management server 200E cannot acquire the session establishment request information from the user terminal 100 (SDK 11), communication by the reciprocal campaign system 500 is, of course, not permitted.

In this manner, by starting communication by the reciprocal campaign system 500 after establishing the communication session, it is possible to improve the security within the network system 1 that includes the reciprocal campaign system 500.

A part of the install notification information, the user information, the executable first content and the provision destination thereof, the result of executing the executable first content, and the content that includes the pre-grant notification information and the provision destination information thereof and the like, rather than being communicated directly from the user terminal 100 to the management server 200, may be communicated with the user terminal 100 via the management server 300 (an example of a server device) handling the target application installed in the user terminal 100. That is, the communicator 210 of the management server 200 may communicate the install notification information, the user information, the executable first content and the provision destination information thereof, the result of executing the executable first content, or the content that includes the pre-grant notification information and the provision destination information thereof and the like either with the user terminal 100 via the application server 300 (an example of a server device) handling the target application installed in the user terminal 100 or directly with the user terminal 100. In the same manner, the communicator 130 of the user terminal 100 may communicate the install notification information, the user information, the executable first content and the provision destination information thereof, the result of executing the executable first content, or the content that includes the pre-grant notification information and the provision destination information thereof and the like, either with the management server 200 via the application server 300 (an example of a server device) handling the target application installed in the user terminal 100 (an example of the user's own terminal device) or directly with the management server 200.

Additionally, the communicator 210 of the management server 200 may communicate the install notification information, the user information, the executable first content and the provision destination information thereof, the result of executing the executable first content, and the content that includes the pre-grant notification information and the provision destination information thereof and the like, with the user terminal 100 via the application server 300 (an example of a server device) handling the target application installed in the user terminal 100. In the same manner, the terminal communicator 130 of the user terminal 100 may communicate the install notification information, the user information, the executable first content and the provision destination information thereof, the result of executing the executable first content, and the content that includes the pre-grant notification information and the provision destination information thereof and the like, with the management server 200 via the application server 300 (an example of a server device) handling the target application installed in the user terminal 100 (an example of the user's own terminal device).

In this manner, even if the user terminal 100 and the management server 200 communicate via the application server 300, the reciprocal campaign system 500 can achieve the same effect as the campaign processing described in the foregoing embodiments.

### Variation Examples

Although, referring to drawings, embodiments of the present invention have been described above in detail, the specific constitution is not limited to those of the above-described embodiments, and include designs that do not depart from the spirit of the present invention. For example, the functions of the above-described first to seventh embodiments can be arbitrarily combined.

(1) In the above-described embodiments, although the description has been of processing in which the management server 200, based on reward granting management information, transmits to the application server 300 handling a reward granting application reward granting information associated with an application user ID of the reward granting application, this is not a restriction. For example, the management server 200 may transmit reward granting information to the user terminal 100 (SDK 11 embedded in the reward granting application) in which the reward granting application is installed. This may enable a reward to be granted in a reward granting application installed in the user terminal 100, based on the reward granting information. Also, reward granting information may be transmitted to the application server 300 handling a reward granting application, via a reward granting application installed in the user terminal 100, with a reward granted in the application server 300, based on the reward granting information.

(2) In the above-described embodiments, although the description has been of the example in which, when a target application is installed for the first time, the reward user ID is generated as individual identification information (unique individual identification information in the reciprocal campaign system 500) that uniquely identifies the user terminal 100 into which install was done, this is not a restriction. For example, a terminal identification number or a telephone number that is set individually in the user terminal 100 (for example, of a smartphone) may be used as the reward user ID. However, rather than using personnel information such as a terminal identification number or telephone number, the use of a reward user ID generated as in the present embodiment can improve security. By not using the terminal number, the telephone number or the like as the reward user ID, but rather using individual identification unique in the reciprocal campaign system 500, even when there is a change, such as when the user purchases a new user terminal 100 (an example of a terminal device) to possess, by following a prescribed procedure to transfer the reward user ID to the new user terminal 100 after the change, the reciprocal campaign system 500 can be used, while maintaining the status from the user terminal 100 before the change.

(3) Although the foregoing embodiments were described for the example in which the target application accommodating the reciprocal campaign system 500 is a game, the target application is not limited to being a game, and may be any application other than a game.

The storage 230 of the management server 200 may be provided in a server device different from the management server 200. The manager 220 or the controller 250 of the management server 200 may, by communicating via the network NW with a storage 230 provided in a server device different from the management server 200, manage the various information stored in the various parts of the storage 230.

Of the functions of the management server 200, a web server function that provides a campaign page or an advertising image or the like to the user terminal 100, based on a page URL or a banner URL, may be provided in a server that is different from the management server 200.

Further, the management server 200 and the application server 300 may be integrated so as to constitute a server device.

(4) A program for implementing the function of the manager 220, the controller 250, or the SDK 11, which are described above, may be stored in a computer-readable recording medium, and the program may be executed by reading the program stored in this recording medium into a computer system, which executes the program. Here, “reading the program stored in this recording medium into a computer system and executing the program” includes installing the program in the computer system. “Computer system” referred to herein is intended to include an operating system and hardware such as peripheral devices. Further, “computer system” may include a plurality of computer devices which are connected via a network, including a communication line such as the Internet, WAN, LAN, or a dedicated line. Further, “computer-readable recording medium” refers to a portable medium such as a flexible disk, a magneto-optical disk, a ROM, and a CD-ROM, or a storage device such as a hard disk built into the computer system. In this manner, a recording medium storing the program may be a non-transitory storage medium such as a CD-ROM. Further, the recording medium also includes a recording medium which is provided internally in or externally to a computer system, which is accessible from the distribution server in order to deliver the program. The program code stored in the recording medium of the distribution server may be different from the program code of a form executable by the terminal device. In other words, a format stored in the distribution server is not limited, as long as the program code can downloaded from a distribution server and installed in a form executable by the terminal device. In addition, a configuration is possible in which a program is divided into a plurality of programs, and the plurality of programs are combined in a terminal device after being downloaded at different times, or there may be different distribution servers that respectively distribute the divided programs. Further, it is assumed that “computer-readable recording medium” includes a medium that holds a program for a fixed time, such as a volatile memory (RAM) inside a computer system which is a server or a client when the program is transmitted through a network. Further, the program may implement a part of the above-described functions. Further, the program may be a so-called differential file (a differential program) that can be implemented by combining the above-described functions with a program already stored in a computer system.

Further, a part or all of the above-described functions may be implemented as an integrated circuit such as a large-scale integrated (LSI) device. The respective functions described above may be formed into separate processors, or a part or all of the respective functions may be integrated and formed into a processor. Further, the circuit integration method is not limited to LSI, and may be implemented by a dedicated circuit or a general-purpose processor. Further, if an integrated circuit technology replacing the LSI appears due to advances in semiconductor technology, an integrated circuit according to that technology may be used.

The systems and methods in the above-described embodiments may be deployed in part or in whole through a machine, circuitry, or hardware processor that executes computer software, software components, program codes, and/or instructions on one or more processors. The one or more processors may be part of a general-purpose computer, a server, a cloud server, a client, network infrastructure, mobile computing platform, stationary computing platform, or other computing platform. One or more processors may be any kind of computational or processing device or devices which are capable of executing program instructions, codes, binary instructions and the like. The one or more processors may be or include a signal processor, digital processor, embedded processor, microprocessor or any variants such as a co-processor, for example, math co-processor, graphic co-processor, communication co-processor and the like that may directly or indirectly facilitate execution of program codes or program instructions stored thereon. In addition, the one or more processors may enable execution of multiple programs, threads, and codes. The threads may be executed simultaneously to enhance the performance of the one or more processors and to facilitate simultaneous operations of the application. Program codes, program instructions and the like described herein may be implemented in one or more threads. The one or more processors may include memory that stores codes, instructions and programs as described herein. The processor may access a non-transitory processor-readable storage medium through an interface that may store codes, instructions and programs as described herein and elsewhere. The non-transitory processor-readable storage medium associated with the processor for storing programs, codes, program instructions or other type of instructions capable of being executed by the computing or processing device may include but may not be limited to one or more of a memory, hard disk, flash drive, RAM, ROM, CD-ROM, DVD, cache and the like.

A processor may include one or more cores that may enhance speed and performance of a multiprocessor. In some embodiments, the process may be a dual core processor, quad core processors, other chip-level multiprocessor and the like that combine two or more independent cores.

The methods and systems described herein may be deployed in part or in whole through a machine that executes computer software on a server, client, firewall, gateway, hub, router, or other such computer and/or networking hardware.

The software program may be associated with one or more client that may include a file client, print client, domain client, internet client, intranet client and other variants such as secondary client, host client, distributed client and the like. The client may include one or more of memories, processors, computer readable media, storage media, physical and virtual ports, communication devices, and interfaces capable of accessing other clients, servers, machines, and devices through a wired or a wireless medium, and the like. The programs or codes as described herein may be executed by the client. In addition, other devices required for execution of methods as described in this application may be considered as a part of the infrastructure associated with the client. The client may provide an interface to other devices including servers, other clients, printers, database servers, print servers, file servers, communication servers, distributed servers and the like. This coupling and/or connection may facilitate remote execution of program across the network. The networking of some or all of these devices may facilitate parallel processing of a program or method at one or more location. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The software program may be associated with one or more servers that may include a file server, print server, domain server, internet server, intranet server and other variants such as secondary server, host server, distributed server and the like. The server may include one or more of memories, processors, computer readable media, storage media, physical and virtual ports, communication devices, and interfaces capable of accessing other servers, clients, machines, and devices through a wired or a wireless medium, and the like. The methods, programs or codes as described herein may be executed by the server. In addition, other devices required for execution of methods as described in this application may be considered as a part of the infrastructure associated with the server. The server may provide an interface to other devices including clients, other servers, printers, database servers, print servers, file servers, communication servers, distributed servers, social networks, and the like. This coupling and/or connection may facilitate remote execution of program across the network. The networking of some or all of these devices may facilitate parallel processing of a program or method at one or more locations. Any of the devices attached to the server through an interface may include at least one storage medium capable of storing programs, codes and/or instructions. A central repository may provide program instructions to be executed on different devices. In this implementation, the remote repository may act as a storage medium for program codes, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing devices associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory, for example, USB sticks or keys, floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The modules, engines, components, and elements described herein, including in flow charts and block diagrams throughout the figures, imply logical boundaries between the modules, engines, components, and elements. However, according to software or hardware engineering practices, the modules, engines, components, and elements and the functions thereof may be implemented on one or more processors, computers, machines through computer executable media, which are capable of executing program instructions stored thereon as a monolithic software structure, as standalone software modules, or as modules that employ external routines, codes, services, or any combination of these, and all such implementations may be within the scope of the present disclosure. Examples of such machines may include, but is not limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers, processor-embedded eyewear and the like. Furthermore, the modules, engines, components, and elements in the flow chart and block diagrams or any other logical component may be implemented on one or more machines, computers or processors capable of executing program instructions. Whereas the foregoing descriptions and drawings to which the descriptions have been referred set forth some functional aspects of the disclosed systems, no particular arrangement of software for implementing these functional aspects should be inferred from these descriptions unless explicitly stated or otherwise clear from the context. It will also be appreciated that the various steps identified and described above may be varied, and that the order of steps may be adapted to particular applications of the techniques disclosed herein. All such variations and modifications are intended to fall within the scope of this disclosure. The descriptions of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the present disclosure includes many embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A management device comprising:
an application manager configured to manage a set of application-related information which is related to a plurality of target applications which are subject to management;
an install notification acquisitor configured to acquire an install notification information from an application which has been installed in a terminal, included in the plurality of target applications, the install notification information indicating that the application has been installed, the install notification information including an identifier which identifies the application and a unique identifier which identifies the terminal in which the application has been installed;
a user information acquisitor configured to acquire a user information with respect to a user who uses the terminal with respect to the application for which the install notification acquisitor acquired the install notification information;
a reward granting manager configured to manage a reward granting management information which includes an identifier and a unique identifier which are associated with each other, the identifier identifying a reward granting application selected to be reward-granted from not-yet-installed applications which has not yet been installed in the terminal, the unique identifier identifying the terminal, the applications being included in the plurality of applications; and
a reward granting processor configured to determine, based on the reward granting management information managed by the reward manager, whether or not the install notification acquisitor acquired the install notification information indicating that the reward granting application has been installed in the terminal, the reward granting processor being configured to notify, to one of a server responsible to the reward granting application and the reward granting application which has been installed into the terminal, a reward granting information associated with the user information with respect to the reward granting application, in a case that the reward granting processor determined that the install notification acquisitor acquired the install notification information, and that the user information acquisitor acquired the user information with respect to the reward granting application.

2. The management device according to claim 1,
wherein the application manager is configured to manage a reward granting time limit defining at least an ending date or time, and
wherein the reward granting processor is configured to determine that the install notification acquisitor acquired no later than the reward granting time limit the install notification information indicating that the reward granting application has been installed in the terminal.

3. The management device according to claim 1, further comprising:
a content provider configured to provide the terminal with executable contents which are executable by the terminal,
wherein the reward granting manager is configured to manage the reward granting management information with respect to the reward granting application selected to be reward-granted from not-yet-installed applications which have not yet been installed in the terminal, the not-yet-installed applications being included in the plurality of applications in a case that a reward granting condition is satisfied by execution of the contents which were provided to the terminal by the content provider.

4. The management device according to claim 3,
wherein the contents provided by the content provider includes receiving a user operation in the terminal and presenting a result in response to a user operation, and
wherein the reward granting manager is configured to manage the reward granting management information with respect to the reward granting application selected from the not-yet-installed applications included in the plurality of target applications, in a case that a reward granting condition is satisfied in response to the user operation in the contents provided to the terminal by the content provider.

5. The management device according to claim 3,
wherein the reward granting manager is configured to manage the reward granting management information with respect to the reward granting application selected from a group including the installed applications which have been installed in the terminal and the not-yet-installed applications which are included in the plurality of target applications, in a case that a reward granting condition is satisfied in the contents provided by the content provider.

6. The management device according to claim 3,
wherein the content provider is configured to provide the contents in response to a request from an application which has been installed in the terminal, included in the plurality of target applications, and
wherein the reward granting manager is configured to manage the reward granting management information with respect to the reward granting application selected from the plurality of target applications except for an application which requests the contents.

7. The management device according to claim 3,
wherein the content provider is configured to provide the contents in response to a request from an application which is operable in the terminal, and which is different from the plurality of target applications, and
wherein the reward granting manager is configured to manage the reward granting management information with respect to the reward granting application selected from the plurality of target applications, the selection having been performed on the basis of a result of the execution of the contents.

8. The management device according to claim 3,
wherein the content provider is configured to provide the contents in a case that a providing condition is satisfied on the basis of a request from an application which has been installed in the terminal, included in the plurality of target applications.

9. The management device according to claim 1,
wherein the unique identifier which identifies the terminal has been acquired in a case that a first-installed application, which was first installed in the terminal in the plurality of target applications, is executed, and
wherein the unique identifier is stored in the terminal where the unique identifier is referable by any of the target applications installed in the terminal.

10. The management device according to claim 1, further comprising:
a communicator configured to communicate the install notification information or the user information directly with the terminal or communicate indirectly to the terminal through a server which is responsible to an application installed in the terminal, included in the plurality of target applications.

11. The management device according to claim 10,
wherein the communicator is configured to communicate directly with the terminal after the communicator has established a session with an application which has been installed in the terminal, included in the plurality of target applications, the establishment was performed via a server which is responsible to the application which had been installed in the terminal.

12. A terminal device configured to communicate with a management device which is configured to manage information related to a plurality of target applications which are subject to management, the terminal device comprising:
a content acquisitor configured to acquire executable contents from the management device, the contents being executable in the terminal device;
a content presenter configured to present the executable contents acquired by the content acquisitor; and
an execution result notifier configured to notify the management device of a result of execution of the executable contents presented by the content presenter,
wherein the content acquisitor acquires contents which include a pre-grant notification information from the management device, in response to notification of the execution result to the management device by the execution result notifier, the pre-grant notification information being to notify, prior to installation of a reward granting application, that a reward is granted to the reward granting application, the reward granting application having been selected to be reward-granted from not-yet-installed applications which have not yet been installed in the terminal device, the not-yet-installed applications being included in the plurality of target applications, and
wherein the content presentor is configured to present contacts including the pre-grant notification information acquired by the content acquisitor.

13. The terminal device according to claim 12, further comprising:
a content requester configured to request the management device for the executable contents with respect to an application which has been installed in the terminal device, included in the plurality of target applications,
wherein the content acquisitor is configured to acquire the executable contents provided by the management device in accordance with the request by the content requester.

14. The terminal device according to claim 12,
wherein identifiers which identify the plurality of target applications are managed in the management device,
wherein a reward granting management information is managed in the management device, the reward granting management information includes an identifier identifying the reward granting application and a unique identifier identifying the terminal device which is associated with the identifier, and
wherein the content acquisitor is configured to acquire contents including the pre-grant notification information from the management device, in response to notification of the execution result to the management device by the execution result notifier, the pre-grant notification information being based on the reward granting management information which is managed in the management device.

15. The terminal device according to claim 14, further comprising:
an install notifier configured to notify, to the management device, an install notification information, the install notification information indicating that an application was installed in the terminal device, the application being included in the plurality of target applications subject to management, the install notification information indicating an identifier which identifies the application and a unique identifier identifying the terminal device.

16. The terminal device according to claim 14, further comprising:
a unique identifier acquisitor configured to acquire the unique identifier in a case that the application installed in the terminal device is a first-installed target application which has been installed first in the terminal device among the plurality of target applications, the unique identifier acquisitor being configured to store in a storage the unique identifier as acquired, the unique identifier being reviewable by any of the target applications installed in the terminal device.

17. The terminal device according to claim 16,
wherein the unique identifier acquisitor is configured to determine whether or not the unique identifier is stored in the storage when the target application is installed in the terminal device,
wherein the unique identifier acquisitor is configured to acquire the unique identifier acquisitor configured to acquire the unique identifier in a case that the unique identifier acquisitor determined that the unique identifier is not stored.

18. The terminal device according to claim 12, further comprising:
a user information notifier configured to notify, to the management device, a user information related to a user which uses the terminal device with respect to an application installed in the terminal device, included in the plurality of target applications.

19. The terminal device according to claim 12, further comprising:
a communicator configured to communicate at least one of: the executable contents; the execution result of the executable contents; and contacts including the pre-grant notification information, directly with the management device or indirectly to the management device through a server which is responsible to an application installed in the terminal device.

20. The management device according to claim 19,
wherein the communicator is configured to communicate directly with the management device after the communicator has established a session with the server responsible to the application installed in the terminal device.
